(19) United States
(12) Patent Application Publication
(10) Pub. No.: US 2026/0151957 A1
(43) Pub. Date: Jun. 4, 2026

(54) Systems and Methods for Stereolithography Three-Dimensional Printing

(71) Applicant: SOUTHWEST GREENE INTERNATIONAL, INC., Oceanside, CA (US)

(72) Inventors: Jonathan Stuart Frankel, Newark, CA (US); Pierre Pascal Anatole Lin, Newark, CA (US); Aldo Suseno, Newark, CA (US); Mangesh Shrikant Edke, Newark, CA (US); Connor Lachlon Curran, Newark, CA (US); Patrick Hendry, Newark, CA (US); Trevor G. Frank, Newark, CA (US); Hany Basam Eitouni, Newark, CA (US); Brian James Adzima, Newark, CA (US); Katrina Mongcopa Paterson, Newark, CA (US)

(73) Assignee: SOUTHWEST GREENE INTERNATIONAL, INC., Oceanside, CA (US)

(21) Appl. No.: 19/122,931

(22) PCT Filed: Oct. 18, 2023
(86) PCT No.: PCT/US2023/077216

§ 371 Date: Apr. 21, 2025

Related U.S. Application Data
(60) Provisional application No. 63/417,625, filed on Oct. 19, 2022.

(51) Int. Cl. B29C 64/129; B29C 64/209; B29C 64/214; B29C 64/227; B29C 64/277; B33Y 10/00; B33Y 30/00

(52) U.S. Cl. CPC B29C 64/129; B29C 64/209; B29C 64/214; B29C 64/227; B29C 64/277; B33Y 10/00; B33Y 30/00

(57) ABSTRACT

The present disclosure provides systems and methods for printing three-dimensional (3D) objects. In some embodiments, the system comprises: a build head configured to support at least a portion of the 3D object during the printing; a platform comprising an area configured to hold a mixture adjacent to the build head; an optical source configured to provide light to the mixture, wherein the light is sufficient to cause formation of at least the portion of the 3D object; and an actuator operatively coupled to the optical source for controlling projection of the light onto the area, wherein the actuator is configured to: (i) adjust a movement between the optical source and the build head relative to one another, along a plurality of degrees of freedom; or (ii) adjust a movement between the optical source and the area relative to one another.

### CROSS REFERENCE

This application claims the benefit of U.S. Provisional Application No. 63/417,625, filed Oct. 19, 2022, which is entirely incorporated herein by reference.

### BACKGROUND

Additive manufacturing techniques, such as three-dimensional (3D) printing, are rapidly being adopted as useful techniques for a number of different applications, including rapid prototyping and fabrication of specialty components. Examples of 3D printing include powder-based printing, fused deposition modeling (FDM), and stereolithography (SLA).

Photopolymer-based 3D printing technology (e.g., SLA) may produce a 3D structure in a layer-by-layer fashion by using light to selectively cure polymeric precursors into a polymeric material within a photoactive resin. Photopolymer-based 3D printers that use bottom up illumination may project light upwards through an optically transparent window of a vat containing photoactive resin to cure at least a portion of the resin. Such printers may build a 3D structure by forming one layer at a time, where a subsequent layer adheres to the previous layer.

### SUMMARY

In an aspect, the present disclosure provides a system for printing a three-dimensional (3D) object, comprising: an optical source configured to provide light to a mixture, wherein the light is sufficient to cause formation of at least a portion of the 3D object during the printing; a build head configured to support at least the portion of the 3D object; a platform comprising an area configured to hold the mixture adjacent to the build head; and an actuator operatively coupled to the platform, wherein the actuator is configured to: (i) adjust a movement between the area and the build head relative to one another, along a plurality of degrees of freedom; or (ii) adjust a movement between the area and the optical source relative to one another.

In another aspect, the present disclosure provides a method for printing a 3D object, comprising: (a) providing: an optical source configured to provide light to a mixture, wherein the light is sufficient to cause formation of at least a portion of the 3D object during the printing, a build head configured to support at least the portion of the 3D object, a platform comprising an area configured to hold the mixture adjacent to the build head; (b) adjusting (i) a movement between the area and the build head relative to one another, along a plurality of degrees of freedom, or (ii) a movement between the area and the optical source relative to one another, for leveling the area; and (c) using the optical source to provide the light to the mixture disposed adjacent to the area of the platform, for the printing.

In another aspect, the present disclosure provides a system for printing a 3D object, comprising: a platform comprising: (i) an exposure window configured to hold a mixture for printing at least a portion of the 3D object, wherein a bottom surface of the exposure window comprises an inner portion surrounded by an outer portion, wherein the outer portion is at least about 20% of the bottom surface; and (ii) a support unit coupled to the inner portion of the bottom surface of the exposure window, to provide stability to the exposure window; a build head configured to support at least the portion of the 3D object; and an optical source configured to provide light to the mixture to form at least the portion of the 3D object.

In another aspect, the present disclosure provides a method for printing a 3D object, comprising: (a) providing: a platform comprising: (i) an exposure window configured to hold a mixture for printing at least a portion of the 3D object, wherein a bottom surface of the exposure window comprises an inner portion surrounded by an outer portion, wherein the outer portion is at least about 20% of the bottom surface; and (ii) a support unit coupled to the inner portion of the bottom surface of the exposure window, to provide stability to the exposure window; a build head configured to support at least the portion of the 3D object; and an optical source configured to provide light to the mixture to form at least the portion of the 3D object; and (b) using the optical source to provide the light to the mixture disposed adjacent to the exposure window of the platform for the printing.

In another aspect, the present disclosure provides a system for printing a 3D object, comprising: a build head configured to support at least a portion of the 3D object during the printing; a platform comprising an area configured to hold a mixture adjacent to the build head; an optical source configured to provide light to the mixture, wherein the light is sufficient to cause formation of at least the portion of the 3D object; and an actuator operatively coupled to the optical source for controlling projection of the light onto the area, wherein the actuator is configured to: (i) adjust a movement between the optical source and the build head relative to one another, along a plurality of degrees of freedom; or (ii) adjust a movement between the optical source and the area relative to one another.

In another aspect, the present disclosure provides a method for printing a 3D object, comprising: (a) providing: a build head configured to support at least a portion of the 3D object during the printing; a platform comprising an area configured to hold a mixture adjacent to the build head; and an optical source configured to provide light to the mixture, wherein the light is sufficient to cause formation of at least the portion of the 3D object; (b) adjusting (i) a movement between the optical source and the build head relative to one another, along a plurality of degrees of freedom; or (ii) a movement between the optical source and the area relative to one another; and (c) using the optical source to provide the light to the mixture disposed adjacent to the area of the platform, for the printing.

In another aspect, the present disclosure provides a system for printing a 3D object, comprising: a platform comprising an area for holding a mixture for printing at least a portion of the 3D object during the printing; a deposition unit in fluid communication with a source of the mixture, wherein the deposition unit is configured to deposit at least a portion of the mixture onto the area; a building unit comprising an optical source configured to provide light to the mixture, wherein the light is sufficient to cause formation of at least the portion of the 3D object; and a plurality of guiding elements operatively coupled to the platform and configured to direct movement of the platform between the deposition unit and the building unit, wherein a first guiding element of the plurality of guiding elements is configured to move along a first path, and a second guiding element of the plurality of guiding elements is configured to move along a second path that is not overlapping with the first path, wherein the first path and the second path are disposed in a single plane that is substantially parallel to the area.

In another aspect, the present disclosure provides a method for printing a 3D object, comprising: (a) providing: a platform comprising an area for holding a mixture for printing at least a portion of the 3D object during the printing; a deposition unit in fluid communication with a source of the mixture, wherein the deposition unit is configured to deposit at least a portion of the mixture onto the area; a building unit comprising an optical source configured to provide light to the mixture, wherein the light is sufficient to cause formation of at least the portion of the 3D object; and a plurality of guiding elements operatively coupled to the platform and configured to direct movement of the platform between the deposition unit and the building unit, wherein a first guiding element of the plurality of guiding elements is configured to move along a first path, and a second guiding element of the plurality of guiding elements is configured to move along a second path that is not overlapping with the first path, wherein the first path and the second path are disposed in a single plane that is substantially parallel to the area; (b) directing, via the plurality of guiding elements, the movement of the platform between the deposition unit and the building unit; and (c) using the optical source to provide the light to the mixture disposed adjacent to the area of the platform for the printing.

In another aspect, the present disclosure provides a system for printing a 3D object, comprising: a platform comprising (i) an area for holding a mixture for printing at least a portion of the 3D object during the printing and (ii) a first coupling unit; a deposition unit in fluid communication with a source of the mixture, wherein the deposition unit is configured to deposit at least a portion of the mixture onto the area; a building unit comprising an optical source configured to provide light to the mixture, wherein the light is sufficient to cause formation of at least the portion of the 3D object during the printing; and a moving unit configured to direct movement of the platform between the deposition unit and the building unit, wherein the moving unit comprises a second coupling unit that is configured to couple to the first coupling unit, such that the platform is operatively coupled to the moving unit, wherein a vertical dimension of the second coupling unit is configured to permit a vertical movement between the first coupling unit and the moving unit relative to one another.

In another aspect, the present disclosure provides a method for printing a 3D object, comprising: (a) providing: a platform comprising (i) an area for holding a mixture for printing at least a portion of the 3D object during the printing and (ii) a first coupling unit; a deposition unit in fluid communication with a source of the mixture, wherein the deposition unit is configured to deposit at least a portion of the mixture onto the area; a building unit comprising an optical source configured to provide light to the mixture, wherein the light is sufficient to cause formation of the at least portion of the 3D object during the printing; and a moving unit configured to direct movement of the platform between the deposition unit and the building unit, wherein the moving unit comprises a second coupling unit that is configured to couple to the first coupling unit, such that the platform is operatively coupled to the moving unit, wherein a vertical dimension of the second coupling unit is configured to permit a vertical movement between the first coupling unit and the moving unit relative to one another; (b) directing, via the moving unit, the movement of the platform between the deposition unit and the building unit; and (c) using the optical source to provide the light to the mixture disposed adjacent to the area of the platform for the printing.

In another aspect, the present disclosure provides a system for printing a 3D object, comprising: a platform configured to support a film holding a mixture for printing at least a portion of the 3D object during the printing, wherein the platform comprises: (i) a bar configured to hold the film at a side of the film; and (ii) an additional bar configured to hold the film at an additional side of the film, wherein the bar comprises a locking mechanism comprising (i) a locking state to couple at least a portion of the side of the film to the bar and (ii) an unlocking state to release at least the portion of the side of the film from the bar; and an optical source configured to provide light to the mixture, wherein the light is sufficient to cause formation of at least the portion of the 3D object during the printing.

In another aspect, the present disclosure provides a method for printing a 3D object, comprising: (a) providing: a platform configured to support a film holding a mixture for printing at least a portion of the 3D object during the printing, wherein the platform comprises: (i) a bar configured to hold the film at a side of the film; and (ii) an additional bar configured to hold the film at an additional side of the film, wherein the bar comprises a locking mechanism comprising (i) a locking state to couple at least a portion of the side of the film to the bar and (ii) an unlocking state to release the at least the portion of the side of the film from the bar; and an optical source configured to provide light to the mixture, wherein the light is sufficient to cause formation of the at least the portion of the 3D object during the printing; and (b) using the optical source to provide the light to the mixture disposed adjacent to the film that is supported by the platform for the printing.

In another aspect, the present disclosure provides a system for printing a 3D object, comprising: a platform comprising a top surface configured to hold a mixture for printing at least a portion of the 3D object, wherein a portion of the top surface is not parallel to an additional portion of the top surface that holds the mixture, and wherein the portion of the top surface is substantially rigid; and an optical source configured to provide light to the mixture, wherein the light is (i) usable for determining a characteristic of the mixture prior to the printing or (ii) sufficient to cause formation of the at least the portion of the 3D object during the printing.

In another aspect, the present disclosure provides a method for printing a 3D object, comprising: (a) providing: a platform comprising a top surface configured to hold a mixture for printing at least a portion of the 3D object, wherein a portion of the top surface is not parallel to an additional portion of the top surface that holds the mixture, and wherein the portion of the top surface is substantially rigid; and an optical source configured to provide light to the mixture, wherein the light is (i) usable for determining a characteristic of the mixture prior to the printing or (ii) sufficient to cause formation of the at least the portion of the 3D object during the printing; and (b) using the optical source to provide the light to the mixture disposed adjacent to the additional portion of the top surface of the platform for the printing.

In another aspect, the present disclosure provides a system for printing a 3D object, comprising: a platform comprising an area configured to hold a mixture for printing at least a portion of the 3D object, a deposition unit comprising: a wiper configured to (i) remove at least a portion of an excess of the mixture from the area or (ii) spread the mixture over the area; an actuator configured to control a vertical movement of the wiper towards or away from the area; and a dampener disposed between the actuator and the wiper, to reduce at least a portion of a force exerted by the actuator and towards the wiper when the actuator directs the vertical movement of the wiper towards or away from the area; and an optical source configured to provide light to the mixture, wherein the light is sufficient to cause formation of the at least the portion of the 3D object during the printing.

In another aspect, the present disclosure provides a method for printing a 3D object, comprising: (a) providing: a platform comprising an area configured to hold a mixture for printing at least a portion of the 3D object, a deposition unit comprising: a wiper configured to (i) remove at least a portion of an excess of the mixture from the area or (ii) spread the mixture over the area; an actuator configured to control a vertical movement of the wiper towards or away from the area; and a dampener disposed between the actuator and the wiper, to reduce at least a portion of a force exerted by the actuator and towards the wiper when the actuator directs the vertical movement of the wiper towards or away from the area; and an optical source configured to provide light to the mixture, wherein the light is sufficient to cause formation of the at least the portion of the 3D object during the printing; (b) using the deposition unit to (i) remove the at least the portion of an excess of the mixture from the area or (ii) spread the mixture over the area; and (c) using the optical source to provide the light to the mixture disposed adjacent to the area of the platform for the printing.

In another aspect, the present disclosure provides a system for printing a 3D object, comprising: a platform comprising an area for holding a mixture for printing at least a portion of the 3D object; a deposition unit comprising a plurality of nozzles in fluid communication with a common source of the mixture, wherein each of the plurality of nozzles is configured to deposit at least a portion of the mixture onto the area, and wherein: (i) the plurality of nozzles comprises a nozzle and an additional nozzle, wherein a cross-sectional dimension of the nozzle and an additional cross-sectional dimension of the additional nozzle are different; or (ii) the plurality of nozzles comprises three or more nozzles; and an optical source configured to provide light to the mixture, wherein the light is sufficient to cause formation of the at least the portion of the 3D object during the printing.

In another aspect, the present disclosure provides a method for printing a 3D object, comprising: (a) providing: a platform comprising an area for holding a mixture for printing at least a portion of the 3D object; a deposition unit comprising a plurality of nozzles in fluid communication with a common source of the mixture, wherein each of the plurality of nozzles is configured to deposit at least a portion of the mixture onto the area, and wherein: (i) the plurality of nozzles comprises a nozzle and an additional nozzle, wherein a cross-sectional dimension of the nozzle and an additional cross-sectional dimension of the additional nozzle are different; or (ii) the plurality of nozzles comprises three or more nozzles; and an optical source configured to provide light to the mixture, wherein the light is sufficient to cause formation of the at least the portion of the 3D object during the printing; and (b) using the deposition unit to deposit the mixture from the common source and towards the area of the platform, via one or more nozzles of the plurality of nozzles; and (c) using the optical source to provide the light to the mixture disposed adjacent to the area of the platform for the printing.

In another aspect, the present disclosure provides a system for printing a 3D object, comprising: a platform comprising an area configured to hold a mixture for printing at least a portion of the 3D object, a deposition unit comprising a structural support and a wiper coupled to the structural support for (i) spreading the mixture over the area or (ii) removing at least a portion of an excess of the mixture from the area, wherein the wiper is configured to move relative to the structural support, such that an axis along a length of the wiper shifts between (a) a non-parallel position relative to a surface of the area and (b) a substantially parallel position relative to the surface of the area; and an optical source configured to provide light to the mixture to form the at least the portion of the 3D object.

In another aspect, the present disclosure provides a method for printing a 3D object, comprising: (a) providing: a platform comprising an area configured to hold a mixture for printing at least a portion of the 3D object, a deposition unit comprising a structural support and a wiper coupled to the structural support for (1) spreading the mixture over the area or (2) removing at least a portion of an excess of the mixture from the area, wherein the wiper is configured to move relative to the structural support, such that an axis along a length of the wiper shifts between (i) a non-parallel position relative to a surface of the area and (ii) a substantially parallel position relative to the surface of the area; and an optical source configured to provide light to the mixture to form the at least the portion of the 3D object; and (b) using the deposition unit to (1) spread the mixture over the area or (2) remove the at least the portion of the excess of the mixture from the area, via the wiper; and (c) using the optical source to provide the light to the mixture disposed adjacent to the area of the platform for the printing.

In another aspect, the present disclosure provides a system for printing a 3D object, comprising: an optical source configured to provide light to a mixture, wherein the light is sufficient to cause formation of at least a portion of the 3D object during the printing; a build head configured to support the at least the portion of the 3D object; a platform comprising an area configured to hold the mixture adjacent to the build head, such that at least a portion of the mixture is disposed under compression between the area and the build head during the printing; and a sensor configured to detect an optical profile of at least a portion of the mixture that is under the compression.

In another aspect, the present disclosure provides a method for printing a 3D object, comprising: (a) providing: an optical source configured to provide light to a mixture, wherein the light is sufficient to cause formation of at least a portion of the 3D object during the printing; a build head configured to support the at least the portion of the 3D object; a platform comprising an area configured to hold the mixture adjacent to the build head, such that at least a portion of the mixture is disposed under compression between the area and the build head during the printing; and a sensor configured to detect an optical profile of at least a portion of the mixture that is under the compression; (b) using the sensor to detect the optical profile of the at least the portion of the mixture that is under the compression; and (c) using the optical source to provide the light to the mixture disposed adjacent to the area of the platform for the printing.

In another aspect, the present disclosure provides a method for printing a 3D object, comprising: (a) providing a plurality of mixtures comprising: a first mixture comprising (i) a first polymeric precursor configured to form a first polymeric material and (ii) a first plurality of particles; and a second mixture comprising (i) a second polymeric precursor configured to form a second polymeric material and (ii) a second plurality of particles, wherein a first concentration of the first plurality of particles in the first mixture is different than a second concentration of the second plurality of particles in the second mixture; (b) directing a light to the first polymeric material in the first mixture to form the first polymeric material, thereby to print a first layer of the 3D object comprising at least a portion of the first plurality of particles; and (c) subsequent to (b), directing the light or an additional light to at least the second polymeric material in the second mixture to form the second polymeric material, thereby to print a second layer of the 3D object comprising at least a portion of the second plurality of particles.

In another aspect, the present disclosure provides a kit comprising a plurality of mixtures for forming a 3D object, wherein the plurality of mixtures comprises: a first mixture comprising (i) a first polymeric precursor configured to form a first polymeric material and (ii) a first plurality of particles, wherein at least a portion of the first mixture is usable for forming a first layer of the 3D object; and a second mixture comprising (i) a second polymeric precursor configured to form a second polymeric material and (ii) a second plurality of particles, wherein at least a portion of the second mixture is usable for forming a second layer of the 3D object, wherein a first concentration of the first plurality of particles in the first mixture is different than a second concentration of the second plurality of particles in the second mixture.

In another aspect, the present disclosure provides a system for printing a 3D object, comprising: a platform comprising a top surface and a plurality of side surfaces, wherein the top surface of the platform is configured to hold a film for carrying a mixture for printing at least a portion of the 3D object; a perimeter wall disposed adjacent to and surrounding the plurality of side surfaces of the platform, wherein at least a portion of the perimeter wall is not in direct contact with at least a portion of a side surface of the plurality of side surfaces, such that the at least the portion of the perimeter wall and the at least the portion of the side surface are separated by a gap; a vacuum unit in fluid communication with the gap, wherein the vacuum unit is configured to provide suction through the gap; and a controller operatively coupled to the vacuum unit, wherein the controller is configured to direct the vacuum unit to provide the suction through the gap to a bottom surface of the film, when the film is disposed adjacent to the top surface of the platform.

In another aspect, the present disclosure provides a method for printing a 3D object, comprising: (a) providing: a platform comprising a top surface and a plurality of side surfaces, wherein the top surface of the platform is configured to hold a film for carrying a mixture for printing at least a portion of the 3D object; a perimeter wall disposed adjacent to and surrounding the plurality of side surfaces of the platform, wherein at least a portion of the perimeter wall is not in direct contact with at least a portion of a side surface of the plurality of side surfaces, such that the at least the portion of the perimeter wall and the at least the portion of the side surface are separated by a gap; and a vacuum unit in fluid communication with the gap, wherein the vacuum unit is configured to provide suction through the gap; and (b) using the vacuum unit to provide the suction through the gap to a bottom surface of the film, when the film is disposed adjacent to the top surface of the platform.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “Figure” and “FIG.” herein), of which:

FIGS. 1A-1C show examples of a platform comprising a plurality of actuators;

FIGS. 2A-2D show examples of a platform comprising a support unit;

FIG. 3A shows a top view of an optical source assembly;

FIG. 3B shows a perspective view of an optical source assembly;

FIG. 3C shows a perspective view of an optical source assembly;

FIGS. 4A-4G schematically illustrate an example of a transfer unit;

FIG. 5A schematically illustrates an example of a transfer unit and coupling of the transfer unit with a film frame;

FIG. 5B schematically illustrates an example of a transfer unit and coupling of an upper film frame and a lower film frame;

FIG. 5C schematically illustrates vertical movements of transfer unit;

FIGS. 6A and 6B schematically illustrate an example film frame;

FIG. 6C schematically illustrates a film installation on a film frame;

FIG. 7A schematically illustrates a platform and a collection unit;

FIG. 7B schematically illustrates a platform with vacuum unit;

FIG. 7C shows an example of configuration for film sealing;

FIG. 7D shows a perspective view of an example platform;

FIG. 7E shows a cross sectional view of an example platform;

FIG. 7F shows a cross sectional view of an example platform;

FIG. 8A schematically illustrates a wiper assembly with a dampener;

FIG. 8B schematically illustrates a side view of a wiper assembly with a dampener;

FIG. 8C schematically illustrates a dampener;

FIG. 8D schematically illustrates a side view of a wiper assembly with a wiper and an additional wiper;

FIG. 9A schematically illustrates a distributed dispense manifold;

FIG. 9B schematically illustrates a surface of a dispense housing;

FIG. 9C schematically illustrates a sealing feature of a dispense housing;

FIG. 9D schematically illustrates an example of valves and operations for the dispensing;

FIG. 9E schematically illustrates an array of dispensed mixtures from a distributed dispense manifold;

FIG. 10A schematically illustrates a wiper assembly;

FIG. 10B schematically illustrates a wiper assembly and coupling with a deposition unit;

FIG. 11A schematically illustrates a deposition unit and a sensor;

FIG. 11B schematically illustrates a deposition unit, a sensor and an optical source;

FIG. 11C illustrates images taken by a sensor during a compression of a mixture;

FIGS. 12A-12H illustrate particle content during a printing process; and

FIG. 13 shows a computer system that is programmed or otherwise configured to implement methods provided herein.

### DETAILED DESCRIPTION

While various embodiments of the present disclosure have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments of the present disclosure described herein may be employed.

The term “three-dimensional object” (also “3D object”), as used herein, generally refers to an object or a part that is printed by three-dimensional (“3D”) printing. The 3D object may be at least a portion of a larger 3D object or an entirety of the 3D object. The 3D object may be fabricated (e.g., printed) in accordance with a computer model of the 3D object.

The term “platform,” as used herein, generally refers to a structure that supports a mixture (e.g., a liquid) or a film of the mixture during 3D printing. The mixture may have a viscosity that is sufficient to permit the mixture to remain on or adjacent to the platform during 3D printing. The platform may be flat. The platform may include an optically transparent or semi-transparent print window or exposure window (e.g., glass or a polymer) to direct light (e.g., one or more lights) through the window and to the mixture or the film of the mixture. Alternatively or in addition to, the light may be directed from above and/or one or more sides of the platform. The platform may have various shapes. The platform may be a rectangle or a ring, for example.

The platform may comprise one or more walls adjacent to the platform, such as at least 1, 2, 3, or 4 walls. The walls may enclose the platform. During printing, a property (e.g., viscosity) of a mixture used for printing may be sufficient to keep the mixture adjacent to the platform without sufficient flow of the mixture towards the one or more walls. In some examples, the walls prevent flow of the mixture out of the open platform. In some examples, the platform may be part (e.g., a bottom portion) of a container or a vat.

The platform may be an “open platform” that is not bounded by any wall. The open platform may not be vat or a container. The open platform may not be part of a vat or a container. The open platform may be a substrate or slab that does not have a depression (e.g., vat or container) for retaining a liquid. In such situations, the mixture may be sufficiently viscous such that the mixture remains on the open platform. The open platform may include one or more sides that are not bounded.

The platform may comprise an area configured to hold the mixture. The area may be at least a portion of the platform (e.g., at least a portion of a surface of the platform). The area may be an additional object (e.g., a sheet, plaster, film, glass, window, etc.) disposed on or adjacent to the platform. The area may be stationary relative to the platform. Alternatively or in addition to, the area may be movable relative to the platform.

At least a portion of the platform may be flexible. Alternatively or in addition to, at least a portion of the platform may be rigid. The platform may be movable between two or more locations. The platform may be positioned over or adjacent to a base. At least a portion of the base may be transparent or semi-transparent to direct light (e.g., sensor light or photoinitiation light) through the base and towards the platform. The base may be flexible. Alternatively or in addition to, at least a portion of the base may be rigid. Such base may be a slab, which slab may be transparent, semi-transparent, opaque, or not transparent.

In an example, the base may comprise at least one window (e.g., at least 1, 2, 3, 4, 5, or more windows), each window having a thickness that is thinner than, substantially equivalent to, or thicker than the platform as disclosed herein. In another example, the base may comprise at least one belt (e.g., at least 1, 2, 3, 4 ,5, or more belts), each belt having a thickness that is thinner than, substantially equivalent to, or thicker than the platform as disclosed herein. In a different example, a platform as disclosed herein (e.g., a transparent or semi-transparent polymer sheet) may be a part of a belt. The belt as disclosed herein may be a roll-to-roll belt system comprised of a transparent or semi-transparent sheet (e.g., polymer sheet), wherein the sheet is provided from a payout roll and ultimately collected by a separate take-up roll. Alternatively, the belt as disclosed herein may be a single continuous belt (or a continuous roll) operatively coupled to a plurality of actuators (e.g., wheels) to control movement and/or configuration of the single roll during printing. Yet in a different example, a platform as disclosed herein may be disposed over a surface of such belt system. In some cases, a belt may be configured to direct movement of one or more different platforms. Alternatively, the 3D printing system may comprise a plurality of different platforms, and each belt may be configured to direct movement of at least one platform. For example, a first belt may be configured to direct movement of a platform from point A to point B, and the platform may be transferred from the first belt to a second and subsequent belt to direct movement of the platform from point B to point C. Point B may be a location where the first and second belts come in proximity to each other. One or more belts as disclosed herein may be operatively coupled to one or more rotational actuators for direct rotation of the one or more belts.

The term “print surface,” as used herein, generally refers to at least a portion of the platform (e.g., a print area or print window or exposure window) or at least a portion of an object disposed on or adjacent to the platform (e.g., a film) that is configured to hold a film of the mixture or any excess thereof during the 3D printing.

The term “build head,” as used herein, generally refers to a structure that supports at least a portion of a printed 3D object (or another object onto which a 3D object may be printed). During the 3D printing, the build head or the at least the portion of the printed 3D object that is disposed on the build head may be in contact with a mixture (e.g., a film of a mixture), and at least a portion of the mixture may be formed into a new portion (e.g., layer) of the 3D object.

A relative distance between the platform (e.g., a print window of the platform, a film disposed on or adjacent to the platform) and the build head may be adjustable (e.g., by one or more actuators coupled to the platform and/or the build head). A relative position of the build head with respect to the platform may be adjustable. The build head may be movable relative to the platform. Hence, the moving piece may be the build head, the platform, or both. A distance between a surface of the build head and a surface of the platform may be adjustable by the one or more actuators. A relative movement between the build head and at least a portion of the platform (e.g., a print window of the platform, a film disposed on or adjacent to the platform) may comprise one or more motions, such as, for example, sliding, rotating, and/or twisting motions. Such relative movement may take place in one or more coordinate directions (e.g., x-, y-, and/or z-axis).

The term “sensor,” as used herein, generally refers to a device, system, or a subsystem that provides a feedback (e.g., electromagnetic radiation absorbance and/or reflectance, image, video, distance, pressure, force, electrical current, electrical potential, magnetic field, position, angle, displacement, distance, speed, acceleration, etc.). Such feedback may correspond to or be correlated with one or more components of the 3D printing system (e.g., a mixture of a film of a mixture, the build head, the platform, etc.) or the 3D printing process (e.g., deposition of a film of a mixture over an area of the platform, etc.). Examples of the sensor can include, but are not limited to, light sensor, speed sensor, pressure sensor, tactile sensor, chemical sensor, current sensor, electroscope, galvanometer, hall effect sensor, hall probe, magnetic anomaly detector, magnetometer, magnetoresistance, magnetic field sensor (e.g., microelectromechanical systems (MEMS) magnetic field sensor), metal detector, planar hall sensor, voltage detector, etc. Additional examples of the sensor can include, but are not limited to, capacitive displacement sensor, flex sensor, free fall sensor, gyroscopic sensor, impact sensor, inclinometer, piezoelectric sensor, linear encoder, liquid capacitive inclinometers, odometer, photoelectric sensor, piezoelectric sensor, position sensor, angular rate sensor, rotary encoder, shock detector (i.e., impact monitor), tilt sensor, ultrasonic thickness gauge, variable reluctance sensor, velocity receiver, a colorimeter, infrared sensor, photodetector, phototransistor, force sensor, tactile sensor, strain gauge, temperature sensor, Doppler radar, motion detector, proximity sensor, speed sensor, etc. In some cases, the sensor may be a switch, comprising, for example, a contact switch (e.g., a high precision contact switch), a limit switch, a reed switch. In some cases, the sensor may be a level.

The terms “mixture,” and “viscous liquid,” as used interchangeably herein, generally refer to a material that is usable to print a 3D object. The mixture may be referred to as a resin. The mixture may be dispensed from a nozzle and over an area. Such area can be an area of a platform (e.g., a print window) or a film (e.g., an opaque, transparent, and/or a semi-transparent film). The mixture may be a liquid, semi-liquid, or solid. The mixture may have a viscosity sufficient to be self-supporting on the print window without flowing or sufficient flowing. The viscosity of the mixture may range, for example, from about 4,000 centipoise (cP) to about 2,000,000 cP. The mixture may be pressed (e.g., by a wiper or a build head) into a film of the mixture on or over such area (e.g., the print window, the film, etc.). A thickness of the film of the mixture may be adjustable. The mixture may include a photoactive resin. The photoactive resin may include a polymerizable and/or cross-linkable component (e.g., a precursor) and a photoinitiator that activates curing of the polymerizable and/or cross-linkable component, to thereby subject the polymerizable and/or cross-linkable component to polymerization and/or cross-linking. The photoactive resin may include a photoinhibitor that inhibits curing of the polymerizable and/or cross-linkable component. In some examples, the mixture may include a plurality of particles (e.g., polymer particles, metal particles, ceramic particles, combinations thereof, etc.). In such a case, the mixture may be a slurry or a photopolymer slurry. The mixture may be a paste. The plurality of particles may be added to the mixture. The plurality of particles may be solids or semi-solids (e.g., gels). Examples of non-metal material include metallic, intermetallic, ceramic, polymeric, or composite materials. The plurality of particles may be suspended throughout the mixture. The plurality of particles in the mixture may have a distribution that is monodisperse or polydisperse. In some examples, the mixture may contain additional optical absorbers and/or non-photoreactive components (e.g., fillers, binders, plasticizers, stabilizers such as radical inhibitors, etc.). The 3D printing may be performed with at least 1, at least 2, at least 3, at least 4, at least 5, at least 6, at least 7, at least 8, at least 9, at least 10or more mixtures. A plurality of mixtures comprising different materials (e.g., different photoactive resin and/or different plurality of particles) may be used for printing a multi-material 3D object.

The term “particles,” as used here, generally refers to any particulate material that may be incorporated into the mixture. The particles may be incorporated to alter (e.g., increase, decrease, stabilize, etc.) a material property (e.g., viscosity) of the mixture. The particles may be configured to be melted or sintered (e.g., not completely melted). The particulate material may be in powder form. The particles may be inorganic materials. The inorganic materials may be metallic (e.g., aluminum or titanium), intermetallic (e.g., steel alloys), ceramic (e.g., metal oxides) materials, or any combination thereof. The powders may be coated by one or more polymers. The term “metal” or “metallic” generally refers to both metallic and intermetallic materials. The metallic materials may include ferromagnetic metals (e.g., iron and/or nickel). The particles may have various shapes and sizes. For example, a particle may be in the shape of a sphere, cuboid, or disc, or any partial shape or combination of shapes thereof. The particle may have a cross-section that is circular, triangular, square, rectangular, pentagonal, hexagonal, or any partial shape or combination of shapes thereof. Upon heating, the particles may sinter (or coalesce) into a solid or porous object that may be at least a portion of a larger 3D object or an entirety of the 3D object. The 3D printing may be performed with at least 1, at least 2, at least 3, at least 4, at least 5, at least 6, at least 7, at least 8, at least 9, at least 10 or more types of particles.

The terms “a film of a mixture” and “a layer of mixture,” as used interchangeably herein, generally refer to a layer of the mixture that is usable to print a 3D object. The film of the mixture may have a uniform or non-uniform thickness across the film of the mixture. The film of the mixture may have an average thickness or a variation of the thickness that is below, within, or above a defined threshold (e.g., a value or a range). The average thickness or the variation of the thickness of the film of the mixture may be detectable and/or adjustable during the 3D printing. An average (mean) thickness of the film of the mixture may be an average of thicknesses from at least about 2, at least about 3, at least about 4, at least about 5, at least about 6, at least about 7, at least about 8, at least about 9, at least about 10, at least about 15, at least about 20, at least about 30, at least about 40, at least about 50, at least about 100, at least about 200, at least about 300, at least about 400, at least about 500, at least about 1000, at least about 2000, at least about 3000, at least about 4000, at least about 5000, or more positions within the film of the mixture. An average (mean) thickness of the film of the mixture may be an average of thicknesses from at most about 5000, at most about 4000, at most about 3000, at most about 2000, at most about 1000, at most about 500, at most about 400, at most about 300, at most about 200, at most about 100, at most about 50, at most about 40, at most about 30, at most about 20, at most about 15, at most about 10, at most about 9, at most about 8, at most about 7, at most about 6, at most about 5, at most about 4, at most about 3, or at most about 2 positions within the film of the mixture. A variation of the thickness of the film of the mixture may be a variance (i.e., sigma squared or “σ²”) or standard deviation (i.e., sigma or “σ”) within a set of thicknesses from the at least about 2, at least about 3, at least about 4, at least about 5, at least about 6, at least about 7, at least about 8, at least about 9, at least about 10, at least about 15, at least about 20, at least about 30, at least about 40, at least about 50, at least about 100, at least about 200, at least about 300, at least about 400, at least about 500, at least about 1000, at least about 2000, at least about 3000, at least about 4000, at least about 5000, or more positions within the film of the mixture. A variation of the thickness of the film of the mixture may be a variance or standard deviation within a set of thicknesses from the at most about 5000, at most about 4000, at most about 3000, at most about 2000, at most about 1000, at most about 500, at most about 400, at most about 300, at most about 200, at most about 100, at most about 50, at most about 40, at most about 30, at most about 20, at most about 15, at most about 10, at most about 9, at most about 8, at most about 7, at most about 6, at most about 5, at most about 4, at most about 3, or at most about 2 positions within the film of the mixture.

During 3D printing, one or more parameters (e.g., (1) a speed of deposition of a film of a mixture adjacent to a surface of an area of a platform (e.g., a print window, a film, etc.), (2) a speed of extrusion of the mixture from a nozzle onto the area of the platform, (3) an amount of the mixture extruded onto the area of the platform, (4) intensity and/or exposure time of one or more lights from one or more optical sources, (5) a speed of a relative movement between the platform and the build head, (6) a speed of a relative movement of the platform between a deposition unit and a printing unit, (7) a force exerted by the build head onto the mixture on or adjacent to the platform, etc.) may be maintained or adjusted to maintain or improve print quality (e.g., a quality of the film of the mixture prior to printing at least a portion of the 3D object, or the printed portion of the 3D object, etc.).

The film of the mixture that is usable to print the 3D object may or may not be re-deposited (e.g., adjacent to the area of the platform) prior to printing at least a portion of the 3D object. For re-deposition, the film of the mixture that is usable to print the 3D object may be removed and a new film of the mixture may be re-deposited prior to printing at least a portion of the 3D object. Access mixture from the removed film may or may not be recycled to deposit the new film of the mixture. In some examples, the film of the mixture may be re-deposited until a desired (e.g., pre-determined) thickness, average thickness, a variation of the thickness, area, average area, and/or a variation of the area is obtained.

The term “deposition head,” as used herein, generally refers to a part that may move across an area of a platform configured to hold a mixture (e.g., a print window a platform, a film on or adjacent to the platform, etc.). The deposition head may move across the area and deposit a mixture (e.g., a pool or film of a mixture) over the area. The film of the mixture may have a uniform thickness across the print window. The film of the mixture may not have a uniform thickness across the print window. The thickness of the film may be adjustable. The deposition head may be coupled to a motion stage adjacent to at least the area of the platform. The deposition head may have at least one nozzle to dispense at least one mixture (e.g., a mixture) over the area of the platform. The deposition head may have at least one wiper to form the layer (or film) of the mixture or remove any excess mixture from the area. The deposition head may have at least one actuator to adjust a distance between the at least one wiper and the area of the platform (thereby to adjust a desired thickness of the film of the mixture). In some examples, the deposition head may have a slot die. The deposition head may retrieve any excess mixture from the area of the platform, contain the excess mixture within the deposition head, and/or recycle the retrieved mixture when printing subsequent portions of the 3D object. The deposition head may clean the area of the platform.

The 3D printing may be performed with at least 1, at least 2, at least 3, at least 4, at least 5, at least 6, at least 7, at least 8, at least 9, at least 10 or more deposition heads. Each of a plurality of deposition heads may be in fluid communication with a separate source of mixture. The plurality of deposition heads may be used to deposit and cure alternating films of different mixtures (e.g., different photoactive resins and/or different inorganic particles). Compartmentalizing different mixtures in separate sources and separate deposition heads may improve printing speed and prevent cross-contamination of the different mixtures.

The term “nozzle,” as used herein, generally refers to a component of the deposition head that directs the mixture towards the area of the platform. The nozzle may include an opening for the mixture to enter and an additional opening for the mixture to exit. The nozzle may not comprise any contraction or control mechanism to adjust flow of the mixture towards the open platform. As an alternative, the nozzle may comprise a contraction or control mechanism to adjust the flow of the mixture towards the open platform.

The term “wiper,” as used herein, generally refers to a part that may be in contact with the area of the platform configured to hold a mixture, the mixture, or another wiper. In some examples, the wiper may be a component of a deposition head. The wiper may be in contact with a mixture to press the mixture into a film. The wiper may be in contact with the area of the platform to remove any excess mixture. A distance between the wiper and the area of the platform may be adjustable. In some examples, the wiper may be a component in a cleaning zone. The wiper may be in contact with another wiper to remove any excess mixture. The wiper may have various shapes, sizes, and surface textures. The wiper may be a blade (e.g., a squeegee blade, a doctor blade), roller, or rod (e.g., wire wound rod), for example. The 3D printing may be performed with at least 1, at least 2, at least 3, at least 4, at least 5, at least 6, at least 7, at least 8, at least 9, at least 10 or more wipers. In some examples, the blade is part of the nozzle or attached to the nozzle.

The deposition head may be a container with an exit orifice opened towards the area of the platform configured to hold the mixture. The mixture may be poured out from the deposition head, through the exit orifice, and towards the area of the platform. The deposition head may be mobile or stationary when the mixture is poured out towards the area of the platform.

One or more lights (e.g., from one or more optical sources) may be used to initiate (activate) curing of a portion of the mixture, thereby to print at least a portion of the 3D object. The one or more lights (e.g., from one or more optical sources) may be used to inhibit (prevent) curing of a portion of the mixture adjacent to an area of the platform (e.g., a print window, a film on or adjacent to the platform, etc.). The one or more lights (e.g., from one or more optical sources) may be used by one or more sensors to determine a profile and/or quality of the mixture (e.g., the film of the mixture) prior to, during, and subsequent to printing the at least the portion of the 3D object.

The 3D printing may be performed with one wavelength. The 3D printing may be performed with at least 1, at least about 2, at least about 3, at least about 4, at least about 5, at least about 6, at least about 7, at least about 8, at least about 9, at least about 10 or more wavelengths that are different. The 3D printing may be performed with at least 1, at least about 2, at least about 3, at least about 4, at least about 5, at least about 6, at least about 7, at least about 8, at least about 9, at least about 10 or more lights. The 3D printing may be performed with at least 1, at least about 2, at least about 3, at least about 4, at least about 5, at least about 6, at least about 7, at least about 8, at least about 9, at least about 10 or more optical sources, and it may be desirable to prevent curing of a portion of the mixture (e.g., a film of the mixture) adjacent to the area of the platform (e.g., a print window, a film on or adjacent to the platform, etc.).

The one or more lights may comprise electromagnetic radiation. The term “electromagnetic radiation,” as used herein, generally refers to one or more wavelengths from the electromagnetic spectrum including, but not limited to x-rays (about 0.1 nanometers (nm) to about 10.0 nm; or about 10¹⁸ Hertz (Hz) to about 10¹⁶ Hz), ultraviolet (UV) rays (about 10.0 nm to about 380 nm; or about 8×10¹⁶ Hz to about 915 Hz), visible light (about 380 nm to about 750 nm; or about 8×10¹⁴ Hz to about 4×10¹⁴ Hz), infrared (IR) light (about 750 nm to about 0.1 centimeters (cm); or about 4×10¹⁴ Hz to about 5×10¹¹ Hz), and microwaves (about 0.1 cm to about 100 cm; or about 10⁸ Hz to about 5×10¹¹ Hz).

The one or more optical sources may comprise an electromagnetic radiation source. The term “electromagnetic radiation source,” as used herein, generally refers to a source that emits electromagnetic radiation. The electromagnetic radiation source may emit one or more wavelengths from the electromagnetic spectrum.

The term “photoinitiation,” as used herein, generally refers to a process of subjecting a portion of a mixture (e.g., a film of the mixture) to a light to cure a photoactive resin in the portion of the mixture. The light (i.e., “photoinitiation light”) may have a wavelength that activates a photoinitiator that initiates curing of a polymerizable and/or cross-linkable component (e.g., monomers, oligomers, etc.) in the photoactive resin.

The term “photoinhibition,” as used herein, generally refers to a process of subjecting a portion of a mixture (e.g., a film of a mixture) to a light to inhibit curing of a photoactive resin in the portion of the mixture. The light (i.e., “photoinhibition light”) may have a wavelength that activates a photoinhibitor that inhibit curing of a polymerizable and/or cross-linkable component in the photoactive resin. The wavelength of the photoinhibition light and another wavelength of a photoinitiation light may be different. In some examples, the photoinhibition light and the photoinitiation light may be projected from the same optical source. In some examples, the photoinhibition light and the photoinitiation light may be projected from different optical sources.

The term “diffuser,” as used herein, generally refers to a sheet (e.g., a plate) or a film (e.g., a laminate or coating on an optical lens or a window) that diffuses energy (e.g., light). The diffuser may scatter or filter the energy. The diffuser may receive one or more electromagnetic radiations (e.g., IR lights) on a first side of the diffuser, then transmit scattered (e.g., distributed, evenly distributed, etc) electromagnetic radiations from a second side of the diffuser opposite the first side. The transmitted scattered electromagnetic radiations may form a flood electromagnetic radiation. The diffuser may eliminate bright spots corresponding to location(s) of one or more electromagnetic radiation sources. Flux of the scattered electromagnetic radiations from the diffuser may be independent of angle with respect to the diffuser and/or of position within a surface of the diffuser. The diffuser may cause light to spread evenly across a surface (e.g., a surface of the diffuser), thereby minimizing or removing high intensity bright spots as the light travels through the diffuser.

The term “profile,” as used herein, generally refers to a view (e.g., image or video) and/or electromagnetic spectrum with respect to such components. The view may be a side view, bottom-up view, or top-down view. The view may comprise an outline, silhouette, contour, shape, form, figure, structure of the components. The electromagnetic spectrum may be absorption, emission, and/or fluorescence spectrum of at least a portion of the electromagnetic radiation (e.g., IR radiation). The profiles may be indicative of one or more features of the components. In an example, the sensor may be capable of sensing or detecting and/or analyzing zero-dimensional (e.g., a single point), one-dimensional (1D), two-dimensional (2D), and/or 3D profiles (e.g., features) of the components.

The 3D printing system may be surrounded by an enclosure (e.g., a case or fabric). The enclosure may prevent external energy (e.g., ambient light) from interfering with one or more lights used during the 3D printing.

The term “green body,” as used herein, generally refers to a 3D object that has a polymeric material and a plurality of particles (e.g., metal, ceramic, or both) that are encapsulated by the polymeric material. The plurality of particles may be in a polymer (or polymeric) matrix. The plurality of particles may be capable of sintering or melting. The green body may be self-supporting. The green body may be heated in a heater (e.g., in a furnace) to burn off at least a portion of the polymeric material and coalesce the plurality of particles into at least a portion of a larger 3D object or an entirety of the 3D object.

The term “brown body,” as used herein, generally refers to a green body that has been treated (e.g., solvent treatment, heat treatment, pressure treatment, etc.) to remove at least a portion (e.g., at least about 20 percent (%), at least about 30%, at least about 40%, at least about 50%, at least about 60%, at least about 70%, at least about 80%, at least about 90%, at least about 95%, or more; at most about 100%, at most about 95%, at most about 90%, at most about 80%, at most about 70%, at most about 60%, at most about 50%, at most about 40%, at most about 30%, at most about 20%, or less) of the polymeric material within the green body. The brown body may comprise the plurality of particles of the green body. The plurality of particles may be capable of sintering or melting. The brown body may be self-supporting. The brown body may be heated in a heater (e.g., in a furnace) to burn off at least a portion of any remaining polymeric material and coalesce the plurality of particles into at least a portion of a larger 3D object or an entirety of the 3D object.

The present disclosure provides methods and systems for forming a 3D object. Such methods may employ application of a film of a mixture adjacent to an area of a platform and exposing the film to light to subject at least a portion of the film to polymerization and/or cross-linking. The 3D object may be based on a computer model of the 3D object, such as a computer-aided design (CAD) stored in a non-transitory computer storage medium (e.g., medium).

### Systems for 3D Printing

Three-dimensional (3D) printing systems and methods (e.g., layer-by-layer 3D printing) can utilize repeating a serial process comprising (i) preparation (e.g., deposition) of a printing material (e.g., a layer of powder, mixture, resin, etc.) for printing and (ii) printing (e.g., solidification, curing, fusion, laser sintering, etc.) at least a portion of the printing material into at least a portion of a 3D object. Thus, a time to produce a layer of the 3D object may be the sum of at least the steps (i) and (ii), and such production may be time-consuming. In view of the foregoing, there exists a considerable need for alternative systems and methods to reduce the production time.

A 3D printing system can comprise at least one platform configured to hold a film of at least one mixture. The at least one platform may comprise a window (e.g., a solid window or a transparent/semi-transparent film). The system can further comprise a deposition unit comprising a nozzle in fluid communication with at least one source of the at least one mixture (e.g., one source of one mixture, multiple sources of the same mixture, multiple sources of different mixtures, etc.). The deposition unit can be configured to deposit the film onto the at least one platform. The system can further comprise an optical source configured to provide a light sufficient for curing at least a portion of the film, to form at least a portion of the 3D object. The system can further comprise a controller (or a processor) operatively coupled to the at least one platform. The controller can further be operatively coupled to the deposition unit. The controller can further be operatively coupled to the optical source.

### Leveling and Alignment

In an aspect, the present disclosure provides a system for printing a 3D object. The system can comprise an optical source configured to provide light to a mixture, wherein the light is sufficient to cause formation of at least a portion of the 3D object during the printing. The system can comprise a build head configured to support the portion of the 3D object. The system can comprise a platform comprising an area configured to hold the mixture adjacent to the build head. The system can further comprise a plurality of actuators operatively coupled to the platform. In some embodiments, the plurality of actuators can be configured to adjust a movement between the area and the build head relative to one another, along a plurality of degrees of freedom. In some embodiments, the plurality of actuators can be configured to adjust a movement between the area and the optical source relative to one another.

In some embodiments, during printing, the build head can move along a direction towards or away from the platform. In some embodiments, the system can comprise a controller to move the build head toward or away from the platform.

In some embodiments, the plurality of actuators can be configured to substantially maintain the leveling of the platform (e.g., relative to the ground on which the printing system is on, relative to another component of the 3D printing system such as the build head or the optical source) during the printing. Maintaining the leveling of the platform can achieve more uniform thickness of the deposited mixture and prevent the change of thickness during the printing, thereby maintaining or enhancing quality of the print product.

In some embodiments, the plurality of actuators can comprise any suitable actuators. In some embodiments, the plurality of actuators can comprise a mechanical actuator, a stepper actuator, linear actuator, hydraulic actuator, pneumatic actuator, electric actuator, magnetic actuator. In some embodiments, the plurality of actuators can comprise a motorized actuator.

In some embodiments, the plurality of actuators can comprise a leveling wedge, e.g., a spring-return leveling wedge. In some embodiments, the plurality of actuators can be operated by a user of the system. In some embodiments, the plurality of actuators can be operated automatically by a program of the 3D printer system. In some embodiments, the plurality of actuators can comprise servomotor, brushed electric motor, brushless electric motor (e.g., stepper motor), torque motor, and shaft actuator (e.g., hollow shaft actuator). In some embodiments, the system can comprise a controller that is operatively coupled to the plurality of actuators. In some embodiments, the plurality of actuators can be operated by the controller.

The plurality of actuators can comprise at least 1, at least 2, at least 3, at least 4, at least 5, at least 6, at least 7, at least 8, at least 9, at least 10, or more actuators. The plurality of actuators can comprise at most 10, at most 9, at most 8, at most 7, at most 6, at most 5, at most 4, or less actuators. The plurality of actuators can comprise at least 1 type, at least 2 types, at least 3 types, at least 4 types, at least 5 types, or more of actuators. The plurality of actuators can comprise at most 5 types, at most 4 types, at most 3 types, or less of actuators.

In some embodiments, the plurality of actuators can be configured to adjust movement of the area relative to the build head, while the build head remains stationary. In some embodiments, the plurality of actuators can be configured to adjust movement of the area relative to the optical source, while the build head remains stationary.

In some embodiments, the plurality of degrees of freedom can comprise one, two, three, four, five, or six members selected from the group consisting of x, y, z, pitch, yaw, and roll.

In some embodiments, the plurality of degrees of freedom can comprise pitch and yaw.

In some embodiments, the relative movement between the area and the optical source can be along a plurality of degrees of freedom comprising one, two, three, four, five, or six members selected from the group consisting of x, y, z, pitch, yaw, and roll. In some embodiments, the plurality of degrees of freedom can comprise pitch and yaw.

In some embodiments, the plurality of actuators can be disposed at any suitable position of the platform. In some embodiments, the plurality of actuators can be disposed at different positions of the platform. In some embodiments, the plurality of actuators can be disposed at an edge, a corner, and a center of the platform. In some embodiments, the plurality of actuators can be disposed at opposite positions relative to each other. In some embodiments, the plurality of actuators can be disposed beneath the area.

In some embodiments, the plurality of actuators can comprise a plurality of fasteners or screws to substantially maintain the leveling during the printing.

In some embodiments, the area can be transparent or semi-transparent. In some embodiments, the area can comprise an exposure window (or a print window). In some embodiments, the exposure window can be transparent or semi-transparent. In some embodiments, the optical source can be configured to provide the light through the area and towards the mixture after the mixture is disposed on the area and during the printing. In some embodiments, the platform or the area can further comprise a film for carrying the mixture, wherein the film is disposed between the mixture and the area. The film can be transparent or semi-transparent. In some embodiments, the film can comprise a polymer film, for example, a fluorinated ethylene propylene (FEP) film. The film can be held in place on the platform by a vacuum.

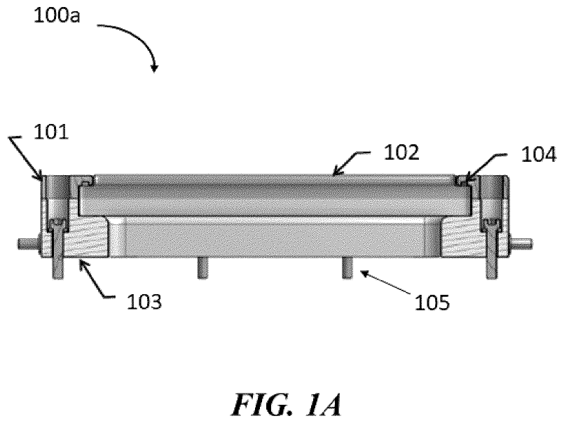

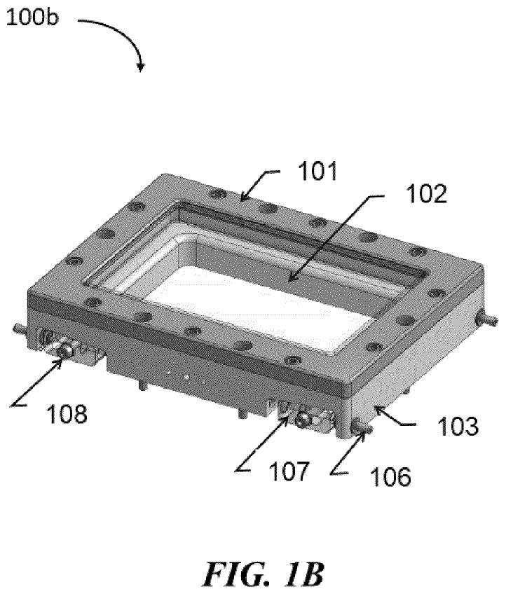

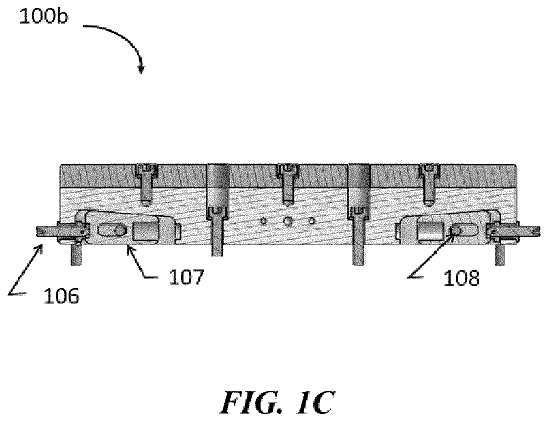

Referring to FIG. 1A, a platform 100a can comprise an upper frame 101, a lower frame 103, and an exposure window 102. The exposure window 102 can be transparent or semi-transparent. The upper frame 102 and the lower frame 103 can be clamped together with the exposure window 102 with an O-ring 104. The platform 100 a can further comprise a plurality of support units 105.

Referring to FIG. 1B, a platform 100b can be coupled to a plurality of actuators, i.e., spring-return leveling wedges 107. The wedges 107 can be disposed beneath the exposure window 102 and at the bottom of the lower frame 103. The wedges 107 can be 5-degree angle wedges. The wedges 107 can comprise a plurality of adjustment screws 106 and a plurality of lock screws 108.

The wedges 107 can adjust the platform in the X and Y axis. The wedges 107 can adjust the platform in the Z axis. By adjusting the wedges 107, the platform and the exposure window can be leveled for the printing. The lock screws 108 can retain the wedges 107 in position, thereby substantially maintaining the leveling of the platform during the printing.

FIG. 1C shows a side view of an exemplary platform 100b as described in FIG. 1B.

Using the system provided herein, the leveling can be controlled at a resolution of movement that ranges between about 10 micrometers (nm) and about 500 nm. The resolution of movement can be about 10 nm, about 20 nm, about 50 nm, about 100 nm, about 150 nm, about 200 nm, about 250 nm, about 300 nm, about 350 nm, about 400 nm, about 450 nm, or about 500 nm. And the platform and the exposure window can be maintained substantially flat during the printing.

### Support Unit

Under load, a print window or an exposure window of a platform may deflect or deform, and deflection or deformation of the print window or the exposure window may result in a layer thickness error. There is a need for a system that can minimize or eliminate the deformation of the print window or exposure window during printing.

In an aspect, the present disclosure provides a system for printing a 3D object. The system can comprise a platform comprising: (i) an exposure window configured to hold a mixture for printing at least a portion of the 3D object, wherein a bottom surface of the exposure window comprises an inner portion surrounded by an outer portion; and (ii) a support unit coupled to the inner portion of the bottom surface of the window, to provide stability to the window. The system can comprise a build head configured to support at least a portion of the 3D object. The system can further comprise an optical source configured to provide light to the mixture to form at least a portion of the 3D object.

The support unit can reduce deformation of the exposure window during printing, as compared to a control 3D printing system lacking the support unit, increasing reliability and predictability of the system. In some embodiments, the support unit can reduce deformation of the exposure window during printing by at least about 5%, at least about 10%, at least about 20%, at least about 30%, at least about 40%, at least about 50%, at least about 60%, at least about 70%, at least about 80%, at least about 90%, or more, as compared to a control 3D printing system lacing the support unit.

In some embodiments, the platform may comprise a fastener to secure the exposure window to the platform.

In some embodiments, the exposure window can be transparent or semi-transparent. In some embodiments, increased thickness of the exposure window can help reduce deformation. The exposure window can have an average thickness of at least about 2 millimeters (mm), at least about 5 mm, at least about 10 mm, at least about 15 mm, at least about 20 mm, at least about 25 mm, at least about 30 mm, at least about 35 mm, at least about 40 mm, at least about 45 mm, at least about 50 mm, at least about 60 mm, at least about 70 mm, at least about 80 mm, at least about 90 mm, at least about 100 mm, or more. In some embodiments, the exposure window can have a top surface, wherein an area of the top surface can be at least about 50 centimeter squared (cm²), at least about 100 cm² , at least about 150 cm², at least about 200 cm² , at least about 300 cm² , at least about 400 cm² , at least about 500 cm², at least about 600 cm² , at least about 700 cm² , at least about 800 cm² , at least about 900 cm², at least about 1000 cm² , at least about 1500 cm² , at least about 2000 cm² , or more. In some embodiments, the exposure window can be a glass window.

In some embodiments, the support unit can be transparent or semi-transparent. In some embodiments, the support unit can be non-transparent that light cannot pass through. In some embodiments, the upper frame can comprise a split frame.

In some embodiments, the support unit can have any suitable shape. In some embodiments, the support unit can have a cross sectional shape of circle, rectangle, square, oval, polygon, triangle, etc.

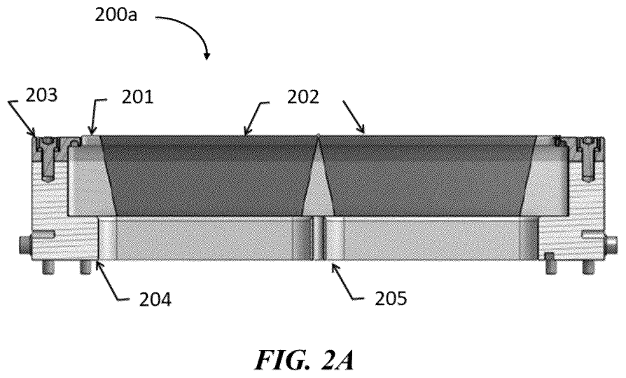

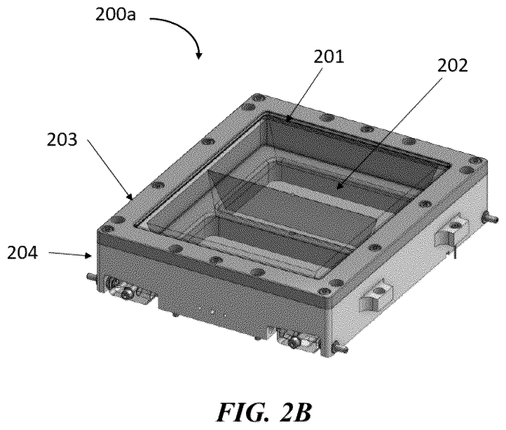

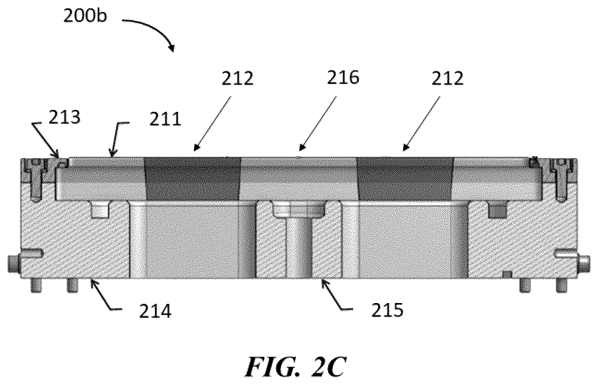

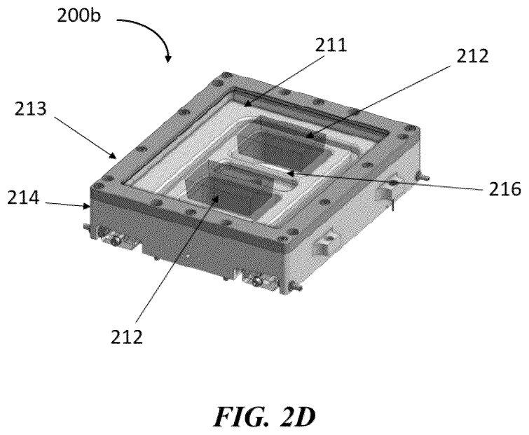

Referring to FIG. 2A and FIG. 2B, a platform 200a can comprise an upper frame 203, a lower frame 204, and an exposure window 201. The platform 200a can further comprise a support unit 205. The support unit 205 can be coupled to a center portion of the bottom surface of exposure window 201. In some embodiments, the support unit can be coupled to a portion of the bottom surface that is not a center portion. In some embodiments, the support unit can be releasably coupled to the bottom surface. An optical source can provide a light to the exposure window 201, generating projected images 202. In some embodiments, referring to FIG. 2C and FIG. 2D, a platform 200b can comprise an upper frame 213, an exposure windows 213, a lower frame 214, and a support unit 215. The projected images 212 are split, separated by an area 216 that does not project an image.

In some embodiments, the support unit is a support beam. The deflection/deformation may be highest in the center; thus it can be advantageous to have the support unit at least substantially beneath the center of a bottom surface of the exposure window.

In some embodiments, the exposure window can be raised over the upper frame. The exposure window can be raised by at least about 0.1 mm, at least about 0.2 mm, at least about 0.3 mm, at least about 0.4 mm, at least about 0.5 mm, at least about 1 mm, or more over the upper frame.

In some embodiments, the bottom surface of the exposure window can be substantially flat.

In some embodiments, the outer portion is at least about 5%, at least about 10%, at least about 20%, at least about 25%, at least about 30%, at least about 35%, at least about 40%, at least about 45%, at least about 50%, at least about 60%, at least about 70%, at least about 80%, at least about 90%, or more of the bottom surface. In some embodiments, the outer portion is at most about 90%, at most about 80%, at most about 70%, at most about 60%, at most about 55%, at most about 50%, at most about 45%, at most about 40%, at most about 35%, at most about 30%, at most about 25%, at most about 20%, or less of the bottom surface.

In some embodiments, the inner portion is at least about 5%, at least about 10%, at least about 20%, at least about 25%, at least about 30%, at least about 35%, at least about 40%, at least about 45%, at least about 50%, at least about 60%, at least about 70%, at least about 80%, at least about 90%, or more of the bottom surface. In some embodiments, the inner portion is at most about 90%, at most about 80%, at most about 70%, at most about 60%, at most about 55%, at most about 50%, at most about 45%, at most about 40%, at most about 35%, at most about 30%, at most about 25%, at most about 20%, or less of the bottom surface.

In some embodiments, the optical source can comprise a plurality of optical sources configured to provide a plurality of lights along a plurality of optical paths and towards the exposure window, wherein the support unit is disposed between the plurality of optical paths.

In some embodiments, the system can further comprise a controller operatively coupled to the optical source. The controller can be programmed to direct the optical source to provide the light to the mixture for the printing.

### Optical Source (e.g., Projector)

In an aspect, the present disclosure provides a system for printing a 3D object. The system can comprise a build head configured to support at least a portion of the 3D object during the printing. The system can comprise a platform comprising an area configured to hold a mixture adjacent to the build head. The system can further comprise an optical source configured to provide light to the mixture, wherein the light is sufficient to cause formation of the at least the portion of the 3D object. The system can further comprise an actuator operatively coupled to the optical source for controlling projection of the light onto the area. The actuator can be configured to adjust a movement between the optical source and the build head relative to one another, along a plurality of degrees of freedom. The actuator can be configured to adjust a movement between the optical source and the area relative to one another.

In some embodiments, the actuator can be configured to adjust movement of the optical source relative to the build head along the plurality of degrees of freedom. In some embodiments, the actuator can be configured to adjust movement of the optical source relative to the build head along the plurality of degrees of freedom, while the build head remains stationary. In some embodiments, the actuator can be configured to adjust movement of the optical source relative to the area. In some embodiments, the actuator can be configured to adjust movement of the optical source relative to the area, while the area remains stationary.

The capability of moving the optical source in a plurality of degrees of freedom relative to the build head or the area can provide more flexibility or capability of the optical source to provide light at different emitting angle, shape, position, orientation, or configuration.

The plurality of degrees of freedom can comprise one, two, three, four, five, or six members selected from the group consisting of x, y, z, pitch, yaw, and roll.

In some embodiments, the plurality of degrees of freedom can comprise two or three of z, pitch and yaw. In some embodiments, the degrees of freedom cam comprise x and y. In some embodiments, the degrees of the freedom can comprise x, y, and z. In some embodiments, the degrees of the freedom can comprise x and z. In some embodiments, the degrees of the freedom can comprise y and z. In some embodiments, the degrees of the freedom can comprise z and pitch. In some embodiments, the degrees of the freedom can comprise z and yaw. In some embodiments, the degrees of the freedom can comprise pitch and yaw. In some embodiments, the degrees of the freedom can comprise y, pitch, and yaw. In some embodiments, the degrees of the freedom can comprise x, y, z, pitch, yaw, and roll.

In some embodiments, the movement between the optical source and the area relative to one another can be along a plurality of degrees of freedom comprising one, two, three, four, five, or six members selected from the group consisting of x, y, z, pitch, yaw, and roll. In some embodiments, the plurality of degrees of freedom can comprise two or three of z, pitch and yaw.

In some embodiments, the optical source can comprise a plurality of optical sources, wherein each optical source of the plurality of optical sources is configured to move relative to the print head or the area along the plurality of degrees of freedom. The optical source can comprise at least 1, at least 2, at least 3, at least 4, at least 5, or more optical sources.

In some embodiments, the optical source can be operatively coupled to a module plate. The module plate can be operatively coupled to a base. In some embodiments, the module plate can move along a plurality of degrees of freedom comprise x, y, z, pitch, yaw, roll, or any combination thereof. In some embodiments, the number of degrees of freedom of the optical source can be greater than the number of degrees of freedom of the module plate. In some embodiments, the number of degrees of freedom of the optical source can be greater than the number of degrees of freedom of the module plate by 1, 2, or 3 degrees of freedom.

In some embodiments, the actuator may not be a vertical actuator. In some embodiments, the relative movement between the optical source and the build head (or the area) may not be solely along the vertical axis between the optical source and the build head (or the area). Accordingly, in some cases, such relative movement may result in horizontal and/or vertical keystone correction of a pattern of the light that is projected onto the area, the mixture, and/or the build head.

In some embodiments, the actuator can be configured to control shape of the projection of the light onto the area. In some embodiments, the actuator can be configured to control position of the projection of the light onto the area.

In some embodiments, the plurality of optical sources can provide a plurality of light projections onto the area. In some embodiments, the plurality of light projections can be adjacent to each other. In some embodiments, a light projection of the plurality of light projections can have overlap with another light projection adjacent to the light projection. In some embodiments, the overlap can be at least a size of one pixel, at least a size of two pixels, at least a size of three pixels, at least a size of 4 pixels, at least a size of 5 pixels, at least a size of 10 pixels, or more. In some embodiments, the overlap can be at most a size of 10 pixels, at most a size of 9 pixels, at most a size of 8 pixels, at most a size of 7 pixels, at most a size of 6 pixels, at most a size of 5 pixels, or less. In some embodiments, at least two of the plurality of light projections can be separated by an area which does not have a light projection.

In some embodiments, the actuator can be coupled to the optical source.

In some embodiments, the system can further comprise a base configured to hold the optical source, wherein the actuator is coupled to the base to adjust movement of the base relative to the area, thereby to control projection of the light from the optical source onto the area.

In some embodiments, the area can comprise an exposure window. The exposure window can be transparent or semi-transparent. In some embodiments, the system can further comprise a film for carrying the mixture, wherein the film is disposed between the mixture and the area.

In some embodiments, the optical source can be configured to provide the light through the area and towards the mixture for printing.

In some embodiments, the build head can be configured to move along a direction towards or away from the platform during the printing.

In some embodiments, the system can further comprise a controller operatively coupled to the actuator, wherein the controller is configured to direct the actuator to adjust the movement of the optical source relative to the build head or the area.

In some embodiments, the actuator can comprise a plurality of actuators. The plurality of actuators can comprise at least 1, at least 2, at least 3, at least 4, at least 5, or more actuators.

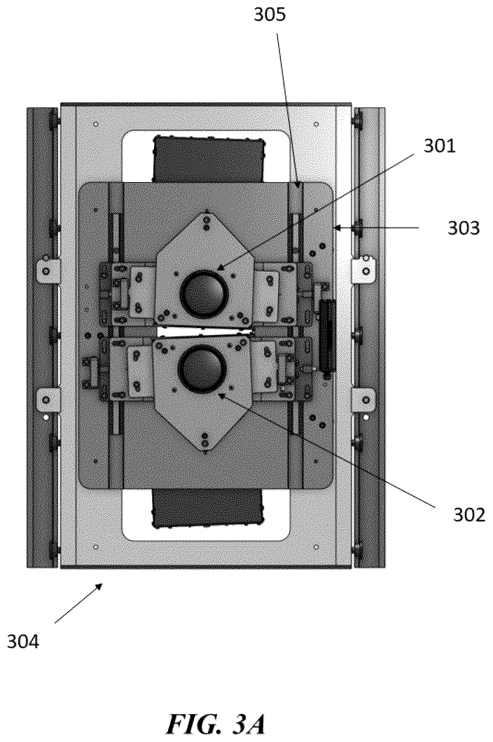

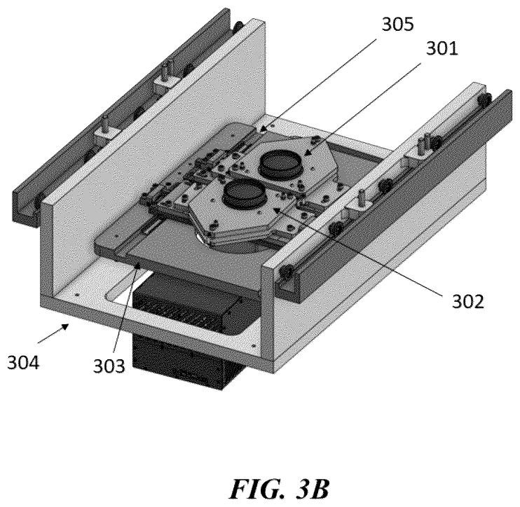

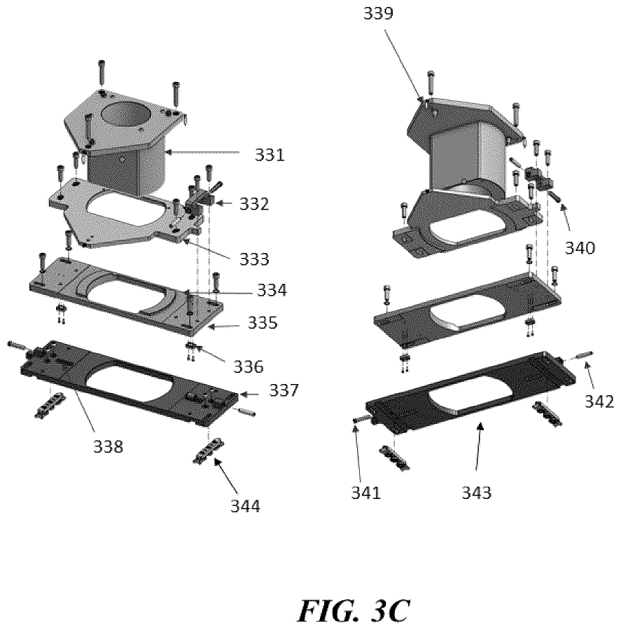

In some embodiments, the projector module can comprise two projectors. FIG. 3A and FIG. 3B show exemplary projector module. The projector module comprises a projector 301, an additional projector 302 and a module plate 303. The projector 301 can be mounted rigidly to the module plate 303. In some embodiments, the projector 301 can be mounted to the module plate 303 with a plurality of degrees of freedom, e.g., x, y, z, yaw, pitch, and/or roll. The projector 302 can be mounted to the module plate 303, with a plurality of degrees of freedom, e.g., x, y, z, yaw, pitch, and/or roll. In some embodiments, the projector 302 can be mounted rigidly to the module plate 303. The projector 302 can be adjusted to match or align with the projector 301 through the x, y, pitch, yaw and Z adjustment. The module plate 303 can be operatively coupled to a base 304. The module plate 303 can have x, y, pitch, yaw, and/or Z adjustment to further adjust the position and shape of light projections from the projectors 301 and 302.

In some embodiments, both projectors 301 and 302 can be rigidly mounted to the module plate 303. The module plate 303 can have x, y, pitch, yaw, and/or Z adjustment to adjust the position and shape of light projections from the projectors 301 and 302.

In some embodiments, three rotational axes of an object can be referred to as “roll”, “pitch”, and “yaw”. In some embodiments, as used interchangeably herein, three rotational axes of an object can be referred to “tilt”, “tip”, and “roll”. In some embodiments, use of the terms “roll”, “pitch”, and “yaw” (or “tilt”, “tip”, and “roll”) may not be limited to a traditional way of defining the three rotational axes, as long as the three rotational axes are orthogonal to one another. For example, a rotation around a front-to-back axis of the object may not need to be referred to as “roll”. Alternatively, such rotation around the front-to-back axis may be referred to as “roll”.

FIG. 3C shows exemplary prospective views of a projector assembly. The projector assembly can comprise (i) a x plate 335, (ii) a y plate 337, (iii) a roll plate 333, (iv) a z, tip, and tilt plate 331, a plurality of adjustment screws (e.g., 342), a plurality of preload compression springs (e.g., 341), a plurality of preload tension springs (e.g., 339), a plurality of bearings (e.g., 344, 336), configured to provide degrees of freedom in x, y, z, tilt, tip, and/or roll. For example, the projector assembly can house at least a portion of the optical source, and the roll plate of the projector assembly can permit the at least the portion of the optical source to roll (e.g., rotate about an axis that is substantially parallel to the optical axis of the optical source or substantially perpendicular to a top surface of the module plate as shown in FIG. 3A), thereby controlling rotation of a projected pattern of the light from the optical source on the area, e.g., for aligning the projected patterns of the lights from the plurality of optical sources.

In some embodiments, the x plate 335 can be configured to allow movement of the projector in the x axis. In some embodiments, the x plate 335 can comprise a feature 334 (e.g., tabs, cavities, or slots) to constrain roll of the projector. In some embodiments, the y plate 337 can be configured to allow movement of the projector in the y axis. In some embodiments, the y plate 337 can comprise a feature 338 (e.g., tabs, cavities, or slots) to constrain movement of the projector in the x axis. In some embodiments, the z, tip, and tilt plate 331 can be configured to allow movement of the projector in the z axis. In some embodiments, the z, tip, and tilt plate 331 can be configured to allow the projector to tip or tilt. 343 in FIG. 3C shows an example projector lens.

Referring to FIGS. 3A and 3B, each projector assembly as illustrated in FIG. 3C can be disposed on the module plate 303. The projector assembly that is housing at least a portion of the optical source can be configured to move the optical source along at least a non-vertical axis relative to the module plate 303. The non-vertical axis can be an axis along or in a horizontal plane. The non-vertical axis can be substantially parallel to a top surface of the module plate 303. For example, the module plate 303 can comprise one or more rails 305, along which the projector assembly can move about. In some cases, a plurality of projector assembles, each comprising a projector, can be configured to move along the same non-vertical axis relative to the module plate 303.

The system provided herein can provide alignment of the build head, the platform, and the optical sources. The system provided herein can provide light at a desired shape, position, or angle.

### Transfer Unit

In an aspect, the present disclosure provides a system for printing a 3D object. The system can comprise a platform comprising an area for holding a mixture for printing at least a portion of the 3D object during the printing. The system can comprise a deposition unit in fluid communication with a source of the mixture, wherein the deposition unit is configured to deposit at least a portion of the mixture onto the area. The system can further comprise a building unit comprising an optical source configured to provide light to the mixture, wherein the light is sufficient to cause formation of the at least the portion of the 3D object. The system can further comprise a plurality of guiding elements operatively coupled to the platform and configured to direct movement of the platform between the deposition unit (e.g., at the deposition station wherein the deposition of mixture is performed) and the building unit (e.g., at the building station wherein the mixture is cured for the printing). A first guiding element of the plurality of guiding elements can be configured to move along a first path, and a second guiding element of the plurality of guiding elements can be configured to move along a second path that is not overlapping with the first path. In some embodiments, the first path and the second path can be disposed in a single plane that is substantially parallel to the area. In some embodiments, the first path and the second path can be disposed on different plates that are both substantially parallel to the area.

In some embodiments, the platform can comprise a film disposed on the surface of the platform. In some embodiments, the film can be configured to hold the mixture for printing. In some embodiments, a film transfer unit (FTU) can be configured to direct the movement of the film between the deposition unit and the building unit. The film transfer unit can comprise the plurality of guiding elements.

In some embodiments, the plurality of guiding elements can be configured to move towards a same direction. In some embodiments, the plurality of guiding elements can be configured to move towards different directions (e.g., an opposite direction). In some embodiments, at least two of the plurality of guiding elements can move towards a same direction. In some embodiments, at least two of the plurality of guiding elements can move towards different directions. In some embodiments, the different directions can be opposite directions. In some embodiments, the different directions can be in an angle from about 0° to about 180°. In some embodiments, the different directions can be perpendicular to one another.

In some embodiments, the plurality of guiding elements can be operatively coupled to a single actuator. In some embodiments, the plurality of guiding elements can be operatively coupled to a plurality of actuators. In some embodiments, a guiding element of the plurality of guiding elements can comprise a belt or a wheel. In some embodiments, the plurality of guiding elements can comprise two or more belts or wheels. In some embodiments, the two or more belts or wheels can be disposed opposite and parallel to each other. In some embodiments, a guiding element of the plurality of guiding elements can comprise a rail.

In some embodiments, the first path and the second path can be substantially parallel to each other. In some embodiments, the first path and the second path may be non-parallel to each other. In some embodiments, the first path and the second path may have an angle that is from 0° to 180°. In some embodiments, the first path and the second path may be perpendicular to each other. In some embodiments, the first guiding element and the second guiding element can be coupled to different locations of the platform. In some embodiments, the first guiding element and the second guiding element can be coupled to two opposite sides of the platform.

In some embodiments, the platform can comprise at least two platforms. In some embodiments, the at least two platforms can comprise a deposition platform and a building platform. In some embodiments, the plurality of guiding elements can be configured to direct movement of the at least two platforms between the deposition unit and the building unit. In some embodiments, the movement of the at least two platforms between the deposition unit and the building unit can be simultaneous. In some embodiments, the movement of the at least two platforms between the deposition unit and the building unit can be separated by a period of time, e.g., at least 1 min, at least 2 min, at least 3 min, at least 4 min, at least 5 min, or more. In some embodiments, movements of the at least two platforms can be at the same direction relative to one another. In some embodiments, movements of the at least two platforms can be at different directions, e.g., opposite relative to one another.

In some embodiments, the area can be transparent or semi-transparent. In some embodiments, the film can be transparent or semi-transparent. The optical source can be configured to provide the light through the area and towards the mixture. A transparent or semi-transparent area or film can allow for light to reach the mixture for the printing.

In some embodiments, the deposition unit can comprise a nozzle that is in fluid communication with the source. In some embodiments, the building unit can comprise a build head configured to support the at least the portion of the 3D object during the printing.

In some embodiments, the system can further comprise a controller operatively coupled to the plurality of guiding elements, wherein the controller is programmed to control the plurality of guiding elements to direct the movement of the platform between the deposition unit and the building unit.

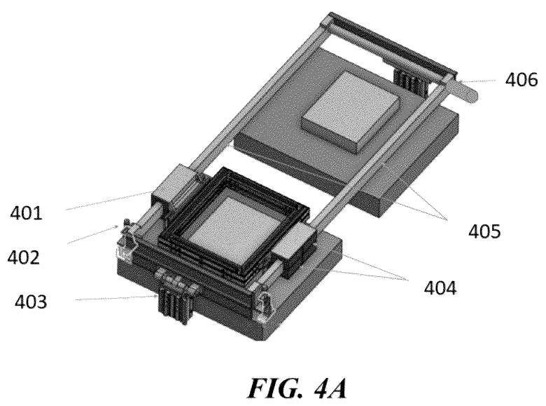

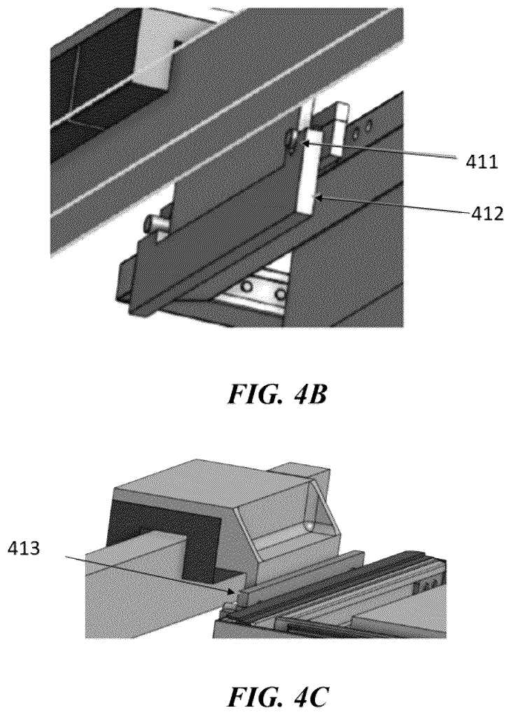

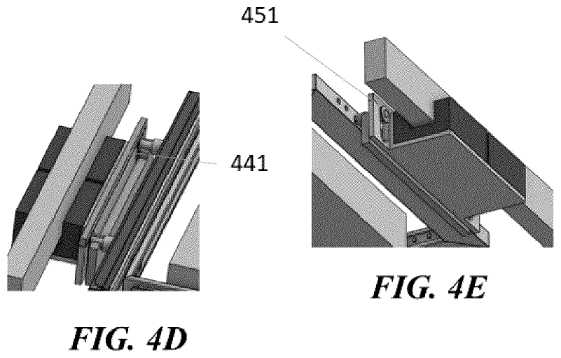

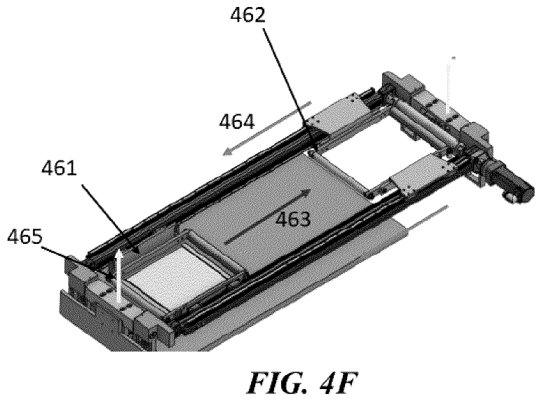

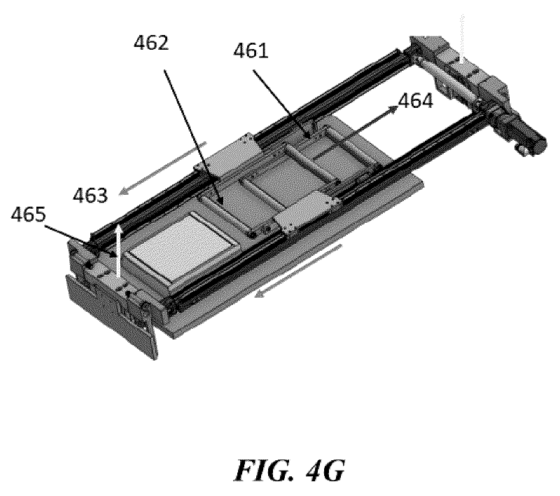

FIG. 4A shows an exemplary transfer unit to move a film (e.g., a film on a film frame) or a platform between the deposition unit and the building unit. The transfer unit can comprise an upper carrier 401, linear rails and belt drive 405, a plurality of carriages 404, a motor 406. The transfer unit can further comprise a pneumatic cylinder 403 at one end of the transfer unit and an additional pneumatic cylinder at the other end of the transfer unit. The pneumatic cylinder 403 can be coupled to a base through a clevis connection. The pneumatic cylinder 403 can allow for z-axis movement of the transfer unit. The transfer unit can further comprise a plurality of stops 402. During the transfer, the transfer unit can lift the platform up from a first unit and move it through the rails to a second unit.

FIGS. 4B-4E show additional features of a transfer unit. The transfer unit can comprise a plurality of pins 411 attached to a platform or a film frame. The transfer unit can comprise a plurality of hardstops 412 configured to set a position of the transfer unit. The transfer unit can comprise an operator 421 configured to set pins on carriage and close clamp. The transfer unit can further comprise a plurality of clamps 441 configured to secure pins against a hardstop. The transfer unit can further comprise a plurality of bushings 451 configured to engage pins in carriage on pick-up.

FIGS. 4F and 4G show an exemplary transfer unit comprising an upper carrier and lower carrier. The upper carrier can move a platform 462 (e.g., in a direction 464) and the lower carrier can move an additional platform 461 (e.g., in a direction 463). The movement of the platform 462 and the additional platform 461 can be in the same or different directions. The upper carrier and the lower carrier have a height difference that is big enough such that the platform 462 and the additional platform 461 do not touch each other when pass through a same location during the movement. FIG. 4G shows the platform 461 and platform 462 during movement. Horizontally, the platforms 461 and 462 are overlapping. However, due to the height difference between the upper carrier and the lower carrier, the two platforms do not touch each other. During the transfer, the transfer unit can lift the platform up (e.g., in the direction 465) from a first unit and move it through the rails to a second unit.

The transfer unit disclosed herein, e.g., reciprocating transfer unit design, can minimize the number of actuators and physical space required to achieve horizontal and vertical motion. Space efficiency (e.g., minimized physical space) can improve repeatability of positioning and processing while reducing cost of consumable clear film on carrier. The carriers can be constrained in vertical direction on both sides of the platforms during processing and during movement, enabling higher speed motion during transfer and more controlled, higher speed separation of printed parts from the carrier film upon completion of exposure step.

### Transfer Unit Assembly

In an aspect, the present disclosure provides a system for printing a 3D object. The system can comprise a platform comprising (i) an area for holding a mixture for printing at least a portion of the 3D object during the printing and (ii) a first coupling unit. The system can comprise a deposition unit in fluid communication with a source of the mixture, wherein the deposition unit is configured to deposit at least a portion of the mixture onto the area. The system can further comprise a building unit comprising an optical source configured to provide light to the mixture, wherein the light is sufficient to cause formation of the at least the portion of the 3D object during the printing. The system can further comprise a moving unit (or a transfer unit, used interchangeably herein) configured to direct movement of the platform between the deposition unit and the building unit, wherein the moving unit comprises a second coupling unit that is configured to couple to the first coupling unit, such that the platform is operatively coupled to the moving unit. A vertical dimension of the second coupling unit can be configured to permit a vertical movement between the first coupling unit and the moving unit relative to one another.

In some embodiments, the system can further comprise an additional platform comprising (i) an additional area for holding the mixture or an additional mixture and (ii) a third coupling unit; and an additional moving unit configured to direct movement of the additional platform between the deposition unit and the building unit. The additional moving unit can comprise a fourth coupling unit that is configured to couple to the third coupling unit, such that the additional platform is operatively coupled to the additional moving unit. A vertical dimension of the fourth coupling unit can be configured to permit a vertical movement between the third coupling unit and the additional moving unit relative to one another. The vertical dimension of the second coupling unit and the vertical dimension of the fourth coupling unit can be different.

In some embodiments, when the platform and the additional platform are moving in opposite directions between the deposition unit and the building unit, the area of the platform and the additional area of the additional platform can be disposed at different heights.

In some embodiments, when the platform and the additional platform are stationary at the deposition unit and the building unit, respectively, the area of the platform and the additional area of the additional platform can be disposed at substantially the same heights.

In some embodiments, the first coupling unit can comprise a protrusion relative to a surface of the first coupling unit. In some embodiments, the second coupling unit can comprise a recess relative to a surface of the second coupling unit. In some embodiments, the protrusion can comprise one or more pins. In some embodiments, the recess can comprise one or more slots.

In some embodiments, the movement of the platform or the additional platform can be substantially horizontal.

In some embodiments, the moving unit can be operatively coupled to an actuator configured to move the moving unit, thereby to direct the movement of the platform along a direction.

In some embodiments, the system can further comprise an additional actuator coupled to the actuator and configured to direct movement of the actuator along an additional direction.

In some embodiments, the direction can be substantially horizontal or substantially vertical. In some embodiments, the additional direction can be substantially horizontal or substantially vertical. In some embodiments, the direction and the additional direction can be parallel to each other. In some embodiments, the direction and the additional direction can have an angle that is from about 0° to 180°.

In some embodiments, the direction and the additional direction can be not parallel to each other. In some embodiments, the direction and the additional direction can have an angle that is from 0° to 180°. In some embodiments, the direction and the additional direction can be substantially orthogonal to each other.

In some embodiments, the additional actuator can be not directly coupled to the platform, such that operation of the additional actuator in absence of the actuator is not configured to move the platform along the direction. In some embodiments, the additional actuator can be coupled to the platform.

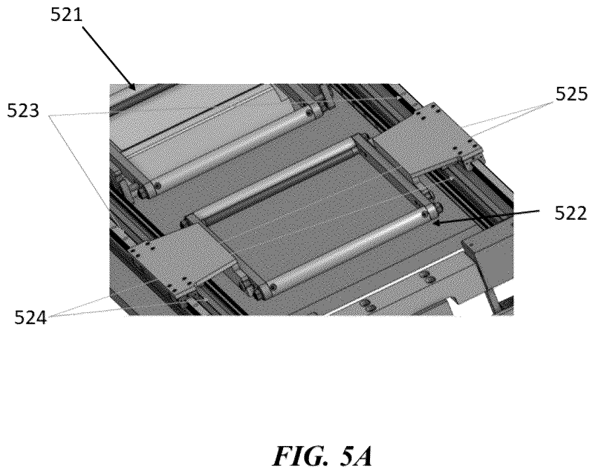

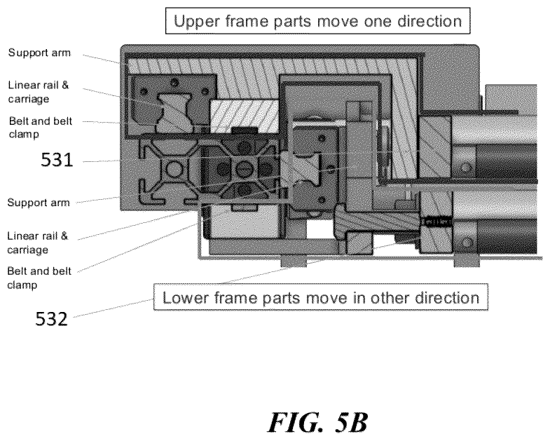

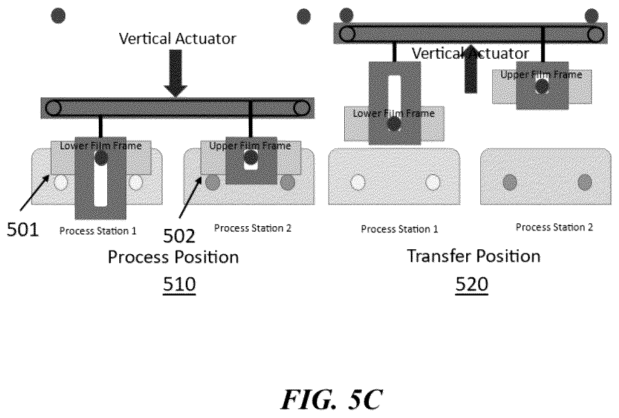

Referring to FIG. 5A, a transfer unit can comprise upper frame linear rails 523, upper frame drive belts 524 and upper frame support arms 525. The transfer unit is operatively coupled to a film frame 522 through the upper frame support arms 525. During the transfer, an actuator can couple the film frame 522 to the transfer unit. The transfer unit moves the film frame 522 through the upper frame linear rails 523 and upper frame drive belts 524 to transfer the film frame 522 from a location to another location. Referring to FIG. 5B, the transfer unit can further comprise lower frame rails and belts for the transfer of lower film frame 532. The upper frame parts can move in one direction while the lower frame parts move in another direction.

FIG. 5C shows exemplary movements of the transfer unit. At a process position 510, a vertical actuator pushes the transfer unit downwards to couple the transfer unit with an upper film frame 502 and a lower film frame 501. At a transfer position 520, the vertical actuator can lift the transfer unit up for the transfer of the upper film frame 502 and the lower film frame 501. The upper film frame 502 is lifted to a position that is taller than the low film frame 501.

In some embodiments, the system further comprising a controller operatively coupled to the moving unit, wherein the controller is programmed to control the moving unit to direct the movement of the platform between the deposition unit and the building unit.

The transfer unit assembly disclosed herein can minimally constrain the carriers such that process position of the carrier and thus tension on the carrier film can be determined solely by the position of the tolerance pins and the chucks. The slots can allow safe transfer spacing between the carriers and the chucks exclusively through gravity without need for additional active or passive mechanical devices. The carriers may be constrained at minimal number of contact points during horizontal motion to prevent binding during the horizontal motion and during vertical motion. The transfer unit assembly disclosed herein can simplify motion required to load and unload carrier from the system.

### Film Frame

In an aspect, the present disclosure provides a system for printing a 3D object. The system can comprise a platform configured to support a film holding a mixture for printing at least a portion of the 3D object during the printing. The platform can comprise a bar configured to hold the film at a side of the film. The platform can comprise an additional bar configured to hold the film at an additional side of the film. The bar can comprise a locking mechanism comprising (i) a locking state to couple at least a portion of the side of the film to the bar and (ii) an unlocking state to release the at least the portion of the side of the film from the bar. The system can further comprise an optical source configured to provide light to the mixture, wherein the light is sufficient to cause formation of at least a portion of the 3D object during the printing.

In some embodiments, the side and the additional side can be at different positions. In some embodiments, the side and the additional side can be opposite to each other. In some embodiments, the locking mechanism can be stationary. In some embodiments, the locking mechanism can be movable relative to the bar. In some embodiments, the locking mechanism can be a clamping bar.

In some embodiments, a length of the locking mechanism can be at least about 20%, at least about 30%, at least about 40%, at least about 50%, at least about 60%, at least about 70%, at least about 80%, at least about 90%, or more of a length of the bar.

In some embodiments, the additional bar can comprise an additional locking mechanism comprising (i) a locking state to couple at least a portion of the additional side of the film to the additional bar and (ii) an unlocking state to release the at least the portion of the additional side of the film from the additional bar.

In some embodiments, at least a portion of a surface of the bar can comprise a coupling mechanism to operatively couple to the clamping bar. In some embodiments, the coupling mechanism can comprise an indentation on at least the portion of the surface.

In some embodiments, the bar or the additional bar is not configured to move upon movement of the film relative to the bar or the additional bar.

In some embodiments, the bar or the additional bar can comprise a rolling mechanism configured to direct rotation of the bar or the additional bar about a central rolling axis.

In some embodiments, a surface of the bar or the additional bar can be coated with a friction-enhancing agent. The friction-enhancing agent can comprise a polymer, for example, a rubber.

In some embodiments, the film frame can comprise a plurality of wedges. The bar and the additional bar can be tightened by the plurality of wedges to apply tension to the film.

In some embodiments, the system can further comprise a controller operatively coupled to the optical source, wherein the controller is programmed to direct the optical source to provide the light to the mixture for the printing.

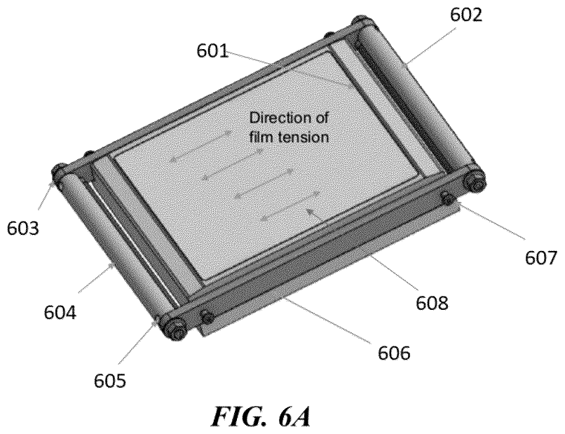

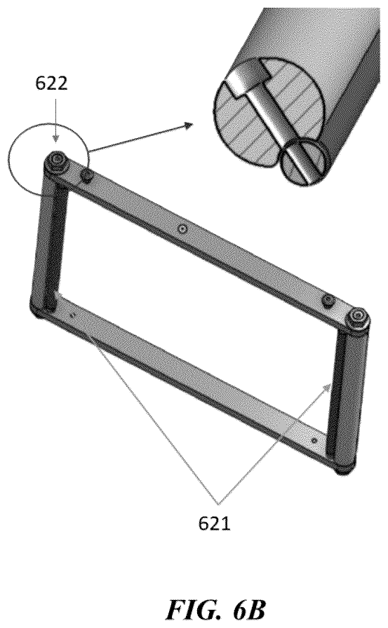

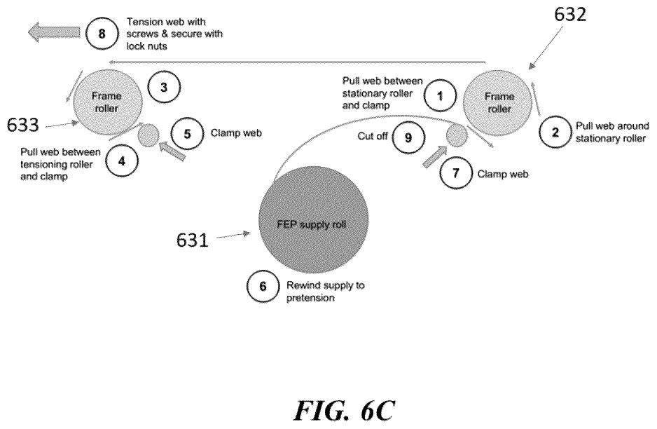

FIG. 6A shows an exemplary film frame. The film frame can comprise a bar 602 and a bar 604 disposed at the two ends of the film frame. The film frame can comprise a hard stop integral 606. The film frame can comprise a plurality of screws 603 to adjust tension on the film. The film frame can comprise a plurality of shoulder bolts 607 to engage with a transfer unit. The film frame can comprise a plurality of screws 605 to engage with a clamp. When a film is installed on the film frame, the bar 602 can act as a clamp. The bar 604 can act as a tensioning bar. The bar 602 can remain stationary while the bar 604 rotate around a rolling axis to apply tension on the film in the direction 608 as shown as the arrows. The screws 603 can be turned to tighten the bar 604 and adjust the tension. FIG. 6B shows an exemplary film frame, comprising clamping bars 621 which can be coated with rubber. The film frame further comprises screws 622 to adjust the tension.

Referring to FIG. 6C, a film, e.g., a FEP film can be supplied to the film frame by pulling the end of the film from an FEP supply roll 631 over a bar 632, between the bar 632 and an additional bar 633, over the additional bar 633, and securing it by clamping it to the bar 632 and the additional bar 633 on both ends of the film. A cutting unit can subsequently cut off the film at a position between the clamping site adjacent to the bar 632 and the FEP supply roll 631.

The film frame disclosed herein can reduce overall space or footprint needed by the transfer system relative to the process stations. It incorporates key interface pins required for operation of transfer assembly. Reduced footprint can achieve faster horizontal and vertical motions with higher positional repeatability. Reduced footprint and single-directional tensioning can minimize amount of consumable carrier film required to operate the system and overall complexity of the mechanical assembly.

### Sealing Interface

In an aspect, the present disclosure provides a system for printing a 3D object. The system can comprise a platform comprising a top surface configured to hold a mixture for printing at least a portion of the 3D object. A portion of the top surface can be not parallel to an additional portion of the top surface that holds the mixture. The portion of the top surface can be substantially rigid. The system can comprise an optical source configured to provide light to the mixture, wherein the light is sufficient to cause formation of the at least the portion of the 3D object during the printing. The light can further be usable for determining a characteristic of the mixture prior to the printing.

In some embodiments, the portion of the top surface is characterized by exhibiting a Young's modulus of at least about 0.1 gigapascals (GPa), at least about 0.5 GPa, at least about 1 GPa, at least about 5 GPa, at least about 10 GPa, at least about 20 GPa, at least about 30 GPa, at least about 40 GPa, at least about 50 GPa, at least about 60 GPa, at least about 70 GPa, at least about 80 GPa, at least about 90 GPa, at least about 100 GPa, or more.

In some embodiments, the portion of the top surface can comprise a reinforced composite material, a plastic material, a wood, a metal, or a metal alloy.

In some embodiments, the portion of the top surface can have an area that is at least about 5%, at least about 10%, at least about 20%, at least about 30%, at least about 40%, at least about 50%, or more of the area of the additional portion of the top surface.

In some embodiments, an angle between an external normal of the portion and an external normal of the additional portion of the top surface is an acute angle. The acute angle can be less than about 70 degrees, less than about 60 degrees, less than about 50 degrees, less than about 40 degrees, less than about 30 degrees, or less.

In some embodiments, the system can further comprise a collection unit (or a drop tray) configured to couple to the platform via the portion of the top surface of the platform, to collect any excess mixture from the platform during or subsequent to the printing.

In some embodiments, the collection unit can be configured to cover the portion of the top surface upon coupling between the collection unit and the platform. In some embodiments, the collection unit can cover at least about 50%, at least about 60%, at least about 70%, at least about 80%, at least about 90%, at least about 95%, or more of the portion of the top surface. In some embodiments, the collection unit can cover substantially the whole area of the portion of the top surface.

In some embodiments, upon coupling of the collection unit and the platform, a top surface of the collection unit can be substantially parallel to the top surface of the platform.

In some embodiments, upon coupling of the collection unit and the platform, a top surface of the collection unit and the top surface of the platform can form a substantially flat area.

In some embodiments, the system can further comprise an actuator configured to direct movement of the collection unit relative to the platform.

In some embodiments, the portion of the top surface of the platform can comprise a sealing mechanism to prevent flow of at least a portion of the mixture across the sealing mechanism.

In some embodiments, the sealing mechanism can be disposed across a cross-sectional dimension of the portion of the top surface.

In some embodiments, the sealing mechanism can protrude out of the portion of the top surface.

In some embodiments, the sealing mechanism can comprise a polymer strip. The polymer strip can comprise a rubber or an elastomer. In some embodiments, the sealing mechanism can comprise a foam. In some embodiments, the sealing mechanism can comprise a caulk like material. In some embodiments, the sealing mechanism can comprise a composite material.

In some embodiments, the additional portion of the top surface is transparent or semi-transparent such that a light can pass through.

In some embodiments, the additional portion of the top surface can be porous. In some embodiments, the additional portion of the top surface can be microporous. In some embodiments, the portion of the top surface can be porous. In some embodiments, the portion of the top surface can be not porous.

In some embodiments, the portion of the top surface can be a frame that is holding the additional portion of the top surface. In some embodiments, the portion and the additional portion of the top surface can comprise different materials. In some embodiments, the portion and the additional portion of the top surface can comprise same materials. In some embodiments, the portion and the additional portion of the top surface can both be porous. In some embodiments, the portion and the additional portion of the top surface can have same porosity. In some embodiments, the portion and the additional portion of the top surface can have different porosity. In some embodiments, at least one of the portion and the additional portion of the top surface can be porous. In some embodiments, at least one of the portion and the additional portion of the top surface can be non porous. In some embodiments, the portion and the additional portion of the top surface can have same density. In some embodiments, the portion and the additional portion of the top surface can have different density.

In some embodiments, the system can further comprise a film for carrying the mixture, wherein the film is disposed between the mixture and the additional portion of the top surface of the platform. The film can comprise a FEP film.

In some embodiments, the film can comprise a back surface adjacent to the top surface of the platform, and wherein the platform comprises one or more channels in fluid communication with the back surface. The system can further comprise a vacuum unit operatively coupled to the one or more channels, wherein the vacuum unit is configured to provide a vacuum between the platform and the back surface. The system can further comprise a controller operatively coupled to the vacuum unit. The controller can be configured to direct the vacuum unit to provide the vacuum between the platform and the back surface.

In some embodiments, the one or more channels can be in fluid communication with a side surface of the platform. In some embodiments, the one or more channels can be in fluid communication with a bottom surface of the platform.

The light can be configured to determine the characteristic of the mixture prior to the printing. The characteristic of the mixture comprises a profile of the mixture or a quality of the mixture. The system can further comprise a sensor. The sensor can be configured to detect a quality or property of the film or the mixture. For examples, a sensor, e.g., a camera, takes an image of the mixture on the film. A back light can be activated to provide illumination for the camera image. The sensor (or a different sensor) can inspect the mixture for presence of any defect.

In some embodiments, the portion of the top surface of the platform can be flat. In some embodiments, the portion of the top surface of the platform can be not flat. In some embodiments, the portion of the top surface of the platform can be curved.

In some embodiments, the additional portion of the top surface of the platform can be substantially flat. In some embodiments, the platform is not a rollable film.

In some embodiments, the system can further comprise a controller operatively coupled to the optical source, wherein the controller is programmed to direct the optical source to provide the light to the mixture for the printing.

In some embodiments, the system can further comprise a backlight operatively coupled to the deposition station and configured to provide a light towards the mixture. In some embodiments, the backlight can be configured to measure a profile of the mixture deposited on the area to quality control the mixture. In some embodiments, the profile can comprise thickness, variation of the thickness, particle distribution, uniformity of the thickness, uniformity of the particle distribution, presence of voids, etc. In some embodiments, the profile can indicate a quality of the deposited mixture.

The sealing interface disclosed herein can enable movement of feedstock or mixture onto and off of the drip tray without material loss to the underside of the drip tray. In some cases, material loss may result in widespread contamination of the drip tray, the chuck and/or the carrier film. Such contamination can end up on either of the process stations (e.g., deposition station or build station), causing either coating or exposure defects. Pushing feedstock material onto the drip tray can reduce the amount of feedstock material held on the carrier film to the bare minimum required to complete the printing step. Excess feedstock can be stored on the drip tray and can be shared between two carrier films. In some embodiments, the sealing interface can be angled. In some embodiments, the seal can be made exclusively via the vertical motion of the drip tray onto the chuck. In some embodiments, the drip tray surface can remain below the surface of the chuck so the coater blade can push material on and off of the drip tray without collision. In some embodiments, the carrier film may not be creased or damaged.

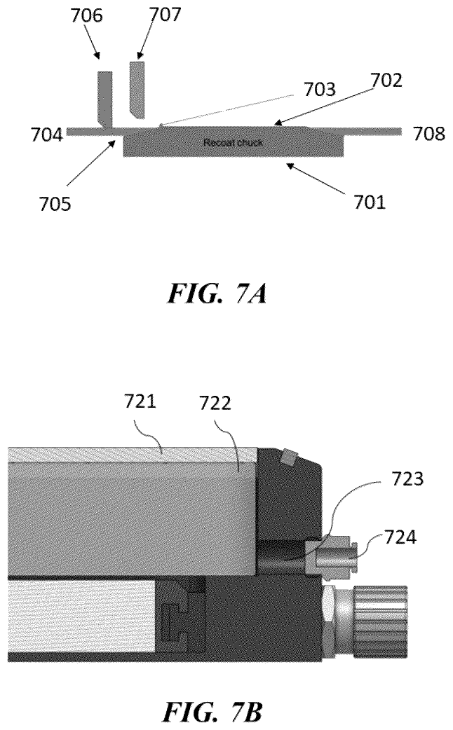

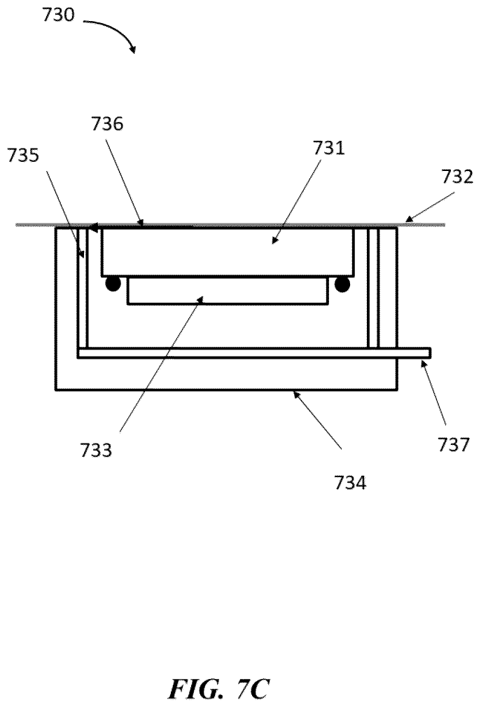

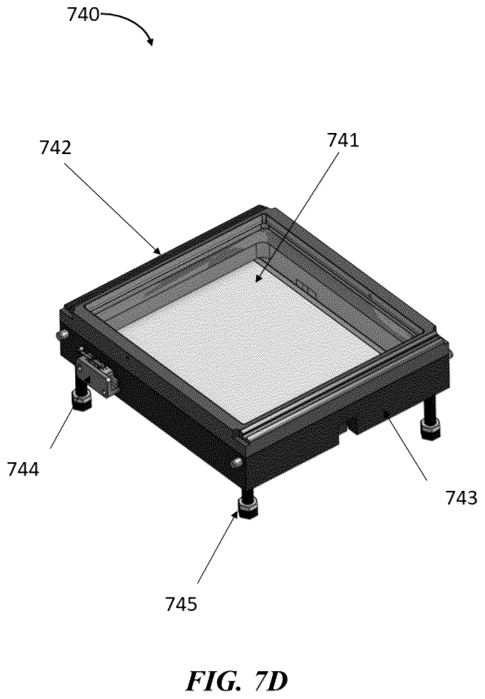

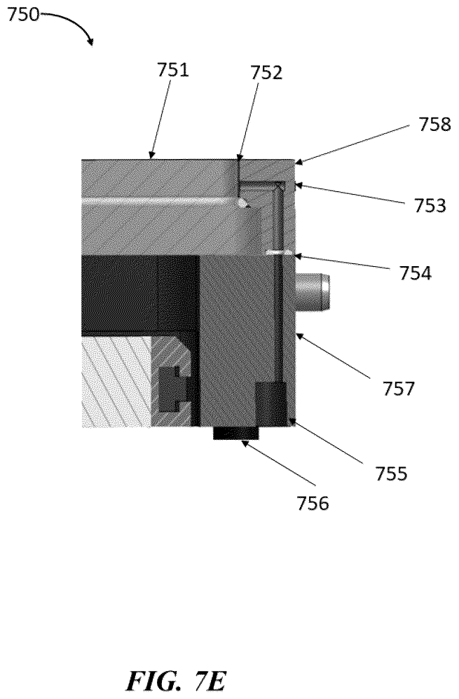

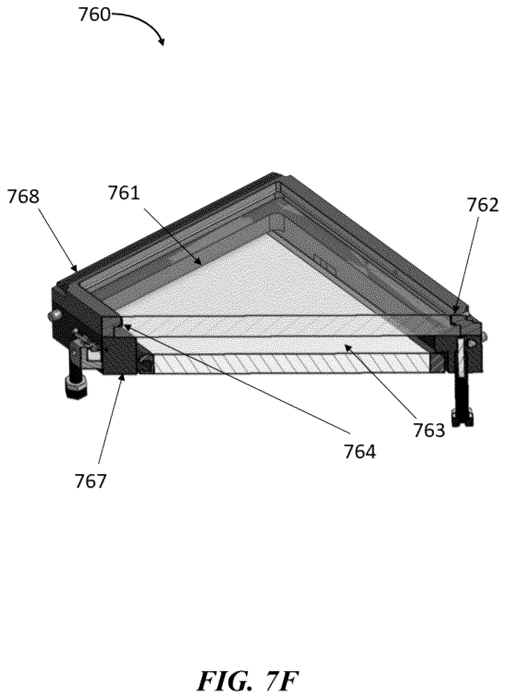

FIG. 7A shows an exemplary platform and collection units. The platform 701 comprises a top surface, comprising a surface 705 and a surface 702. The surface 702 and surface 705 are not parallel. The surface 702 is configured to hold a mixture or a film. Collection units 704 and 708 can be coupled to the platform through the surface 705. The collection unit 704 and 708 can have same size or shape. The collection unit 704 and 708 can have different size or shape. After coupling, a surface of the collection unit 704 and the surface 702 can form a flat area. After coupling, an interface 703 is created in between the collection unit 704 and surface 705. The collection unit 704 and the surface 705 can be sealed at the interface 703 to prevent a portion of the mixture enters into the interface. A system can further comprise a wiper 706 and an additional wiper 707. During printing, the wiper 706 and the additional wiper 707 can spread the mixture on the top surface of a platform (i.e., an exposure window or a film). In some embodiments, the wiper 706 and the additional wiper 707 can wipe a portion of the mixture from the top surface of the platform to the collection unit 704, thereby to collect the portion of the mixture. The portion of the mixture collected, i.e., excess resin or waste resin, can be mixed with another mixture, for subsequent printing.

FIG. 7B shows an exemplary platform. The platform comprises a vacuum surface 721 comprising a plurality of pores, a support glass 722, an air flow pocket 723 on a side of the support glass 722, and a vacuum port 724 on a side of vacuum chuck frame. A vacuum can be provided through the vacuum port and the air flow pocket to seal the vacuum surface 721 and a film disposed on top of the platform.

In some embodiments, the present disclosure provides a system for printing a 3D object. The system can comprise a platform comprising a top surface and a plurality of side surfaces, wherein the top surface of the platform can be configured to hold a film for carrying a mixture for printing at least a portion of the 3D object. The system can comprise a perimeter wall disposed adjacent to and surrounding the plurality of side surfaces of the platform, wherein at least a portion of the perimeter wall is not in direct contact with at least a portion of a side surface of the plurality of side surfaces, such that the at least the portion of the perimeter wall and the at least the portion of the side surface are separated by a gap. The system can further comprise a vacuum unit in fluid communication with the gap, wherein the vacuum unit can be configured to provide suction through the gap. The system can further comprise a controller operatively coupled to the vacuum unit, wherein the controller can be configured to direct the vacuum unit to provide the suction through the gap to a bottom surface of the film, when the film is disposed adjacent to the top surface of the platform.

In some embodiments, the platform can be porous. In some embodiments, the platform may not be porous. In some embodiments, at least a portion of the top surface of the platform can be textured or comprise a pattern. The texture of pattern can provide roughness to the top surface of the platform. In some embodiments, when a film is disposed adjacent to the top surface of the platform that is textured or patterned, the textured surface can generate one or more continuous networks of pores or cavities for air to pass through (or for vacuum to pull suction through). In some embodiments, at least about 10%, at least about 20%, at least about 30%, at least about 40%, at least about 50%, at least about 60%, at least about 70%, at least about 80%, at least about 90%, at least about 95%, or more, of the top surface of the platform can be textured or comprise a pattern. In some embodiments, the texture or the pattern can comprise a plurality of humps or dimples. In some embodiments, the texture or the pattern can comprise a height difference between the highest vertical point and the lowest vertical point of the texture or pattern that is from about 10 micrometers (μm) to about 20 μm, from about 10 μm to about 50 μm, from about 10 μm to about 100 μm, from about 10 μm to about 150 μm, from about 20 μm to about 50 μm, from about 20 μm to about 100 μm, from about 20 μm to about 150 μm, from about 50 μm to about 100 μm, from about 50 μm to about 150 μm, or from about 100 μm to about 150 μm. In some embodiments, the cross-sectional dimension of the texture or pattern can be from about 10 μm to about 20 μm, from about 10 μm to about 50 μm, from about 10 μm to about 100 μm, from about 10 μm to about 150 μm, from about 20 μm to about 50 μm, from about 20 μm to about 100 μm, from about 20 μm to about 150 μm, from about 50 μm to about 100 μm, from about 50 μm to about 150 μm, or from about 100 μm to about 150 μm.

In some embodiments, the platform can be transparent or semi-transparent. In some embodiments, the platform can comprise a glass. In some embodiments, the glass can comprise textured surface that is generated by abrasive blasting a surface of a glass. In some embodiments, the glass can comprise textures on the surface from about from 120 grits (average dimension of about 102 micrometers) to about 320 grits (average dimension of about 31-36 micrometers). In some embodiments, the glass can comprise textures on the surface of about 220 grits (average dimension of about 63 micrometers).

In some embodiments, the top surface of the platform and a top surface of the perimeter wall can be substantially at the same vertical level, such that the film remains substantially flat when disposed on top of the top surface of the platform and the top surface of the perimeter wall. In some embodiments, the at least the portion of the perimeter wall and the plurality of side surfaces can be separated by the gap (or vacuum plenum), wherein the gap is a continuous gap adjacent to the plurality of side surfaces.

In some embodiments, the gap can surround at least a portion of the perimeter of the platform. In some embodiments, the gap can surround the entire perimeter of the platform.

In some embodiments, the perimeter wall can surround the entire perimeter of the platform. In some embodiments, the perimeter wall can comprise at least one fluid channel within the perimeter wall, wherein the at least one channel provides the fluid communication between the vacuum unit and the gap. In some embodiments, a size of the gap can be from about 0.1 millimeters (mm) to about 0.5 mm, from about 0.1 mm to about 1 mm, from about 0.1 mm to about 5 mm, from about 0.1 mm to about 10 mm, from about 0.5 mm to about 1 mm, from about 0.5 mm to about 5 mm, from about 0.5 mm to about 10 mm, from about 1 mm to about 5 mm, from about 1 mm to about 10 mm, or from about 5 mm to about 10 mm.

In some embodiments, an additional portion of the perimeter wall can be coupled to an additional portion of the plurality of side surfaces via an O-ring. In some embodiments, the system can further comprise an optical source configured to provide light towards the top surface, wherein the optical source is disposed at or adjacent to a bottom surface of the platform.

When a film is placed on top of the platform and a vacuum is applied to the gap, air can be evacuated through the cavities between the bottom surface (or back surface) of the film and the textured surface of the platform to create a seal between the bottom surface of the film and the textured surface. In some embodiments, a vacuum level between the bottom surface of the film and the textured surface can be from about −100 kilopascals (kPa) to about −90 kPa, from about −100 kPa to about −80 kPa, from about −100 kPa to about −70 kPa, from about −100 kPa to about −60 kPa, from about −100 kPa to about −50 kPa, from about −100 kPa to about −40 kPa, from about −100 kPa to about −30 kPa, from about −90 kPa to about −80 kPa, from about −90 kPa to about −70 kPa, from about −90 kPa to about −60 kPa, from about −90 kPa to about −50 kPa, from about −90 kPa to about −40 kPa, from about −90 kPa to about −30 kPa, from about −80 kPa to about −70 kPa, from about −80 kPa to about −60 kPa, from about −80 kPa to about −50 kPa, from about −80 kPa to about −40 kPa, from about −80 kPa to about −30 kPa, from about −70 kPa to about −60 kPa, from about −70 kPa to about −50 kPa, from about −70 kPa to about −40 kPa, from about −70 kPa to about −30 kPa, from about −60 kPa to about −50 kPa, from about −60 kPa to about −40 kPa, from about −60 kPa to about −30 kPa, from about −50 kPa to about −40 kPa, from about −50 kPa to about −30 kPa, or from about −40 kPa to about −30 kPa.

In some embodiments, to release the film from the platform, the vacuum can be turned off and air can re-enter the cavities between the textured surface and back surface of the film to break the seal thereby to release the film.

This design or setup can eliminate deflection of the platform (e.g., a chuck window) due to pressure difference from vacuum. It can also eliminate the need for vacuum holes or porous materials in the chuck window to pull vacuum through the chuck window. In addition, the gap has a small volume and evacuation can occur quickly.

In some embodiments, the system can further comprise at least one sensor configured to detect the coupling or sealing of the film and the platform. The system may comprise at least 1, at least 2, at least 3, at least 4, at least 5, at least 6, at least 7, at least 8, at least 9, at least 10, or more sensors configured to detect the coupling or sealing of the film and the platform.

In some embodiments, the system may further comprise a controller configured to direct the at least one sensor to detect the coupling or sealing of the film and the platform. The controller may be further configured to direct the build head and/or the platform to undergo motion (relative motion) towards one another along an axis until the at least one sensor detects coupling or sealing of the film and the platform.

The at least one sensor configured to detect the coupling or sealing of the film and the platform may comprise at least one camera (e.g., at least 1, at least 2, at least 3, at least 4, at least 5, or more cameras). The at least one sensor may comprise at least one pressure sensor (e.g., at least 1, at least 2, at least 3, at least 4, at least 5, or more pressure sensors) configured to detect a pressure or vacuum level between the film and the platform.

FIG. 7C shows an example configuration for film sealing. The platform 730 comprises a frame 734 and a chuck window 731. The chuck window 731 (or the platform) is configured to hold the film and/or the mixture. The chuck window 731 comprises a textured surface. The platform comprises a plurality of vacuum plenums 735 in communication with a vacuum port 737. When a film 732 is placed on top of the chuck window and a vacuum is applied through the vacuum port 737, air can be evacuated through the cavities between the bottom surface of the film 732 and the textured surface. The arrow 736 shows an exemplary passage for the air to evacuate to the vacuum ducts 735. Under vacuum, a seal can be created between the film and the textured surface to hold the film 732 in place.

In some embodiments, the seal between the film and the textured surface can secure the film during deposition of the mixture, during the wiping, and/or during the printing.

In some embodiments, the textured surface can eliminate or minimize dimpling of the film owing to the fine and small dimensions of the textures that do not cause macroscopic damage to the film.

In some embodiments, a backlight (e.g., 733 of FIG. 7C) can be placed right below the chuck window to provide light to the chuck window, the film, and the mixture to obtain an unobstructed image.

FIG. 7D shows a perspective view of an example platform. The platform 740 comprises an upper frame 742 configured to hold the chuck window 741 in place. The platform 740 comprises a lower frame 743 to support the upper frame 742 and the chuck window 741. The chuck window 741 comprises textured glass surface. The platform 740 can comprise a retainer for switch(es) 744 which allows for adjusting the trigger position of the switch(es) and also protects the switch(es) from damage. The platform 740 can further comprise a plurality of actuators (e.g., 745) to adjust and/or level the platform and the chuck window. In some cases, the plurality of actuators can comprise differential thread pitch levelers or shim leveling.

FIG. 7E shows a cross sectional view of an example platform. The platform 750 comprises a chuck window 751 comprising textured surface. The platform comprises an upper frame 758 and a bottom frame 757 configured to hold the chuck window in place. At the interface of the chuck window and the upper frame 758, the platform comprises a plurality of vacuum ducts or plenums 752 configured to evacuate air from between a film and the textured surface. The platform can further comprise a plurality of plug welds 753, a plurality of O-ring seals 754, and mechanisms for fitting 755 (e.g., ⅛-NPT for fitting), and a plurality of actuators 756 for adjusting and/or leveling the platform and the chuck window.

FIG. 7F shows a cross sectional view of an example platform. The platform 760 comprises a chuck window 761 comprising textured surface. The platform comprises an upper frame 768 and a bottom frame 767 configured to hold the chuck window in place. At the interface of the chuck window 761 and the upper frame 768, the platform comprises a plurality of vacuum plenums 762 configured to evacuate air from between a film and the textured surface. The platform can further comprise a plurality of O-ring seals 764. The platform can further comprise a backlight 763 that can be coupled or connected to the base plate or the bottom frame.

### Dampener

In an aspect, the present disclosure provides a system for printing a 3D object. The system can comprise a platform comprising an area configured to hold a mixture for printing at least a portion of the 3D object. The system can comprise a deposition unit comprising a wiper configured to (i) remove at least a portion of an excess of the mixture from the area or (ii) spread the mixture over the area. The deposition unit can further comprise an actuator configured to control a vertical movement of the wiper towards or away from the area. The deposition unit can further comprise a dampener disposed between the actuator and the wiper, to reduce at least a portion of a force exerted by the actuator and towards the wiper when the actuator directs the vertical movement of the wiper towards or away from the area. The system can further comprise an optical source configured to provide light to the mixture, wherein the light is sufficient to cause formation of the at least the portion of the 3D object during the printing.

In some embodiments, the dampener can permit a relative movement between the actuator and the wiper. The deposition unit can further comprise a joint mechanism coupled to the wiper, wherein the joint mechanism is configured to permit movement of the wiper relative to the actuator or the dampener along at least one degree of freedom (DOF), wherein the at least one DOF is different from a direction of the vertical movement. In some embodiments, the at least one DOF can be a roll axis. In some embodiments, the at least one DOF can be a pitch axis. In some embodiments, the joint mechanism can comprise a double clevis joint. In some embodiments, the joint mechanism can comprise a swivel joint bushing.

In some embodiments, the system can further comprise a controller operatively coupled to the deposition unit. The controller can be programmed to (a) direct the actuator to control the vertical movement of the wiper, and (b) direct the optical source to provide the light to the mixture, for the printing.

In some embodiments, the dampener can comprise a spring. In some embodiments, the spring can comprise a metal, a metal alloy, or a rubber material. In some embodiments, the dampener can comprise a polymer, for example, a rubber or an elastic material.

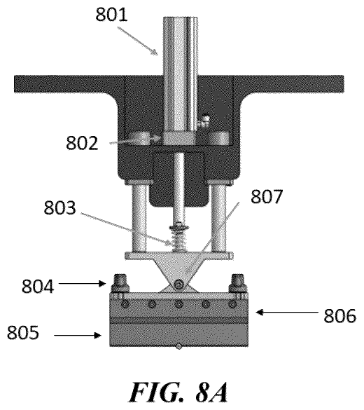

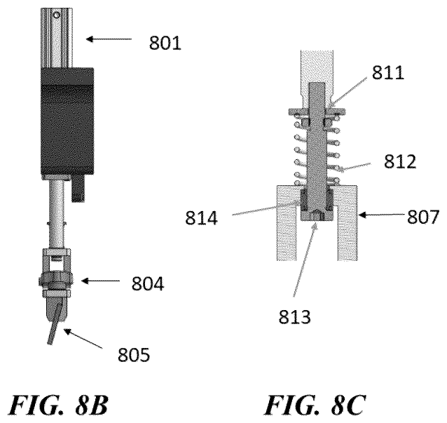

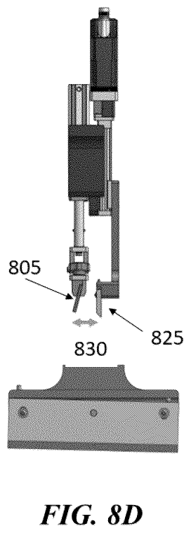

FIG. 8A shows an example wiper assembly comprising a wiper 805, an actuator 801, and a dampener, i.e., a spring 803. The actuator 801, e.g., a pneumatic actuator, can be configured to control a vertical movement of the wiper assembly. The spring 803 can be disposed between the actuator 801 and the wiper to control a wipe force. The wiper 805 can be connected to a clamp 806 through a plurality of locking knobs 804. The plurality of locking knobs 804 can be torque limited and can make audible click sound when locked. The clamp 806 can be coupled to the spring 803 via a double clevis joint 807, allowing for rotation and conforming of the wiper to a mixture, a film, or an area of a platform. The wiper assembly can further comprise a force spacer block 802 to set the spring compression and regulate the wiper force.

FIG. 8B shows a side view of the example wiper assembly as provided in FIG. 8A. The wiper 805 can deflect when it contacts or touches a surface of a platform, or a surface of a mixture, or a surface of a film disposed on the platform.

FIG. 8C shows an enlarged side view of the exemplary spring and connections. The spring 812 can be coupled to the actuator 801 through locknut, lock washer, and oversized washer 811. The spring 812 can be coupled to the double clevis joint 807 through a swivel joint bushing 814 and a shoulder bolt 813.

Referring to FIG. 8D, the deposition unit can comprise a wiper 805 an additional wiper 825. The wiper 805 and the additional wiper 825 can be configured to spread the mixture over the area, to generate a film of the mixture that is usable for the printing. In some embodiments, the wiper 805 and the additional wiper 825 can be configured to move relative to each other. In some embodiments, the wiper 805 and the additional wiper 825 can be separated by a distance 830. In some embodiments, the distance 830 can be at least 30 mm, at least 35 mm, at least 40 mm, at least 45 mm, at least 50 mm, at least 55 mm, at least 60 mm, at least 65 mm, at least 70 mm, at least 75 mm, at least 80 mm, at least 85 mm, at least 90 mm, at least 95 mm, at least 100 mm, or more. In some embodiments, the distance 830 can be at most 100 mm, at most 95 mm, at most 90 mm, at most 85 mm, at most 80 mm, at most 75 mm, at most 70 mm, at most 65 mm, at most 60 mm, at most 55 mm, at most 50 mm, at most 45 mm, at most 40 mm, at most 35 mm, at most 30 mm, or less.

The system provided herein can enhance the uniformity of a thickness of a mixture disposed on a platform. The system provided herein can enhance the efficiency in collecting an excess of a mixture for use in a subsequent printing. The system provided herein can further regulate a vertical movement of a wiper such that during a vertical movement, a wiper will not dash to a surface of the platform or a mixture on the platform.

### Distributed Dispense Manifold

A mixture for forming 3D object can comprise a polymeric precursor and a plurality of particles. During a printing, if the mixture is dispensed at a single point on a platform, it may cause non-uniformity in distribution of the plurality of particles in a printed layer of the printed 3D object. To increase the uniformity in distribution of the plurality of particles, a new system with a deposition unit comprising a distributed dispense manifold design is needed.

In an aspect, the present disclosure provides a system for printing a 3D object. The system can comprise a platform comprising an area for holding a mixture for printing at least a portion of the 3D object. The system can comprise a deposition unit comprising a plurality of nozzles in fluid communication with a common source of the mixture, wherein each of the plurality of nozzles is configured to deposit at least a portion of the mixture onto the area. The plurality of nozzles can comprise a nozzle and an additional nozzle, wherein a cross-sectional dimension of the nozzle and an additional cross-sectional dimension of the additional nozzle can be same or different. The plurality of nozzles can comprise at least 2, at least 3, at least 4, at least 5, at least 6, at least 7, at least 8, at least 9, at least 10, or more nozzles. The plurality of nozzles can be configured in one row. The plurality of nozzles can be configured in an array. In different rows of the array, the number of the nozzles in a row can be different than in a second row. The system can further comprise an optical source configured to provide light to the mixture, wherein the light is sufficient to cause formation of the at least the portion of the 3D object during the printing.

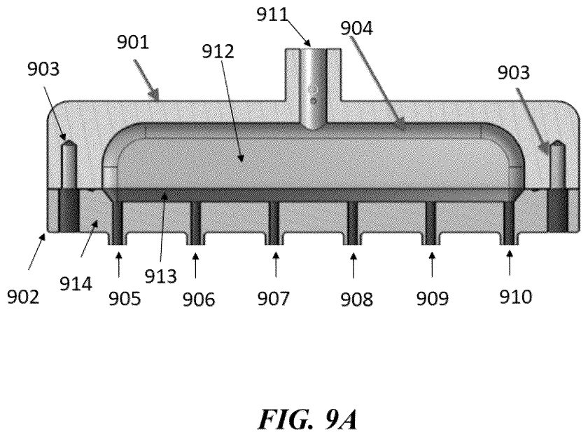

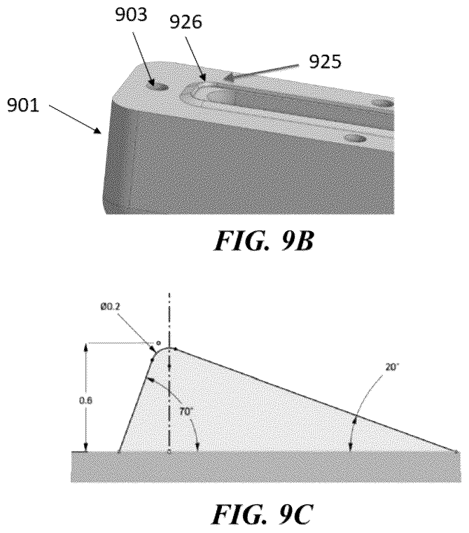

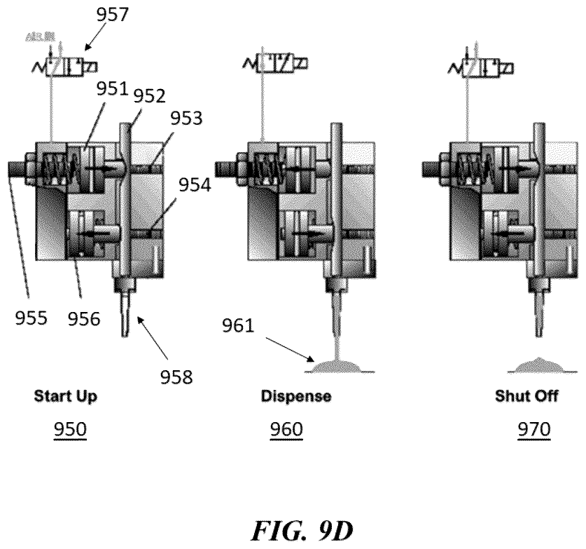

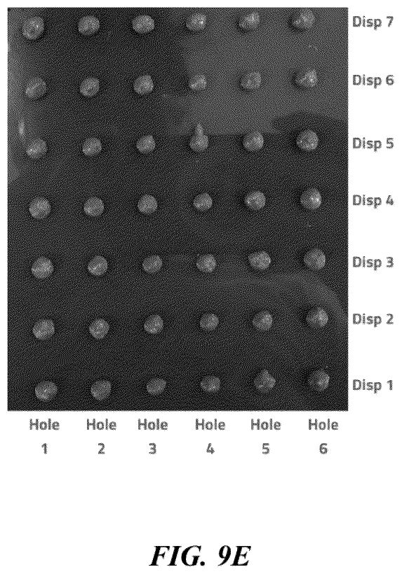

FIG. 9A shows an example deposition unit comprising a distributed dispense manifold. The deposition unit comprises housing 901 and housing 902 that are coupled to each other to provide a flow path from the mixture source to a plurality of nozzles. A housing 901 can comprise a fluid channel 911 connecting to a mixture source. Alternatively, the housing 901 can comprise the mixture source. The housing 901 can comprise plenum and sealing feature to ensure sealing between the housing 901 and housing 902 of the deposition unit. The housing 901 can comprise plenum 904 to equalize flow across a plurality of nozzles. The housing 901 can further comprise a compartment 912 for distribution of a mixture. The housing 901 can further comprise a plurality of fastener holes 903 to couple the housing 901 and housing 902. The material for housing 901 can comprise stainless steel. The housing 902 (or the distributed dispense manifold, as used interchangeably herein) can comprise a compartment 914, a surface 913 that can form an interface between the housing 901 and housing 902, and a plurality of nozzles (905, 906, 907, 908, 909, and 910). The mixture for 3D printing can flow through the channel 911 from the mixture source to the compartment 912 and then distributed to the plurality of nozzles, for the dispense. The plurality of nozzles (905, 906, 907, 908, 909, and 910) are disposed adjacent to a bottom surface of the deposition unit. Nozzles 907 and 908 are closer to a center of the bottom surface as compared to the additional nozzles 906 and 909. Additional nozzles 905 and 910 can be farther to a center of the bottom surface as compared to the additional nozzles 906 and 909. The cross-sectional dimension of the nozzles 907 and 908 can be less than the cross-sectional dimension of the additional nozzles 906 and 909. The cross-sectional dimension of the nozzles 905 and 910 can be larger than the cross-sectional dimension of the nozzles 906 and 909. The material for housing 902 can comprise 3D printed ABS. The nozzles sizes can be customized.

FIG. 9B illustrates the sealing feature of the housing 901. The housing 901 comprises a knife-edge sealing feature 925. The knife-edge sealing feature 925 can comprise a protrusion 926 on the surface. The protrusion 926 can comprise metal. The housing 902 can act as a compliant material where the protrusion 926 can make a contact with the housing 902 to create a seal between the housing 901 and the housing 902. In some embodiments, the sealing feature can comprise a ConFlat fitting that uses one or more metal seals to achieve a vacuum condition. In some embodiments, the sealing feature disclosed herein can eliminate an O-ring (e.g., a rubber O-ring). In some embodiments, the sealing provided by the sealing feature can be sufficient in absence of a rubber O-ring.

FIG. 9C illustrates a cross-sectional view of the protrusion 926 as provided in FIG. 9B. The shape of the protrusion 926 can be arch, semi-circle or triangle.

In some embodiments, the deposition unit is configured to control flow of the mixture from the common source, through a nozzle of the plurality of nozzles, and towards the area. In some embodiments, the deposition unit comprises one or more valves to control the flow. In some embodiments, the system does not need any external force to direct flow of the mixture from the common source and towards the area of the platform. In some embodiments, the deposition unit can comprise an additional housing for containing the one or more valves.

FIG. 9D shows example valve operations for controlling the dispense. The valve comprises a pinching valve mechanism. At configuration 950, i.e., startup configuration, a spring-closed upper piston 951 collapses a channel 952 of a nozzle 958, preventing a flow. A pinch stop adjusting screw 953 limits an amount of pinch regulating a stress on the channel 952. A blunt lower piston 956 is held in its open position by a spring. At configuration 960, i.e., dispense configuration, an air unit 957 moves the upper piston 951 back to an adjustable stop 955, which controls an amount the channel 952 opens and regulates a rate of flow through the channel 952. Simultaneous with the action of the upper piston 951, the blunt lower piston 956 moves forward until it stops against the adjusting screw 954, partially occluding the channel 952. A mixture 961 is dispensed through the nozzle 958 to an area of the platform. The rate of flow, nozzle size, fluid pressure, and time the valve is open determines an amount of the mixture dispensed. At configuration 970, i.e., shut off configuration, the upper piston 951 moves forward to pinch the channel 952 to stop the flow. The blunt lower piston 956 is released and the spring returns to its original position. The lower portion of the channel 952 returns to its normal, i.e., shape. Suck-back is created from the change in the channel shape. The valve is now ready to repeat the cycle. Fine adjustment can be made to both flow rate and suck-back to obtain a required dispense.

The system can further comprise a controller operatively coupled to the deposition unit and the optical source. The controller can be programmed to (a) direct the deposition unit to deposit the at least the portion of the mixture onto the area, and (b) direct the optical source to provide the light to the mixture for the printing. In some embodiments, the controller can be programmed to individually control flow of the mixture through each of the nozzle of the plurality of nozzles and towards at least a portion of the area, thereby to control dispense location of the mixture onto the area. In some embodiments, the controller is programmed to direct the deposition unit to move across the area to deposit the at least the portion of the mixture onto the area.

FIG. 9E shows an example dispense of the mixture using a deposition unit as disclosed herein. The deposition unit comprises 6 nozzles (or holes, as used interchangeably herein). The diameters of the nozzles are 2 mm for 907 and 908, 2.1 mm for 906 and 909, and 2.2 mm for 905 and 910, respectively. During each dispense, 6 aliquots of mixtures are disposed on an area of a platform (Disp 1). As the deposition unit moves across the area, additional 6 aliquots of mixtures are disposed on the area of the platform (Disp 2) and so on (Disp 3, Disp 4, Disp 5, Disp 6, Disp 7) for forming the 3D object. In some examples, the volume dispensed from a nozzle is at least 0.5 mL, at least 0.6 mL, at least 0.7 mL, at least 0.8 mL, at least 0.9 mL, at least 1 mL, or more.

The system provided herein can allow for multiple dispensing points by replacing the nozzle of the dispenser cartridge with a cartridge with a distributed dispense manifold, without adding another motor axis to move the dispenser. The system disclosed herein can enhance the uniformity in distribution of the plurality of particles in a printed layer of the printed 3D object.

### Wiper

In an aspect, the present disclosure provides a system for printing a 3D object. The system can comprise a platform comprising an area configured to hold a mixture for printing at least a portion of the 3D object. The system can comprise a deposition unit comprising a structural support and a wiper coupled to the structural support for (i) spreading the mixture over the area or (ii) removing at least a portion of an excess of the mixture from the area. The wiper can be configured to move relative to the structural support, such that an axis along a length of the wiper shifts between (a) a non-parallel position relative to a surface of the area and (b) a substantially parallel position relative to the surface of the area. The system can further comprise an optical source configured to provide light to the mixture to form the at least the portion of the 3D object.

In some embodiments, the wiper can be configured to spread the mixture over the area. In some embodiments, the wiper can be configured to ensure a uniform thickness of the mixture over the area. In some embodiments, the wiper can be configured to remove at least a portion of the excess mixture from the area. In some embodiments, the at least the portion of the excess mixture removed from the area can be used in subsequent printings.

In some embodiments, the wiper can be configured to rotate about a pivot point to move relative to the structure support. In some embodiments, the pivot point can be a single pivot point. In some embodiments, the pivot point can be disposed at or adjacent to a central position along the length of the wiper. In some embodiments, the pivot point can comprise more than one pivot points.

In some embodiments, the deposition unit can further comprise a fastener to substantially maintain the wiper at the substantially parallel position.

In some embodiments, the system can further comprise a controller operatively coupled to the deposition unit. The controller can be programmed to direct movement of the area and the deposition unit relative to one another, thereby to direct the wiper to perform (i) the spreading or (ii) the removing. The controller can be programmed to direct the optical source to provide the light to the mixture for the printing.

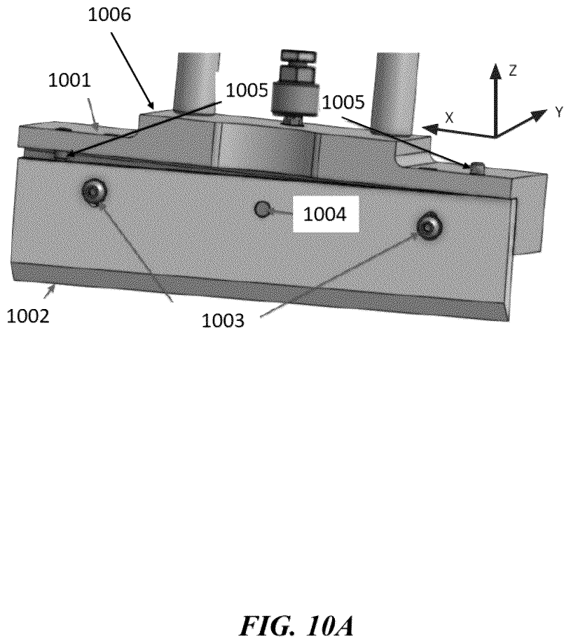

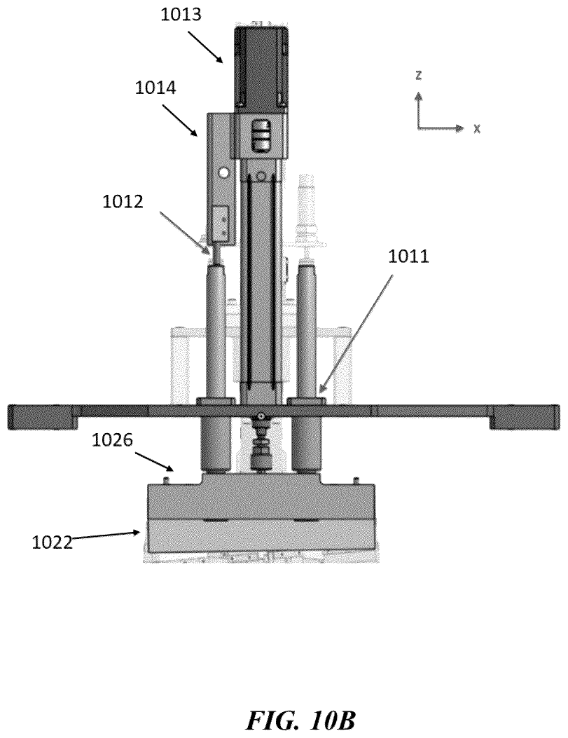

Referring to FIG. 10A, a wiper 1002 is coupled to a structural support 1006 wherein the structural support 1006 and the wiper 1002 are both parts of a deposition unit. The structural support 1006 comprises a plurality of brackets comprising a plurality of adjustment screws 1005 to connect the wiper 1002 to the structural support 1006. The wiper 1002 further comprises a pivot pin 1004 at the center for connecting to the structural support 1006. The pivot pin 1004 allows for tilting of the wiper 1002 relative to the structural support 1006. During printing, a relative position of the wiper to the mixture can be adjusted by tilting the wiper 1002 to the structural support 1006. The adjustment screws 1005 can be turned clockwise or counterclockwise to accommodate the tilting. The wiper 1002 can further comprise a plurality of tightening screws 1003 at the side of the wiper 1002 to secure the wiper alignment once setup is done.

Referring to FIG. 10B, the structural support of FIG. 10A can be coupled to a deposition unit 1013 through a structural unit 1014. The structural unit 1014 can comprise a plurality of high precision positioning switches 1012 to adjust the position of the structural support 1026 to the deposition unit 1013. The structural unit 1014 can further comprise a linear guide and shaft assembly 1011 to prevent rotation of the wiper 1022 about Z axis during setup and motion.

In some embodiments, the wiper can be a non-contact wiper, such that the deposition unit is not in direct contact with the area during the spreading, which in turn eliminates wear on the exposure window or film (e.g., a fluorinated ethylene propylene (FEP) film) on the exposure window.

Using the system provided herein, a uniform gap between the wiper and the surface of the platform (i.e., the exposure window, or the EFP film on the exposure window) can be maintained therefore ensuring uniformity of the deposited mixture and the wear of the surface of the platform can be minimized or eliminated.

### Printing Sensor

In an aspect, the present disclosure provides a system for printing a 3D object. The system can comprise an optical source configured to provide light to a mixture, wherein the light is sufficient to cause formation of at least a portion of the 3D object during the printing. The system can comprise a build head for supporting at least the portion of the 3D object. The system can further comprise a platform comprising an area for holding the mixture adjacent to the build head, such that at least a portion of the mixture is disposed under compression between the area and the build head during the printing. The system can further comprise a sensor for detecting an optical profile of at least a portion of the mixture that is under the compression.

In some embodiments, the sensor can comprise a camera. In some embodiments, the sensor can be configured to capture an image or video of the at least portion of the mixture that is under compression.

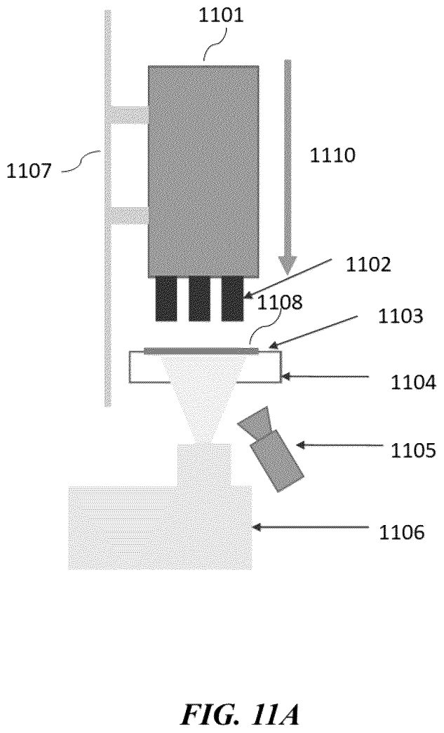

Referring to FIG. 11A, the system comprises a build head 1101 configured to move relative to a platform 1104. The build head 1101 is movable by an actuator 1107. The build head 1101 is configured to support at least a portion of a 3D object 1102. The platform 1104 comprises an area 1103 for holding a mixture 1108. The build head 1101 can be moved by the actuator 1107 downwards in the 1110 direction to adjacent to the mixture 1108. During the printing, the build head 1101 is lowered to compress at least a portion of the mixture 1108. The system further comprises an optical source 1106 for providing a light to the mixture 1108 through the platform 1104, e.g., a print window. The system further comprises a sensor 1105, e.g., a camera, for detecting an optical profile of at least a portion of the mixture 1108 that is under the compression. The optical profile can be indicative of a quality of the mixture 1108. The sensor 1105 can capture images or videos of at least a portion of the mixture 1108. The images or videos can be used for detection and mitigation of entrapped bubbles in the mixture 1108, uneven metal loading in the mixture 1108, non-uniform thickness of the mixture 1108, and errors in projection geometry.

Referring to FIG. 11B, the system can comprise an additional optical source 1111 for providing an additional light to at least a portion of the mixture 1108 that is under compression during the printing. The additional optical source can comprise bar lighting, dark field lighting, diffuse on-axis lighting, diffuse dome/ring lighting, back lighting, dome lighting, low angle dark field lighting, ring lighting, high-powered integrated lighting, or insight integrated lighting. The additional optical source can comprise a red bar lighting. The additional light can comprise a red light. In some embodiments, the additional light can comprise an infrared light. The sensor 1105 can detect a different light that is reflected or remitted by at least a portion of the mixture 1108 upon exposure to the additional light. The additional light from the additional optical source 1111 can provide illumination and contrast such that the defects in the mixture 1108 can be more visible in the images captured by the sensor 1105, providing enhanced detection of the defects.

In some embodiments, the optical profile can comprise thickness, presence/absence of defects, volume, density of particles within the mixture, surface profile, air bubbles, and/or phase separation of the mixture deposited on the print window, film, or platform.

Referring to FIG. 11B, the platform 1104 can comprise a transparent polymer film 1109. The film 1109 can be configured to hold the mixture 1108.

In some embodiments, the optical source 1106 can be an ultraviolet (UV) projector and the light can comprise a UV light.

In some embodiments, the system can further comprise one or more controllers. The one or more controllers can be operatively coupled to the platform 1104, the optical source 1106, the build head 1101, the sensor 1105 or the additional optical source 1111. The one or more controllers can be programmed to direct movement of build head 1101 and the platform 1104 relative to one another, to provide the mixture 1108 under the compression. In some embodiments, the one or more controllers can be programmed to direct the build head 1101 to move relative to the platform 1104. The one or more controllers can be programmed to direct the sensor 1105 to detect the optical profile of at least a portion of the mixture 1108 that is under the compression. The one or more controllers can be programmed to direct the optical source 1106 to provide a light to the mixture 1108 to form at least a portion of the 3D object. The one or more controllers can be programmed to direct the additional optical source 1111 to provide a light to at least a portion of the mixture 1108 that is under compression.

FIG. 11C shows images that are captured by a sensor when the build head moves towards the mixture. As a previous layer of a 3D object starts to contact the mixture, the image starts to reveal the shape of the previous layer of the 3D object. At higher compression, the shape of the previous layer of the 3D object becomes more visible. Under UV exposure, the images reveal both the shape of the previous layer of the 3D object and the light projections.

The system provided herein can provide a way to monitor the printing process and quality control the process.

### Kits for 3D Printing

A mixture for forming 3D object can comprise a polymeric precursor and a plurality of particles. In some embodiments, the plurality of particles can comprise a distribution of particle dimension (e.g., a distribution of average particle diameter).

During a printing, when a build head compresses the mixture on a platform (such that the compressed mixture is disposed between the build head and the platform), at least a portion of the mixture may be pushed out of the compressed region and towards/around one or more edges of the build head. The portion of the mixture that is pushed out of the compressed region can have a concentration of particles higher than that of the mixture due to evaporation of volatile components and migration of particles out of the compressed region.

In some embodiments, a portion of the mixture that is pushed out of the compressed region, i.e., excess resin, can be collected and combined with a new mixture in a subsequent printing. The combination of the excess resin with the new mixture has a higher concentration of the plurality of particles than a prior mixture and/or a combination of a prior excess resin with a prior mixture, thus resulting in inconsistent concentration of the plurality of particles in different layers of the 3D object. There are needs for kits, systems and methods for printing a 3D object that can increase the consistency of concentration of the plurality of particles throughout 3D printing.

In an aspect, the present disclosure provides a kit for printing a 3D object. The kit comprises a plurality of mixtures for forming a 3D object. The plurality of mixtures can comprise a first mixture and a second mixture. The first mixture can comprise a first polymeric precursor for forming a first polymeric material and a first plurality of particles, wherein at least a portion of the first mixture is usable for forming a first layer of the 3D object. The second mixture can comprise a second polymeric precursor for forming a second polymeric material and a second plurality of particles, wherein at least a portion of the second mixture is usable for forming a second layer of the 3D object. The first concentration of the first plurality of particles in the first mixture can be different than a second concentration of the second plurality of particles in the second mixture.

The first polymeric precursor and the second polymeric precursor can comprise monomers to be polymerized into the polymeric material, oligomers to be cross-linked into the polymeric material, or both. The monomers may be of the same or different types. An oligomer may comprise two or more monomers that are covalently linked to each other. Alternatively or in addition to, first polymeric precursor and the second polymeric precursor can include a dendritic precursor (monodisperse or polydisperse).

In some embodiments, the first polymeric precursor and the second polymeric precursor can comprise at least one photoinhibitor.

In some embodiments, the first polymeric precursor and the second polymeric precursor can be the same. In some embodiments, the first polymeric precursor and the second polymeric precursor can be different. In some embodiments, the plurality of mixtures can be stored in separate containers.

The first plurality of particles and the second plurality of particles can comprise metal particles or ceramic particles. In some embodiments, the first plurality of particles and the second plurality of particles can be the same. In some embodiments, the first plurality of particles and the second plurality of particles can be different.

In some embodiments, the first concentration of the first plurality of particles in the first mixture is at least about 50%, at least 60%, at least 70%, at least 80%, by weight, or more.

In some embodiments, the second concentration of the second plurality of particles in the second mixture is at least about 50%, at least 60%, at least 70%, at least 80%, by weight, or more.

In some embodiments, the first concentration is higher than the second concentration by at least 0.1%, at least 0.5%, at least 1%, at least 1.5%, at least 2%, at least 2.5%, at least 3%, at least 3.5%, at least 4%, at least 4.5%, at least 5%, at least 5.5%, at least 6%, at least 6.5%, at least 7%, at least 8%, at least 9%, at least 10%, by weight, or more.

In some embodiments, the second layer is directly coupled to the first layer.

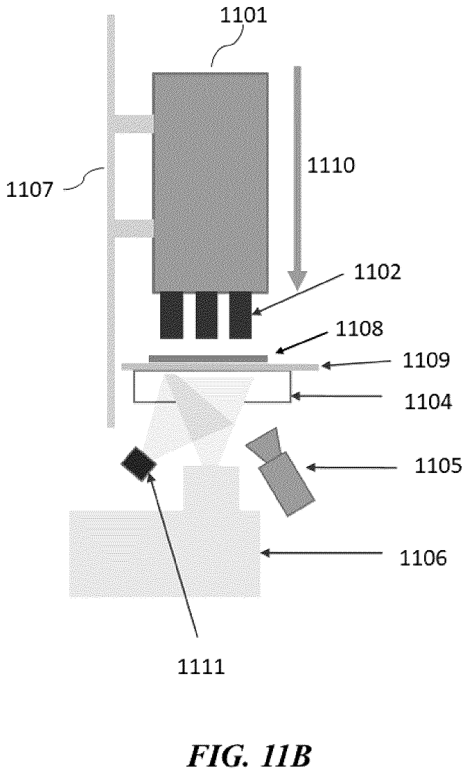

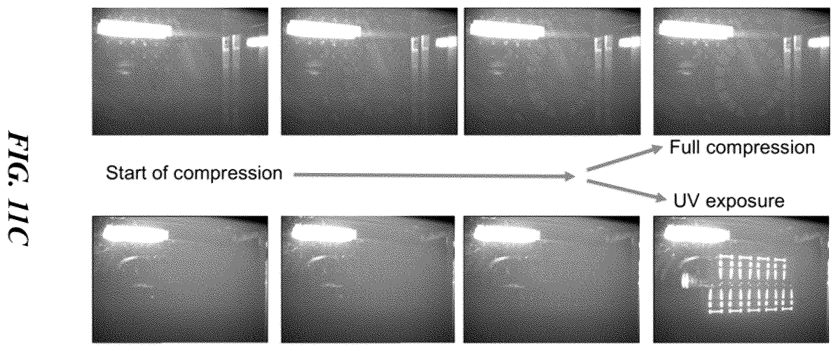

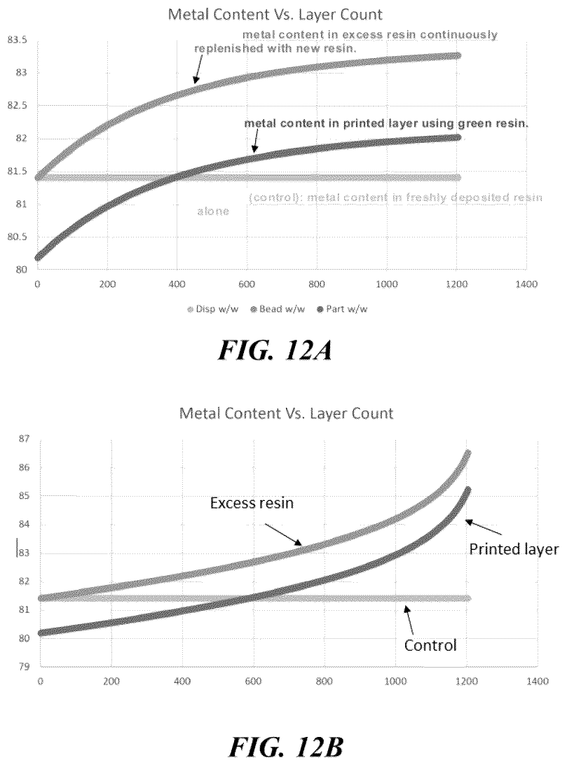

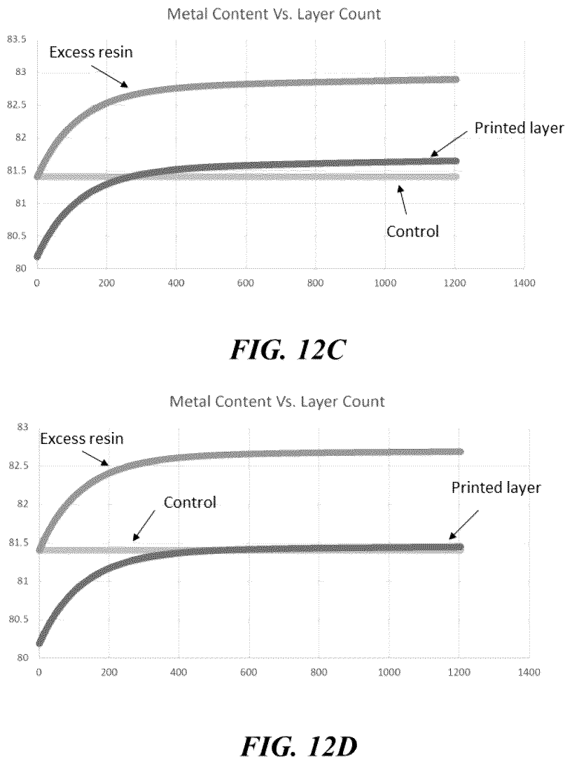

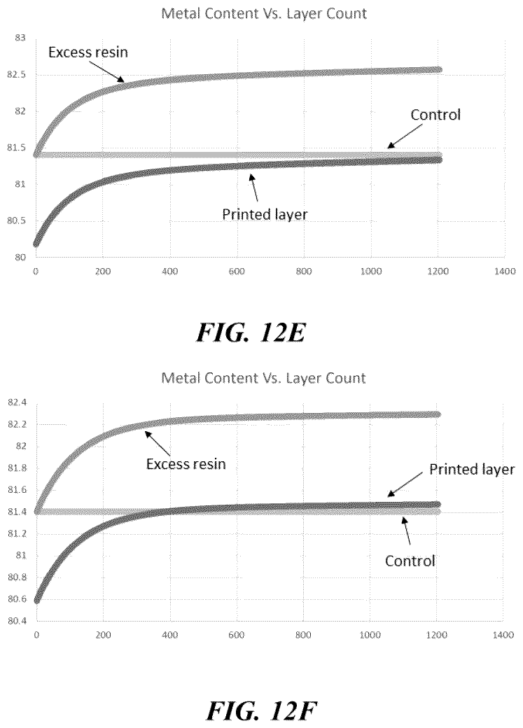

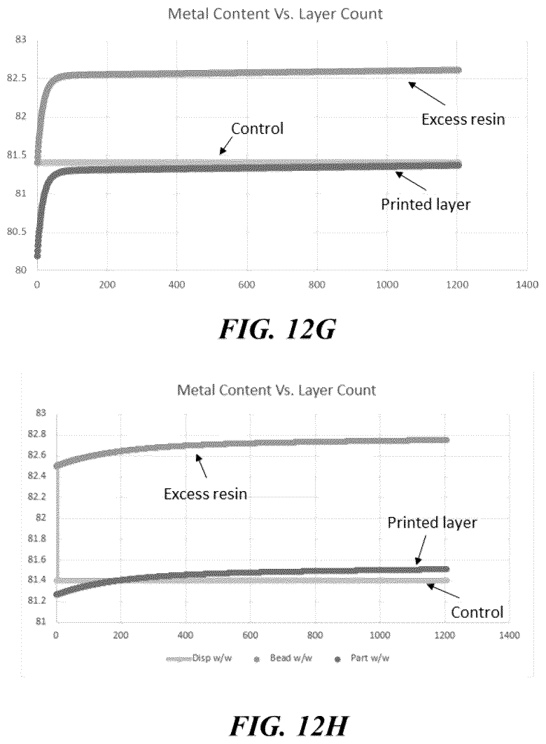

FIG. 12A shows an example modeling result of a 3D printing process. The mixture has a metal content of 81.4 wt %. Initial dispense volume is 30 mL with a layer thickness of 22 μm, a coating thickness of 90 μm, and a layer area of 3600 mm² . With dispense extent of 100%, zonal extent of 30%, evaporation area of 100%, over-dispense percentage of 5%, and evaporation ration of 0.002 wt % per layer, after 1200 layers of printing, no steady state is reached. The metal content in excess resin continuously increases from 81.4 wt % to 83.2 wt %. The metal content in printed layer also continuously increases from 80.2 wt % to 82 wt %. The metal content in the printed part is about 98.5% of the metal content in the feedstock mixture.

FIGS. 12B-12G show additional example modeling results of a 3D printing process with varying mixing conditions and dispensing conditions. As the same feedstock is used throughout the printing process, a variation of particle content in layer is observed, with a lower content at beginning and higher content in later printed layers. The variation in particle content can be from 1 wt % to 2 wt %.

FIG. 12H shows an example modeling result of a 3D printing process. A mixture with higher particle content is used initially and then the particle content is lowered. Referring to FIG. 12H, the particle content in the printed 3D object is more consistent throughout the layers.

Using the kits as provided herein, a more consistent distribution of particles throughout the printed layers can be obtained.

### Methods of Use

Additional aspects of the present disclosure provide methods of using any of the systems provided herein for printing one or more 3D objects.

In an aspect, the present disclosure provides a method for printing a 3D object. The method can comprise providing an optical source for providing light to a mixture wherein the light is sufficient to cause formation of at least a portion of the 3D object during the printing. The method can comprise providing a build head for supporting at least the portion of the 3D object. The method can comprise providing a platform comprising an area for holding the mixture adjacent to the build head. The method can comprise providing an actuator operatively coupled to the platform. The method can comprise, via the actuator, adjusting a movement between the area and the build head relative to one another, along a plurality of degrees of freedom. In some embodiments, the actuator is coupled to the platform. In some embodiments, the plurality of degrees of freedom comprises one, two, three, four, five, or six members selected from the group consisting of x, y, z, pitch, yaw, and roll. In some embodiments, the plurality of degrees of freedom comprises pitch and yaw. In some embodiments, the area is adjusted relative to the build head while the build head remains stationary. The method can comprise, via the actuator, adjusting a movement between the area and the optical source relative to one another. In some embodiments, the area is adjusted relative to the optical source while the optical source remains stationary. The method can further comprise using the optical source to provide the light to the mixture disposed adjacent to the area of the platform for the printing. The optical source can provide the light through the area and towards the mixture. The method can further comprise moving the build head along a direction towards or away from the platform during the printing.

In another aspect, the present disclosure provides a method for printing a 3D object. The method can comprise providing a platform comprising: (i) a window for holding a mixture for printing at least a portion of the 3D object, wherein a bottom surface of the window comprises an inner portion surrounded by an outer portion and (ii) a support unit coupled to the inner portion of the bottom surface of the window, to provide stability to the window. The method can comprise providing a build head for supporting at least the portion of the 3D object. The method can comprise providing an optical source for providing light to the mixture to form the portion of the 3D object. The light is sufficient to cause formation of the at least the portion of the 3D object. The method can comprise using the optical source to provide the light to the mixture disposed adjacent to the window of the platform for the printing. The method can comprise using a controller operatively coupled to the optical source to operate the optical source.

In another aspect, the present disclosure provides a method for printing a 3D object. The method can comprise providing a build head for supporting at least a portion of the 3D object during the printing. The method can comprise providing a platform comprising an area for holding a mixture adjacent to the build head. The method can comprise providing an actuator operatively coupled to the optical source. The method can comprise providing an optical source for providing light to the mixture to form the portion of the 3D object. The light is sufficient to cause formation of the at least the portion of the 3D object. The method can comprise adjusting a movement between the optical source and the build head relative to one another, along a plurality of degrees of freedom. The plurality of degrees of freedom can comprise one, two, three, four, five, or six members selected from the group consisting of x, y, z, pitch, yaw, and roll. The method can comprise providing an actuator operatively coupled to the optical source. The method can comprise adjusting a movement between the optical source and the area relative to one another. The method can comprise using the optical source to provide the light to the mixture disposed adjacent to the window of the platform for the printing. The method can comprise using a controller operatively coupled to the optical source to operate the optical source. The method can comprise using a controller operatively coupled to the optical source to operate the optical source.

In another aspect, the present disclosure provides a method for printing a 3D object. The method can comprise providing a platform comprising an area for holding a mixture for printing at least a portion of the 3D object during the printing. The method can comprise providing a deposition unit in fluid communication with a source of the mixture, wherein the deposition unit is configured to deposit at least a portion of the mixture onto the area. The method can comprise providing a building unit comprising an optical source providing light to the mixture. The light is sufficient to cause formation of the at least the portion of the 3D object. The method can comprise providing a plurality of guiding elements operatively coupled to the platform. The plurality of guiding elements can direct movement of the platform between the deposition unit and the building unit. A first guiding element of the plurality of guiding elements can move along a first path, and a second guiding element of the plurality of guiding elements can move along a second path that is not overlapping with the first path. In some embodiments, the first path and the second path are disposed in a single plane that is substantially parallel to the area. The method can comprise directing, via the plurality of guiding elements, the movement of the platform between the deposition unit and the building unit. The method can comprise using the optical source to provide the light to the mixture disposed adjacent to the area of the platform for the printing.

In another aspect, the present disclosure provides a method for printing a 3D object. The method can comprise providing a platform comprising (i) an area for holding a mixture for printing at least a portion of the 3D object during the printing and (ii) a first coupling unit. The method can comprise providing a deposition unit in fluid communication with a source of the mixture, wherein the deposition unit can deposit at least a portion of the mixture onto the area. The method can comprise providing a building unit comprising an optical source for providing light to the mixture. The light is sufficient to cause formation of the at least the portion of the 3D object. The method can comprise providing a moving unit for directing movement of the platform between the deposition unit and the building unit. The moving unit can comprise a second coupling unit that is configured to couple to the first coupling unit, such that the platform is operatively coupled to the moving unit. In some embodiments, a vertical dimension of the second coupling unit can permit a vertical movement between the first coupling unit and the moving unit relative to one another. The method can comprise directing, via the moving unit, the movement of the platform between the deposition unit and the building unit. The method can comprise using the optical source to provide the light to the mixture disposed adjacent to the area of the platform for the printing. The method can comprise using a controller operatively coupled to the optical source to operate the optical source.

In another aspect, the present disclosure provides a method for printing a 3D object. The method can comprise providing a platform configured to support a film holding a mixture for printing at least a portion of the 3D object during the printing. The platform can comprise (i) a bar for holding the film at a side of the film, and (ii) an additional bar for holding the film at an additional side of the film. The bar can comprise a locking mechanism comprising (i) a locking state to couple at least a portion of the side of the film to the bar and (ii) an unlocking state to release at least the portion of the side of the film from the bar. The method can comprise providing an optical source for providing light to the mixture. The light is sufficient to cause formation of the at least the portion of the 3D object. The method can comprise using the optical source to provide the light to the mixture disposed adjacent to the film that is supported by the platform for the printing. The method can comprise using a controller operatively coupled to the optical source to operate the optical source.

In another aspect, the present disclosure provides a method for printing a 3D object. The method can comprise providing a platform comprising a top surface for holding a mixture for printing at least a portion of the 3D object, wherein a portion of the top surface is not parallel to an additional portion of the top surface that holds the mixture. The portion of the top surface can be substantially rigid. The method can comprise providing an optical source for providing light to the mixture, wherein the light is (i) usable for determining a characteristic of the mixture prior to the printing or (ii) sufficient to cause formation of the at least the portion of the 3D object during the printing. The method can comprise using the optical source to provide the light to the mixture disposed adjacent to the additional portion of the top surface of the platform for the printing. The method can comprise using a controller operatively coupled to the optical source to operate the optical source.

In another aspect, the present disclosure provides a method for printing a 3D object. The method can comprise providing a platform comprising an area for holding a mixture for printing at least a portion of the 3D object. The method can comprise providing a deposition unit comprising a wiper configured to (i) remove at least a portion of an excess of the mixture from the area or (ii) spread the mixture over the area, an actuator configured to control a vertical movement of the wiper towards or away from the area, and a dampener, e.g., a spring disposed between the actuator and the wiper, to reduce at least a portion of a force exerted by the actuator and towards the wiper when the actuator directs the vertical movement of the wiper towards or away from the area. The method can comprise providing an optical source configured to provide light to the mixture, wherein the light is sufficient to cause formation of the at least the portion of the 3D object during the printing. The method can comprise using the deposition unit to (i) remove the at least the portion of an excess of the mixture from the area or (ii) spread the mixture over the area. The method can comprise using the optical source to provide the light to the mixture disposed adjacent to the area of the platform for the printing. The method can comprise using a controller operatively coupled to the deposition unit to (i) direct the actuator to control the vertical movement of the wiper, and (ii) direct the optical source to provide the light to the mixture, for the printing.

In another aspect, the present disclosure provides a method for printing a 3D object. The method can comprise providing a platform comprising an area for holding a mixture for printing at least a portion of the 3D object. The method can comprise providing a deposition unit comprising a plurality of nozzles in fluid communication with a common source of the mixture. Each of the plurality of nozzles can deposit at least a portion of the mixture onto the area, and wherein the plurality of nozzles can comprise a nozzle and an additional nozzle, wherein a cross-sectional dimension of the nozzle and an additional cross-sectional dimension of the additional nozzle can be different. The plurality of nozzles can comprise three or more nozzles. The method can comprise providing an optical source configured to provide light to the mixture, wherein the light is sufficient to cause formation of the at least the portion of the 3D object during the printing. The method can comprise using the deposition unit to deposit the mixture from the common source and towards the area of the platform, via one or more nozzles of the plurality of nozzles. The light is sufficient to cause formation of the at least the portion of the 3D object. The method can comprise using the optical source to provide the light to the mixture disposed adjacent to the area of the platform for the printing. The method can comprise using a controller operatively coupled to the optical source to direct the deposition unit and/or operate the optical source. The method can comprise using the controller to individually control flow of the mixture through each of the nozzle of the plurality of nozzles and towards at least a portion of the area, thereby to control dispense location of the mixture onto the area. The method can comprise using the controller to direct the deposition unit to move across the area to deposit the at least the portion of the mixture onto the area.

In another aspect, the present disclosure provides a method for printing a 3D object. The method can comprise providing a platform comprising an area for holding a mixture for printing at least a portion of the 3D object. The method can comprise providing a deposition unit comprising a structural support and a wiper coupled to the structural support for (1) spreading the mixture over the area or (2) removing at least a portion of an excess of the mixture from the area. The wiper can move relative to the structural support, such that an axis along a length of the wiper shifts between (i) a non-parallel position relative to a surface of the area and (ii) a substantially parallel position relative to the surface of the area. The method can comprise providing an optical source for providing light to the mixture to form the at least the portion of the 3D object. The method can comprise using the deposition unit to (1) spread the mixture over the area or (2) remove the at least the portion of the excess of the mixture from the area, via the wiper. The method can comprise using the optical source to provide the light to the mixture disposed adjacent to the area of the platform for the printing. The method can comprise using a controller operatively coupled to the deposition unit to (i) direct movement of the area and the deposition unit relative to one another, thereby to direct the wiper to perform (1) the spreading or (2) the removing; or (ii) direct the optical source to provide the light to the mixture for the printing.

In another aspect, the present disclosure provides a method for printing a 3D object. The method can comprise providing an optical source for providing light to a mixture, wherein the light is sufficient to cause formation of at least a portion of the 3D object during the printing. The method can comprise providing a build head configured to support the at least the portion of the 3D object. The method can comprise providing a platform comprising an area configured to hold the mixture adjacent to the build head, such that at least a portion of the mixture is disposed under compression between the area and the build head during the printing. The method can comprise providing a sensor configured to detect an optical profile of at least a portion of the mixture that is under the compression. The method can comprise using the sensor to detect the optical profile of the at least the portion of the mixture that is under the compression. The method can comprise using the optical source to provide the light to the mixture disposed adjacent to the area of the platform for the printing. The method can comprise using a controller operatively coupled to the build head, the platform, and the sensor to (i) direct movement of the build head and the platform relative to one another, to provide the mixture under the compression, (ii) subsequent to (i), direct the sensor to detect the optical profile of the at least the portion of the mixture that is under the compression, and (iii) subsequent to (ii), direct the optical source to provide the light to the mixture, to form the at least the portion of the 3D object.

In another aspect, the present disclosure provides a method for printing a 3D object. The method can comprise providing a plurality of mixtures comprising a first mixture comprising (i) a first polymeric precursor configured to form a first polymeric material and (ii) a first plurality of particles, and a second mixture comprising (i) a second polymeric precursor configured to form a second polymeric material and (ii) a second plurality of particles. A first concentration of the first plurality of particles in the first mixture is different than a second concentration of the second plurality of particles in the second mixture. The method can comprise directing a light to the first polymeric material in the first mixture to form the first polymeric material, thereby to print a first layer of the 3D object comprising at least a portion of the first plurality of particles. The method can comprise directing the light or an additional light to at least the second polymeric material in the second mixture to form the second polymeric material, thereby to print a second layer of the 3D object comprising at least a portion of the second plurality of particles. The method can comprise (i) mixing an excess of the first mixture and the second mixture to form a third mixture; and (ii) directing the light or the additional light to the third mixture, thereby to print the second layer of the 3D object comprising at least the portion of the second plurality of particles and an additional portion of the first plurality of particles from the excess of the first mixture. The method can comprise directing the light to at least the second polymeric material in the second mixture to form the second polymeric material.

In another aspect, the present disclosure provides a method for printing a 3D object. The method can comprise providing a platform comprising a top surface and a plurality of side surfaces, wherein the top surface of the platform is configured to hold a film for carrying a mixture for printing at least a portion of the 3D object; a perimeter wall disposed adjacent to and surrounding the plurality of side surfaces of the platform, wherein at least a portion of the perimeter wall is not in direct contact with at least a portion of a side surface of the plurality of side surfaces, such that the at least the portion of the perimeter wall and the at least the portion of the side surface are separated by a gap; and a vacuum unit in fluid communication with the gap, wherein the vacuum unit is configured to provide suction through the gap. The method can comprise using the vacuum unit to provide the suction through the gap to a bottom surface of the film, when the film is disposed adjacent to the top surface of the platform.

### Additional Details for 3D Printing

One or more actuators disclosed herein (e.g., for moving one or more platforms between two or more non-overlapping paths) may comprise at least 1, at least 2, at least 3, at least 4, at least 5, at least 6, at least 7, at least 8, at least 9, at least 10, or more actuator(s). The one or more actuators may comprise at most 10, at most 9, at most 8, at most 7, at most 6, at most 5, at most 4, at most 3, at most 2, or 1 actuator(s). Examples of the one or more actuators may comprise a stepper actuator, linear actuator, hydraulic actuator, pneumatic actuator, electric actuator, magnetic actuator, mechanical actuator (e.g., rack and pinion, chains, etc.), etc. Examples of the actuator provided herein may comprise a servomotor, brushed electric motor, brushless electric motor (e.g., stepper motor), torque motor, and shaft actuator (e.g., hollow shaft actuator).

The deposition unit and the building unit may comprise a working position for each platform to be in. For example, once a platform is transferred to the deposition unit along one of a plurality of non-overlapping paths, the platform may be configured to move towards the working position (e.g., to a mixture deposition position relative to a deposition unit as disclosed herein) via one or more actuators (e.g., one or more vertical actuators). In another example, once the platform is transferred to the building unit along one of the plurality of non-overlapping paths, the platform may be configured to move towards the working position (e.g., to a determined position relative to the optical source and/or the build head as disclosed herein) via one or more actuators (e.g., one or more vertical actuators).

In some embodiments of any one of the systems disclosed herein, the system may be for printing a three-dimensional (3D) object. A platform for holding the mixture (e.g., a film of the mixture), as disclosed herein, may be a transparent substrate (or a semi-transparent substrate). The system may comprise (1) a recoating station or a deposition station configured to coat a feedstock film onto a transparent substrate, (2) a printing station or a build station configured to receive the feedstock film on the transparent substrate and to cure the feedstock into a desired structural layer, and (3) a transfer device (e.g., one or more transfer devices) configured to move two or more transparent substrates between the recoating station and the printing station, wherein the system, may be configured for both the recoating station and the printing station to operate at the same time (or substantially at the same time).

In some embodiments, the transparent substrates may be held in one or more frames, and the transfer device may be configured to move (e.g., move substantially simultaneously) (i) a first transparent substrate from the recoating station to the printing station along a first plane and (ii) a second transparent substrate from the printing station to the recoating station along a second plane, wherein the first plane and the second plane may be parallel and separated by a distance greater that a thickness of the one or more frames. In such embodiments, the first and second transparent substrates may be over and under each other.

In some embodiments, the transparent substrates may be held in one or more frames, wherein the one or more frames may be coplanar and may be attached to one another at a central point, and the transfer device may be configured to move (e.g., move substantially simultaneously) (i) a first transparent substrate from the recoating station to the printing station and (ii) a second transparent substrate from the printing station to the recoating station, by pivoting around the central point. In such embodiments, the first and second transparent substrates may be rotationally swapped during 3D printing.

In some embodiments, the system may further comprise one or more sensors. The one or more sensors may be part of the recoating station and/or the printing station. Alternatively, the one or more sensors may be disposed separate from the recoating station and the printing station. For example, the system may comprise one or more sensor stations comprising (i) a pre-print inspection station configured to receive a feedstock film on the transparent substrate from the recoating station and to inspect the feedstock film before sending the feedstock film on the transparent substrate onto the printing station, and (ii) a post-print inspection station configured to receive a waste film on the transparent substrate from the printing station and to inspect the waste film before sending the waste film on the transparent substrate onto the recoating station.

In some embodiments, the transparent substrates may be held in one or more frames, and the transfer device may be configured to move simultaneously (e.g., substantially simultaneously) (i) a first transparent substrate from the recoating station to the pre-print inspection station, (ii) a second transparent substrate from the pre-print inspection station to the printing station, (iii) a third transparent substrate from the printing station to the post print inspection station, and (iv) a fourth transparent substrate from the post print inspection station to the recoating station, wherein the first, second, third, and fourth transparent substrates maybe co-planar. In some examples, the transfer device may direct movement of (or may move) the first, second, third, and/or fourth transparent substrates around a continuous track. In some examples, the transfer device may direct movement of (or may move) the first, second, third, and fourth transparent substrates around a pivot point. In some examples, the transparent substrate may be a continuous belt, and the transfer device may be configured to advance the belt to move the transparent substrate from the recoating station to the printing station. In some examples, the transparent substrate may be a wound sheet between a payout roll and a take-up roll, and the transfer device may be configured to unwind the payout roll and wind the take up roll to move the transparent substrate from the recoating station to the printing station.

In some embodiments, a dimension (e.g., an average diameter) the particles in the mixture that may be flown out or pushed out of the compressed region (e.g., region that is compressed by the build head, as disclosed herein), may be at most about 80%, at most about 75%, at most about 70%, at most about 65%, at most about 60%, at most about 55%, at most about 50%, at most about 45%, at most about 40%, at most about 35%, at most about 30%, at most about 25%, at most about 20%, or less than a thickness of the compressed region. In some embodiments, the dimension (e.g., an average diameter) of the particles in the mixture that may be flown out or pushed out of the compressed region may be at most about 60%, at most about 55%, at most about 50%, at most about 45%, at most about 40%, at most about 35%, at most about 30%, at most about 25%, at most about 20%, or less than the thickness of the compressed region. In some embodiments, the dimension (e.g., an average diameter) of the particles in the mixture that may be flown out or pushed out of the compressed region may be at most about 50% of the thickness of the compressed region. In some examples, the thickness of the compressed region of the film of mixture may be between about 10 μm and about 200 μm, about 10 μm and about 100 μm, or about 50 μm and 100 μm.

In some embodiments, when the excess mixture (excess mixture remaining after curing and removing at least a portion of the film of the mixture) is re-used for printing one or more subsequent layers without using the at least the first wiper as disclosed herein for mixing the excess mixture, and this process is repeated for printing a plurality of layers, an average particle size (e.g., as defined by D50 measurement) of the excess (or left-over) mixture disposed over the platform may decrease after printing a plurality of layers. For example, without the use of the at least the first wiper as disclosed herein, the average particle size of the excess mixture may decrease by at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35%, at least about 40%, or more upon printing at least about 10 layers, at least about 15 layers, at least about 20 layers, at least about 25 layers, at least about 30 layers, at least about 35 layers, at least about 40 layers, at least about 45 layers, at least about 50 layers, at least about 55 layers, at least about 60 layers, at least about 65 layers, at least about 70 layers, at least about 80 layers, at least about 90 layers, at least about 100 layers, or more (e.g., layers having the same shape or different shapes). For example, without the use of the at least the first wiper, the average particle size of the excess mixture may decrease by about 15% as compared to the starting average particle size of the mixture, after printing about 50 layers. Thus, by use of the at least the first wiper as disclosed herein during 3D printing, a degree of such decrease of the average particle size of the excess mixture after printing a plurality of layers may be reduced by at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35%, at least about 40%, or more (as compared to 3D printing without the at least the first wiper) upon printing at least about 10 layers, at least about 15 layers, at least about 20 layers, at least about 25 layers, at least about 30 layers, at least about 35 layers, at least about 40 layers, at least about 45 layers, at least about 50 layers, at least about 55 layers, at least about 60 layers, at least about 65 layers, at least about 70 layers, at least about 80 layers, at least about 90 layers, at least about 100 layers, or more (e.g., layers having the same shape or different shapes).

In some embodiments, when the excess mixture is re-used for printing one or more subsequent layers without using the at least the first wiper as disclosed herein for mixing the excess mixture, and this process is repeated for printing a plurality of layers, there may be a build-up of particles (e.g., metal and/or ceramic powder particles) in the portion of the excess mixture adjacent to the part that has been cured and removed, as a function of layer number. This, mixing the excess mixture by the at least one wiper as disclosed herein (e.g., prior to the use of the at least the second wiper) may reduce heterogeneity within the excess mixture (or substantially re-homogenize the excess mixture) to redistribute the particles that have been pushed out of the compressed region, to reduce or substantially prevent such local build-up of particles adjacent to the part that has been cured and removed. As such, while the smaller particles (or fine particles) may be prone to getting pushed out of the compressed region, such particles may be redistributed by mixing via the at least the first wiper to minimize their effect (e.g., negative effect) on printing or quality of the printed part(s). In some examples, without the use of the at least the first wiper as disclosed herein, local particle loading in the mixture (e.g., the local concertation of particles within a local volume of the mixture) adjacent to (e.g., adjacent to and outside of) the compressed region may increase by at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35%, at least about 40%, or more upon printing at least about 10 layers, at least about 15 layers, at least about 20 layers, at least about 25 layers, at least about 30 layers, at least about 35 layers, at least about 40 layers, at least about 45 layers, at least about 50 layers, at least about 55 layers, at least about 60 layers, at least about 65 layers, at least about 70 layers, at least about 80 layers, at least about 90 layers, at least about 100 layers, or more (e.g., layers having the same shape or different shapes). For example, without the use of the at least the first wiper as disclosed herein, the local particle loading in the mixture may increase by about 5% after printing about 50 layers. Thus, by use of the at least the first wiper as disclosed herein during 3D printing, a degree of such increase of the local particle loading adjacent to the compressed region may be reduced by at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35%, at least about 40%, or more (as compared to 3D printing without the at least the first wiper) upon printing at least about 10 layers, at least about 15 layers, at least about 20 layers, at least about 25 layers, at least about 30 layers, at least about 35 layers, at least about 40 layers, at least about 45 layers, at least about 50 layers, at least about 55 layers, at least about 60 layers, at least about 65 layers, at least about 70 layers, at least about 80 layers, at least about 90 layers, at least about 100 layers, or more (e.g., layers having the same shape or different shapes).

As disclosed herein, a volume of the compressed region within a film of the mixture may be about 10% to about 90%. A volume of the compressed region within a film of the mixture may be at least about 10%. A volume of the compressed region within a film of the mixture may be at most about 90%. A volume of the compressed region within a film of the mixture may be about 10% to about 20%, about 10% to about 25%, about 10% to about 30%, about 10% to about 35%, about 10% to about 40%, about 10% to about 45%, about 10% to about 50%, about 10% to about 60%, about 10% to about 70%, about 10% to about 80%, about 10% to about 90%, about 20% to about 25%, about 20% to about 30%, about 20% to about 35%, about 20% to about 40%, about 20% to about 45%, about 20% to about 50%, about 20% to about 60%, about 20% to about 70%, about 20% to about 80%, about 20% to about 90%, about 25% to about 30%, about 25% to about 35%, about 25% to about 40%, about 25% to about 45%, about 25% to about 50%, about 25% to about 60%, about 25% to about 70%, about 25% to about 80%, about 25% to about 90%, about 30% to about 35%, about 30% to about 40%, about 30% to about 45%, about 30% to about 50%, about 30% to about 60%, about 30% to about 70%, about 30% to about 80%, about 30% to about 90%, about 35% to about 40%, about 35% to about 45%, about 35% to about 50%, about 35% to about 60%, about 35% to about 70%, about 35% to about 80%, about 35% to about 90%, about 40% to about 45%, about 40% to about 50%, about 40% to about 60%, about 40% to about 70%, about 40% to about 80%, about 40% to about 90%, about 45% to about 50%, about 45% to about 60%, about 45% to about 70%, about 45% to about 80%, about 45% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%. A volume of the compressed region within a film of the mixture may be about 10%, about 20%, about 25%, about 30%, about 35%, about 40%, about 45%, about 50%, about 60%, about 70%, about 80%, or about 90%. For example, the volume of the compressed region may be between about 30% and about 35% of the volume of the film of the mixture.

As disclosed herein, the wipers in the multiple wiper system may be made of any flexible material that is suitable for use with the mixture of interest. When a plurality of wipers is used (e.g., for the at least the first wiper as disclosed herein), the plurality of wipers may comprise the same material. Alternatively, the plurality of wipers may comprise different materials.

Once the at least the portion of the 3D object is printed (herein referred to as a green body), the method may further comprise removing the green body from the build head. The green body may be separated from the build head by inserting a thin material (e.g., a steel blade) between the green body and the build head. In some examples, a first layer of the green body that is in contact with the build head may not comprise the plurality of particles for easy removal from the build head by the thin material. The method may further comprise washing the green body. The green body may be washed by jetting a solvent (e.g., isopropanol) to remove any excess polymeric precursor. The method may further comprise subjecting the green body to further heat treatment (e.g., in a furnace) to (i) decompose (e.g., into a gas phase) or remove at least a portion of (e.g., substantially all of polymeric materials and/or precursors in the green body and/or (ii) sinter the plurality of particles of the green body to form a final product that is at least a portion of a 3D object or an entire 3D object.

A wiper as disclosed herein may comprise a blade, a roller, and/or a rod. A surface of the wiper may comprise (e.g., may be coated with) one or more fluoropolymers that prevent adhesion of the at least one wiper to the back surface of the substrate. Examples of the one or more fluoropolymers include polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (a copolymer of tetrafluoroethylene and perfluoromethylvinylether, also known as MFA).

In an example, a wiper as disclosed herein may be a roller or a rod. The roller or a rod may have a diameter of at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm, at least about 21 mm, at least about 22 mm, at least about 23 mm, at least about 24 mm, at least about 25 mm, at least about 26 mm, at least about 27 mm, at least about 28 mm, at least about 29 mm, at least about 30 mm, or more. The roller or a rod may have a diameter of at most about 30 mm, at most about 29 mm, at most about 28 mm, at most about 27 mm, at most about 26 mm, at most about 25 mm, at most about 24 mm, at most about 23 mm, at most about 22 mm, at most about 21 mm, at most about 20 mm, at most about 19 mm, at most about 18 mm, at most about 17 mm, at most about 16 mm, at most about 15 mm, at most about 14 mm, at most about 13 mm, at most about 12 mm, at most about 11 mm, at most about 10 mm, at most about 9 mm, at most about 8 mm, at most about 7 mm, at most about 6 mm, at most about 5 mm, or less.

A sensor as disclosed herein may be configured to provide a feedback (e.g., light absorption spectroscopy, image, video, etc.) indicative of the film of the mixture disposed on or adjacent to at least a portion of the platform (e.g., a print window of the platform, a film disposed on or adjacent to the at least the portion of the platform, etc.). The sensor may be operatively coupled to a controller (e.g., a computer) that controls one or more operations (e.g., depositing the film of the mixture onto the at least the portion of the platform) of the 3D printing. The controller may adjust the one or more operations of the 3D printing, based on the feedback provided by the sensor. The controller may adjust the operation(s) during the 3D printing, and thus such feedback may be a closed loop feedback. The sensor may provide the feedback (i) during calibration of the 3D printing system, (ii) prior to, during, and/or subsequent to depositing the film of the mixture to be used for 3D printing, and/or (iii) prior to, during, or subsequent to solidifying (curing) at least a portion of the film of the mixture to print at least a portion of the 3D object. The sensor may provide the feedback pre-fabrication or post-fabrication of the 3D object. The 3D printing may use at least about 1, at least about 2, at least about 3, at least about 4, at least about 5, at least about 6, at least about 7, at least about 8, at least about 9, at least about 10, or more sensors. The 3D printing may use at most about 10, at most about 9, at most about 8, at most about 7, at most about 6, at most about 5, at most about 4, at most about 3, at most about 2, or 1 sensor(s).

Examples of the sensor configured to provide such feedback indicative of the film of the mixture may comprise a detector, vision system, computer vision, machine vision, imager, camera, electromagnetic radiation sensor (e.g., IR sensor, color sensor, etc.), proximity sensor, densitometer (e.g., optical densitometer), profilometer, spectrometer, pyrometer, force sensor (e.g., piezo sensor for pressure, acceleration, temperature, strain, force), motion sensor, magnetic field sensor (e.g., microelectromechanical systems), electric field sensor, chemical sensor, structured-light sensor, etc.

The sensor may be capable of detecting and/or analyzing one or more profiles of various components of the 3D printing system. The various components may be used (e.g., the print window) and/or generated (e, g., the film of mixture or mixture) during the 3D printing process.

The sensor may capture profiles of a print surface (e.g., a portion of the platform, i.e., a print area, the film 170), a surface of the build head that is configured to hold at least a portion of the 3D object during printing, or a surface of a previously deposited layer of the 3D object adjacent to the build head.

The feedback from the sensor may be one or more images of the film of the mixture or any excess mixture remaining on the print surface after printing at least a portion of the 3D object. The feedback from the sensor may be one or more videos (e.g., for a duration of time) of the film of the mixture or the excess mixture remaining on the print surface.

The feedback provided by the sensor may comprise one or more internal or external features (e.g., temperature, transparency or opacity, surface texture, thickness, shape, size, length, area, pattern, density of one or more particles embedded in the film of the mixture, defects, etc.) of the film of the mixture deposited on or adjacent to the print surface. In an example, the sensor provides such feedback of the film of the mixture prior to solidifying (e.g., curing, polymerizing, cross-linking) a portion of the film of the mixture into at least a portion of the 3D object. In another example, the sensor provides such feedback of any excess mixture remaining on the print surface after the portion of the film of the mixture is solidified (e.g., cured, polymerized, cross-linked) into the at least a portion of the 3D object and removed from the print surface (e.g., by the build head). The feedback may comprise the one or more internal or external features of at least a portion of a 3D object printed on the build head, or a portion of a non-printed 3D object on the build head onto which at least a portion of a 3D object is to be printed.

The sensor may be capable of measuring an energy that is emitted, reflected, or transmitted by a medium (e.g., the film of the mixture on the build surface). The sensor may be capable of measuring an energy density, comprising: electromagnetic energy density, optical energy density, reflectance density, transmittance density, absorbance density, spectral density, luminescence (fluorescence, phosphorescence) density, and/or electron density. Such energy density may be indicative of an amount, concentration, and/or density of one or more components (e.g., one or more particles) within one or more points, lines, or areas within the film of the mixture.

The sensor may be operatively coupled to a source of energy for sensing, wherein at least a portion of energy for sensing is measured by the sensor as a feedback indicative of the 3D printing process. Such energy for sensing may be electromagnetic radiation (e.g., from ambient light or from an electromagnetic radiation source) and/or electrons (e.g., from an electron beam). In an example, the sensor may be an IR sensor (e.g., an IR camera), and the source of energy may be an IR light source. In such a case, the IR sensor may detect at least a portion of the IR light from the IR optical source that is being reflected by or transmitted from (i) the film of the mixture adjacent to the print surface, or (ii) any excess mixture remaining on the print surface. The IR light being reflected by or transmitted from the film of the mixture or any excess mixture may be zero-dimensional (a point), 1D (a line), or 2D (a plane).

A single sensor may be operatively coupled to a single source of energy for sensing. A single sensor may be operatively coupled to at least about 1, at least about 2, at least about 3, at least about 4, at least about 5, at least about 6, at least about 7, at least about 8, at least about 9, at least about 10, or more sources of energy for sensing that are the same or different. A single sensor may be operatively coupled to at most about 10, at most about 9, at most about 8, at most about 7, at most about 6, at most about 5, at most about 4, at most about 3, or at most about 2 sources of energy for sensing that are the same or different. A single source of energy for sensing may be operatively coupled to at least about 1, at least about 2, at least about 3, at least about 4, at least about 5, at least about 6, at least about 7, at least about 8, at least about 9, at least about 10, or more sensors that are the same or different. A single source of energy for sensing may be operatively coupled to at most about 10, at most about 9, at most about 8, at most about 7, at most about 6, at most about 5, at most about 4, at most about 3, or at most about 2 sensors that are the same or different.

One or more sensors and one or more sources of energy for sensing may be part of a same system (e.g., a single enclosed unit) or different systems. The one or more sensors may be disposed below, within, on, and/or over the build surface. The one or more sensors and the one or more sources of energy for sensing may be on a same side or opposite sides of a component of the 3D printing system (e.g., the print window or film comprising the print surface, the film of the mixture adjacent to the print surface, etc.). In some examples, the one or more sensors and the one or more sources of energy may be in contact with the print surface, the film of the mixture adjacent to the print surface, and/or any excess mixture remaining on the print surface subsequent to printing a layer of the 3D object. In some examples, the one or more sensors and the one or more sources of energy may not be in contact with the print surface, the film of the mixture adjacent to the print surface, and/or any excess mixture remaining on the print surface subsequent to printing a layer of the 3D object.

The sensor may not be in contact with the film of the mixture while generating the feedback. The sensor may be in contact with the film of the mixture while generating the feedback.

The sensor and/or the source of energy for sensing may be stationary with respect to the print surface (e.g., the print window or the film disposed on or adjacent to the platform). The sensor and/or the source of energy for sensing may be movable with respect to the print surface. Such movement may be a relative movement, and thus the moving piece may be the sensor, the source of energy for sensing, and/or the print surface.

The one or more sensors may be operatively coupled to a controller (e.g., a computer) capable of employing artificial intelligence (e.g., one or more machine learning algorithms) to analyze a database comprising a plurality of feedbacks indicative of various components of the 3D printing system, such as the film of the mixture on the print surface or of any excess mixture remaining on the print surface after printing a portion of the 3D object. One or more machine learning algorithms of the artificial intelligence may be capable of distinguishing or differentiating profiles (e.g., features) of a film of the mixture on or adjacent to the print surface based on the database. Such features may comprise the film quality, film thickness, density of one or more components (e.g., one or more particles, etc.) in the film of the mixture, or one or more defects (e.g., bubbles, wrinkles, pre-polymerized particulates, etc.).

The database may further comprise a plurality of training data sets that comprise example feedback indicative of the features of the film of the mixture. The plurality of training data sets may allow the machine learning algorithm(s) to learn a plurality of parameters to generate one or more models (e.g., mathematical models, classifiers) that can be used to distinguish or differentiate the features of a new film of the mixture received from the one or more sensors during the 3D printing. In an example, the feedback from a sensor may be an optical (e.g., IR) densitometry profile of the film of the mixture. In such a case, the trained machine learning algorithm may be used to distinguish (i) a variation in optical density due to a height defect across the film of the mixture, (ii) a variation in optical density due to voids (e.g., bubbles, streaks, etc.) in the film of the mixture, and (iii) a variation in optical density due to a difference in the density of one or more particles (e.g., metal or ceramic particles) in the film of the mixture.

A series of machine learning algorithms may be connected as an artificial neural network to better recognize, categorize, and/or classify each feature of the film of the mixture or each feature of any excess mixture remaining on the print surface from the feedback of the one or more sensors. An artificial intelligence system capable of acquiring, processing, and analyzing image and/or video feedbacks from the one or more sensors, and such system may be referred to as computer vision.

The one or more machine learning algorithms may use deep learning algorithms. The deep learning algorithms may be capable of generating new classifications (e.g., categories, sub-categories, etc.) of one or more features of the mixture or the film of the mixture, based on a new feedback and a database comprising a plurality of previous feedbacks and example feedbacks. The deep learning algorithms may use the new classifications to distinguish or differentiate the features of the mixture or the film of the mixture.

The diffuser may be disposed between the one or more sources of energy (e.g., one or more electromagnetic radiations) for sensing and the corresponding sensor(s). In an example, the diffuser may diffuse the one or more electromagnetic radiations (e.g., one or more IR lights) and direct the scattered electromagnetic radiations towards a build surface (e.g., a print window), to the film of the mixture, and to the corresponding sensor(s) (e.g., one or more IR sensors). The scattered electromagnetic radiations may be directed to the film of the mixture without passing through the build surface. In another example, the diffuser may be adjacent to the one or more sensor(s).

The diffuser may be transparent, semi-transparent, semi-opaque, or opaque. The diffuser may be ceramic, polymeric (e.g., polycarbonate, polytetrafluoroethylene (PTFE), etc.), or a combination thereof. Examples of the diffuser comprise a holographic diffuser, a white diffusing glass, and a ground glass diffuser. Other examples of the diffuser include paper or fabric.

One or more surfaces of the diffuser may comprise a matte finish on its surface to further assist in scattering the one or more electromagnetic radiations. The diffuser may not be a mirror. During the 3D printing process, at least about 1, at least about 2, at least about 3, at least about 4, at least about 5, or more diffusers may be used. During the 3D printing process, at most about 5, at most about 4, at most about 3, at most about 2, or 1 diffuser may be used.

The mixture may be used for printing the at least the portion of the 3D object. The mixture may comprise a photoactive resin to form a polymeric material. The photoactive resin may comprise a polymeric precursor of the polymeric material. The photoactive resin may comprise at least one photoinitiator that is configured to initiate formation of the polymeric material from the polymeric precursor. The photoactive resin may comprise at least one photoinhibitor that is configured to inhibit formation of the polymeric material from the polymeric precursor. The mixture may comprise a plurality of particles for forming the at least the portion of the 3D object.

The mixture may be the photoactive resin. The viscosity of the photoactive resin may range between about 1 cP to about 2,000,000 cP. The viscosity of the photoactive resin may be at least about 1 cP, 5 cP, 10 cP, 50 cP, 100 cP, 500 cP, 1000 cP, 5,000 cP, 10,000 cP, 50,000 cP, 100,000 cP, 500,000 cP, 1,000,000 cP, 2,000,000 cP, or more. The viscosity of the photoactive resin may be at most about 2,000,000 cP, 1,000,000 cP, 500,000 cP, 100,000 cP, 50,000 cP, 10,000 cP, 5,000 cP, 1,000 cP, 500 cP, 100 cP, 50 cP, 10 cP, 5 cP, 1 cP, or less.

The mixture may be a non-Newtonian fluid. The viscosity of the mixture may vary based on a shear rate or shear history of the mixture. As an alternative, the mixture may be a Newtonian fluid.

The mixture may comprise the photoactive resin and the plurality of particles. The viscosity of the mixture may range between about 4,000 cP to about 2,000,000 cP. The viscosity of the mixture may be at least about 4,000 cP, 10,000 cP, 20,000 cP, 30,000 cP, 40,000 cP, 50,000 cP, 60,000 cP, 70,000 cP, 80,000 cP, 90,000 cP, 100,000 cP, 200,000 cP, 300,000 cP, 400,000 cP, 500,000 cP, 600,000 cP, 700,000 cP, 800,000 cP, 900,000 cP, 1,000,000 cP, 2,000,000 cP, or more. The viscosity of the mixture may be at most about 2,000,000 cP, 1,000,000 cP, 900,000 cP, 800,000 cP, 700,000 cP, 600,000 cP, 500,000 cP, 400,000 cP, 300,000 cP, 200,000 cP, 100,000 cP, 90,000 cP, 80,000 cP, 70,000 cP, 60,000 cP, 50,000 cP, 40,000 cP, 30,000 cP, 20,000 cP, 10,000 cP, 4,000 cP, or less.

In the mixture comprising the photoactive resin and the plurality of particles, the photoactive resin may be present in an amount ranging between about 5 volume % (vol %) to about 80 vol % in the mixture. The photoactive resin may be present in an amount of at least about 5 vol %, at least about 6 vol %, at least about 7 vol %, at least about 8 vol %, at least about 9 vol %, at least about 10 vol %, at least about 11 vol %, at least about 12 vol %, at least about 13 vol %, at least about 14 vol %, at least about 15 vol %, at least about 16 vol %, at least about 17 vol %, at least about 18 vol %, at least about 19 vol %, at least about 20 vol %, at least about 21 vol %, at least about 22 vol %, at least about 23 vol %, at least about 24 vol %, at least about 25 vol %, at least about 30 vol %, at least about 35 vol %, at least about 40 vol %, at least about 45 vol %, at least about 50 vol %, at least about 55 vol %, at least about 60 vol %, at least about 65 vol %, at least about 70 vol %, at least about 75 vol %, at least about 80 vol %, or more in the mixture. The photoactive resin may be present in an amount of at most about 80 vol %, at most about 75 vol %, at most about 70 vol %, at most about 65 vol %, at most about 60 vol %, at most about 55 vol %, at most about 50 vol %, at most about 45 vol %, at most about 40 vol %, at most about 35 vol %, at most about 30 vol %, at most about 25 vol %, at most about 24 vol %, at most about 23 vol %, at most about 22 vol %, at most about 21 vol %, at most about 20 vol %, at most about 19 vol %, at most about 18 vol %, at most about 17 vol %, at most about 16 vol %, at most about 15 vol %, at most about 14 vol %, at most about 13 vol %, at most about 12 vol %, at most about 11 vol %, at most about 10 vol %, at most about 9 vol %, at most about 8 vol %, at most about 7 vol %, at most about 6 vol %, at most about 5 vol %, or less in the mixture.

The polymeric precursor in the photoactive resin may comprise monomers to be polymerized into the polymeric material, oligomers to be cross-linked into the polymeric material, or both. The monomers may be of the same or different types. An oligomer may comprise two or more monomers that are covalently linked to each other. The oligomer may be of any length, such as at least 2 (dimer), 3 (trimer), 4 (tetramer), 5 (pentamer), 6 (hexamer), at least 7, at least 8, at least 9, at least 10, at least 20, at least 30, at least 40, at least 50, at least 100, at least 200, at least 300, at least 400, at least 500, or more monomers. Alternatively or in addition to, the polymeric precursor may include a dendritic precursor (monodisperse or polydisperse). The dendritic precursor may be a first generation (G1), second generation (G2), third generation (G3), fourth generation (G4), or higher with functional groups remaining on the surface of the dendritic precursor. The resulting polymeric material may comprise a monopolymer and/or a copolymer. The copolymer may be a linear copolymer or a branched copolymer. The copolymer may be an alternating copolymer, periodic copolymer, statistical copolymer, random copolymer, and/or block copolymer.

Examples of monomers include one or more of hydroxyethyl methacrylate; n-Lauryl acrylate; tetrahydrofurfuryl methacrylate; 2, 2, 2-trifluoroethyl methacrylate; isobornyl methacrylate; polypropylene glycol monomethacrylates, aliphatic urethane acrylate (i.e., Rahn Genomer 1122); hydroxyethyl acrylate; n-Lauryl methacrylate; tetrahydrofurfuryl acrylate; 2, 2, 2-trifluoroethyl acrylate; isobornyl acrylate; polypropylene glycol monoacrylates; trimethylpropane triacrylate; trimethylpropane trimethacrylate; pentaerythritol tetraacrylate; pentaerythritol tetraacrylate; triethyleneglycol diacrylate; triethylene glycol dimethacrylate; tetrathyleneglycol diacrylate; tetrathylene glycol dimethacrylate; neopentyldimethacrylate; neopentylacrylate; hexane dioldimethacylate; hexane diol diacrylate; polyethylene glycol 400 dimethacrylate; polyethylene glycol 400 diacrylate; diethylglycol diacrylate; diethylene glycol dimethacrylate; ethyleneglycol diacrylate; ethylene glycol dimethacrylate; ethoxylated bis phenol A dimethacrylate; ethoxylated bis phenol A diacrylate; bisphenol A glycidyl methacrylate; bisphenol A glycidyl acrylate; ditrimethylolpropane tetraacrylate; and ditrimethylolpropane tetraacrylate.

Polymeric precursors may be present in an amount ranging between about 3 weight % (wt %) to about 90 wt % in the photoactive resin of the mixture. The polymeric precursors may be present in an amount of at least about 3 wt %, 4 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or more in the photoactive resin of the mixture. The polymeric precursors may be present in an amount of at most about 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, 15 wt %, 10 wt %, 5 wt %, 4 wt %, 3 wt %, or less in the photoactive resin of the mixture.

Photopolymerization of the polymeric precursors into the polymeric material may be controlled by one or more photoactive species, such as the at least one photoinitiator and the at least one photoinhibitor. The at least one photoinitiator may be a photon-absorbing compound that (i) is activated by a first light comprising a first wavelength and (ii) initiates photopolymerization of the polymeric precursors. The at least one photoinhibitor may be another photon-absorbing compound that (i) is activated by a second light comprising a second wavelength and (ii) inhibits the photopolymerization of the polymeric precursors. The first wavelength and the second wavelength may be different. The first light and the second light may be directed by the same optical source. As an alternative, the first light may be directed by a first optical source and the second light may be directed by a second optical source. In some examples, the first light may comprise wavelengths ranging between about 420 nm to about 510 nm. In some examples, the second light may comprise wavelengths ranging between about 350 nm to about 410 nm. In an example, the first wavelength to induce photoinitiation is about 460 nm. In an example, the second wavelength to induce photoinhibition is about 365 nm.

Relative rates of the photoinitiation by the at least one photoinitiator and the photoinhibition by the at least one photoinhibitor may be controlled by adjusting the intensity and/or duration of the first light, the second light, or both. By controlling the relative rates of the photoinitiation and the photoinhibition, an overall rate and/or amount (degree) of polymerization of the polymeric precursors into the polymeric material may be controlled. Such process may be used to (i) prevent polymerization of the polymeric precursors at the print surface-mixture interface, (ii) control the rate at which polymerization takes place in the direction away from the print surface, and/or (iii) control a thickness of the polymeric material within the film of the mixture.

Examples of types of the at least one photoinitiator include one or more of benzophenones, thioxanthones, anthraquinones, benzoylformate esters, hydroxyacetophenones, alkylaminoacetophenones, benzil ketals, dialkoxyacetophenones, benzoin ethers, phosphine oxides acyloximino esters, alphahaloacetophenones, trichloromethyl-S-triazines, titanocenes, dibenzylidene ketones, ketocoumarins, dye sensitized photoinitiation systems, maleimides, and mixtures thereof.

Examples of the at least one photoinitiator in the photoactive resin include one or more of 1-hydroxy-cyclohexyl-phenyl-ketone (Irgacure™ 184; BASF, Hawthorne, NJ); a 1:1 mixture of 1-hydroxy-cyclohexyl-phenyl-ketone and benzophenone (Irgacure™ 500; BASF); 2-hydroxy-2-methyl-1-phenyl-1-propanone (Darocur™ 1173; BASF); 2-hydroxy-1-[4-(2-hydroxyethoxy)phenyl]-2-methyl-1-propanone (Irgacure™ 2959; BASF); methyl benzoylformate (Darocur™ MBF; BASF); oxy-phenyl-acetic acid 2-[2-oxo-2-phenyl-acetoxy-ethoxy]-ethyl ester; oxy-phenyl-acetic 2-[2-hydroxy-ethoxy]-ethyl ester; a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester (Irgacure™ 754; BASF); alpha, alpha-dimethoxy-alpha-phenylacetophenone (Irgacure™ 651; BASF); 2-benzyl-2-(dimethylamino)-1-[4-(4-morpholinyl)-phenyl]-1-butanone (Irgacure™ 369; BASF); 2-methyl-1-[4-(methylthio)phenyl]-2-(4-morpholiny1)-1-propanone (Irgacure™ 907; BASF); a 3:7 mixture of 2-benzyl-2-(dimethylamino)-1-[4-(4-morpholinyl) phenyl]-1-butanone and alpha, alpha-dimethoxy-alpha-phenylacetophenone per weight (Irgacure™ 1300; BASF); diphenyl-(2,4,6-trimethylbenzoyl) phosphine oxide (Darocur™ TPO; BASF); a 1:1 mixture of diphenyl-(2,4,6-trimethylbenzoyl)-phosphine oxide and 2-hydroxy-2-methyl-1-phenyl-1-propanone (Darocur™ 4265; BASF); phenyl bis(2,4,6-trimethyl benzoyl) phosphine oxide, which can be used in pure form (Irgacure™ 819; BASF, Hawthorne, NJ) or dispersed in water (45% active, Irgacure™ 819DW; BASF); 2:8 mixture of phosphine oxide, phenyl bis(2,4,6-trimethyl benzoyl) and 2-hydroxy-2-methyl-1-phenyl-1-propanone (Irgacure™ 2022; BASF); Irgacure™ 2100, which comprises phenyl-bis(2,4,6-trimethylbenzoyl)-phosphine oxide); bis-(eta 5-2,4-cyclopentadien-1-yl)-bis-[2,6-difluoro-3-(1H-pyrrol-1-yl) phenyl]-titanium (Irgacure™ 784; BASF); (4-methylpheny1) [4-(2-methylpropyl) phenyl]-iodonium hexafluorophosphate (Irgacure™ 250; BASF); 2-(4-methylbenzyl)-2-(dimethylamino)-1-(4-morpholinophenyl)-butan-1-one (Irgacure™ 379; BASF); 4-(2-hydroxyethoxy)phenyl-(2-hydroxy-2-propyl)ketone (Irgacure™ 2959; BASF); bis-(2,6-dimethoxybenzoyl)-2,4,4-trimethylpentylphosphine oxide; a mixture of bis-(2,6-dimethoxybenzoyl)-2,4,4-trimethylpentylphosphine oxide and 2 hydroxy-2-methyl-1-phenyl-propanone (Irgacure™ 1700; BASF); 4-Isopropyl-9-thioxanthenone; and mixtures thereof.

The at least one photoinitiator may be present in an amount ranging between about 0.1 wt % to about 10 wt % in the photoactive resin. The at least one photoinitiator may be present in an amount of at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more in the photoactive resin. The at least one photoinitiator may be present in an amount of at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %, at most about 0.9 wt %, at most about 0.8 wt %, at most about 0.7 wt %, at most about 0.6 wt %, at most about 0.5 wt %, at most about 0.4 wt %, at most about 0.3 wt %, at most about 0.2 wt %, at most about 0.1 wt %, or less in the photoactive resin.

The at least one photoinhibitor in the photoactive resin may comprise one or more radicals that may preferentially terminate growing polymer radicals, rather than initiating polymerization of the polymeric precursors. Examples of types of the at least one photoinitiator include: one or more of sulfanylthiocarbonyl and other radicals generated in photoiniferter polymerizations; sulfanylthiocarbonyl radicals used in reversible addition-fragmentation chain transfer polymerization; and nitrosyl radicals used in nitroxide mediate polymerization. Other non-radical species that can be generated to terminate growing radical chains may include the numerous metal/ligand complexes used as deactivators in atom-transfer radical polymerization (ATRP). Thus, additional examples of the types of the at least one photoinhibitor include: one or more of thiocarbamates, xanthates, dithiobenzoates, hexaarylbiimidazoles, photoinitiators that generate ketyl and other radicals that tend to terminate growing polymer chains radicals (i.e., camphorquinone (CQ) and benzophenones), ATRP deactivators, and polymeric versions thereof.

Examples of the at least one photoinhibitors in the photoactive resin include one or more of zinc dimethyl dithiocarbamate; zinc diethyl dithiocarbamate; zinc dibutyl dithiocarbamate; nickel dibutyl dithiocarbamate; zinc dibenzyl dithiocarbamate; tetramethylthiuram disulfide; tetraethylthiuram disulfide (TEDS); tetramethylthiuram monosulfide; tetrabenzylthiuram disulfide; tetraisobutylthiuram disulfide; dipentamethylene thiuram hexasulfide; N, N′-dimethyl N, N′-di(4-pyridinyl)thiuram disulfide; 3-Butenyl 2-(dodecylthiocarbonothioylthio)-2-methylpropionate; 4-Cyano-4-[(dodecylsulfanylthiocarbonyl)sulfanyl]pentanoic acid; 4-Cyano-4-[(dodecylsulfanylthiocarbonyl)sulfanyl]pentanol; Cyanomethyl dodecyl trithiocarbonate; Cyanomethyl [3-(trimethoxysilyl)propyl] trithiocarbonate; 2-Cyano-2-propyl dodecyl trithiocarbonate; S, S-Dibenzyl trithiocarbonate; 2-(Dodecylthiocarbonothioylthio)-2-methylpropionic acid; 2-(Dodecylthiocarbonothioylthio)-2-methylpropionic acid N-hydroxysuccinimide; Benzyl 1H-pyrrole-1-carbodithioate; Cyanomethyl diphenylcarbamodithioate; Cyanomethyl methyl(phenyl)carbamodithioate; Cyanomethyl methyl(4-pyridyl)carbamodithioate; 2-Cyanopropan-2-yl N-methyl-N-(pyridin- 4-yl)carbamodithioate; Methyl 2-[methyl(4-pyridinyl)carbamothioylthio]propionate; 1-Succinimidyl -4-cyano-4-[N-methyl-N-(4-pyridyl)carbamothioylthio]pentanoate; Benzyl benzodithioate; Cyanomethyl benzodithioate; 4-Cyano-4-(phenylcarbonothioylthio)pentanoic acid; 4-Cyano-4-(phenylcarbonothioylthio)pentanoic acid N-succinimidyl ester; 2-Cyano-2-propyl benzodithioate; 2-Cyano-2-propyl 4-cyanobenzodithioate; Ethyl 2-(4-methoxyphenylcarbonothioylthio)acetate; 2-Phenyl-2-propyl benzodithioate; Cyanomethyl methyl(4-pyridyl)carbamodithioate; 2-Cyanopropan-2-yl N-methyl-N-(pyridin-4-yl)carbamodithioate; 2,2′-Bis(2-chlorophenyl)-4,4′,5,5′-tetraphenyl-1,2′-biimidazole; 2-(2-ethoxyphenyl)-1-[2-(2-ethoxyphenyl)-4,5-diphenyl-2H-imidazol-2-yl]-4,5-diphenyl-1H-imidazole; 2,2′,4-tris-(2-Chlorophenyl)-5-(3,4-dimethoxyphenyl)-4′,5′-diphenyl-1,1′-biimidazole; and Methyl 2-[methyl(4-pyridinyl)carbamothioylthio]propionate.

In some examples, the photoinhibitor may comprise a hexaarylbiimidazole (HABI) or a functional variant thereof. The hexaarylbiimidazole may comprise a phenyl group with a halogen and/or an alkoxy substitution. In an example, the phenyl group comprises an ortho-chloro-substitution. In another example, the phenyl group comprises an ortho-methoxy-substitution. In another example, the phenyl group comprises an ortho-ethoxy-substitution. Examples of the functional variants of the hexaarylbiimidazole include: 2,2′-Bis(2-chlorophenyl)-4,4′,5,5′-tetraphenyl-1,2′-biimidazole; 2-(2-methoxyphenyl)-1-[2-(2-methoxyphenyl)-4,5-diphenyl-2H-imidazol-2-yl]-4,5-diphenyl-1H-imidazole; 2-(2-ethoxyphenyl)-1-[2-(2-ethoxyphenyl)-4,5-diphenyl-2H-imidazol-2-yl]-4,5-diphenyl-1H-imidazole; and 2,2′,4-tris-(2-Chlorophenyl)-5-(3,4-dimethoxyphenyl)-4′,5′-diphenyl-1,1′-biimidazole.

The at least one photoinhibitor may be present in an amount ranging between about 0.1 wt % to about 10 wt % in the photoactive resin. The at least one photoinhibitor may be present in an amount of at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more in the photoactive resin. The at least one photoinhibitor may be present in an amount of at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %, at most about 0.9 wt %, at most about 0.8 wt %, at most about 0.7 wt %, at most about 0.6 wt %, at most about 0.5 wt %, at most about 0.4 wt %, at most about 0.3 wt %, at most about 0.2 wt %, at most about 0.1 wt %, or less in the photoactive resin.

Alternatively or in addition to, the photoactive resin may include a co-initiator. The co-initiator may be used to enhance the polymerization rate of the polymeric precursors. Suitable classes of the co-initiators may include: primary, secondary, and tertiary amines; alcohols; and thiols. Examples of the co-initiators may include: one or more of isoamyl 4-(dimethylamino)benzoate, 2-ethylhexyl 4-(dimethylamino)benzoate; ethyl 4-(dimethylamino)benzoate (EDMAB); 3-(dimethylamino)propyl acrylate; 2-(dimethylamino)ethyl methacrylate; 4-(dimethylamino)benzophenones, 4-(diethylamino)benzophenones; 4,4′-Bis(diethylamino)benzophenones; methyl diethanolamine; triethylamine; hexane thiol; heptane thiol; octane thiol; nonane thiol; decane thiol; undecane thiol; dodecane thiol; isooctyl 3-mercaptopropionate; pentaerythritol tetrakis(3-mercaptopropionate); 4,4′-thiobisbenzenethiol; trimethylolpropane tris(3-mercaptopropionate); CN374 (Sartomer); CN371 (Sartomer), CN373 (Sartomer), Genomer 5142 (Rahn); Genomer 5161 (Rahn); Genomer(5271 (Rahn); Genomer 5275 (Rahn), and TEMPIC (Bruno Boc, Germany).

The at least one photoinitiator and the co-initiator may be activated by the same light. The at least one photoinitiator and the co-initiator may be activated by the same wavelength and/or two different wavelengths of the same light. Alternatively or in addition to, the at last one photoinitiator and the co-initiator may be activated by different lights comprising different wavelengths. The system may comprise a co-initiator optical source configured to direct a co-initiation light comprising a wavelength sufficient to activate the co-initiator to the film of the mixture.

The co-initiator may be a small molecule (e.g., a monomer). Alternatively or in addition to, the co-initiator may be an oligomer or polymer comprising a plurality of small molecules. The co-initiator may be present in an amount ranging between about 0.1 wt % to about 10 wt % in the photoactive resin. The co-initiator may be present in an amount of at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more in the photoactive resin. The co-initiator may be present in an amount of at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %, at most about 0.9 wt %, at most about 0.8 wt %, at most about 0.7 wt %, at most about 0.6 wt %, at most about 0.5 wt %, at most about 0.4 wt %, at most about 0.3 wt %, at most about 0.2 wt %, at most about 0.1 wt %, or less in the photoactive resin.

The photoactive resin may comprise one or more dyes. The one or more dyes may be used to attenuate light, to transfer energy to the photoactive species, or both. The one or more dyes may transfer energy to the photoactive species to increase sensitivity of the photoactive resin to the first light for the photoinitiation process, the second light for the photoinhibition process, or both. In an example, the photoactive resin comprises at least one dye configured to absorb the second light having the second wavelength, which second wavelength is for activating the at least one photoinhibitor. Exposing the photoactive resin to the second light may initiate the at least one dye to absorb the second light and (i) reduce an amount of the second light exposed to the at least one photoinhibitor, thereby controlling the depth of penetration of the second light into the film of the mixture, and/or (ii) transfer (e.g., via Förster resonance energy transfer (FRET)) some of the absorbed energy from the second light to the at least one photoinhibitor, thereby improving the efficiency of photoinhibition. Examples of the one or more dyes may include compounds commonly used as ultraviolet (UV) light absorbers, including 2-hydroxyphenyl-benzophenones, 2-(2-hydroxyphenyl)-benzotriazoles, and 2-hydroxyphenyl-s-triazines. Alternatively or in addition to, the one or more dyes may include those used for histological staining or dying of fabrics, including Martius yellow, Quinoline yellow, Sudan red, Sudan I, Sudan IV, eosin, eosin Y, neutral red, and acid red.

A concentration of the one or more dyes in the photoactive resin may be dependent on the light absorption properties of the one or more dyes. The one or more dyes may be present in an amount ranging between about 0.1 wt % to about 10 wt % in the photoactive resin. The one or more dyes may be present in an amount of at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more in the photoactive resin. The one or more dyes may be present in an amount of at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, at most about 1 wt %, at most about 0.9 wt %, at most about 0.8 wt %, at most about 0.7 wt %, at most about 0.6 wt %, at most about 0.5 wt %, at most about 0.4 wt %, at most about 0.3 wt %, at most about 0.2 wt %, at most about 0.1 wt %, or less in the photoactive resin.

The mixture may comprise the plurality of particles for forming the at least the portion of the 3D object. The amount of the plurality of particles in the mixture may be sufficient to minimize shrinking of the green body during sintering. The plurality of particles may comprise any particulate material (a particle) that can be melted or sintered (e.g., not completely melted). The particulate material may be in powder form. The particular material may be inorganic materials. The inorganic materials may be metallic, intermetallic, ceramic materials, or any combination thereof. The one or more particles may comprise at least one metallic material, at least one intermetallic material, at least one ceramic material, at least one polymeric material, or any combination thereof.

Whereas powdered metals alone may be a severe safety hazard and may explode and/or require extensive safety infrastructures, using powdered metals that are dispersed in the mixture may avoid or substantially reduce the risks relevant to using the powdered metals that are not dispersed in a liquid medium. Additionally, photopolymer-based 3D printing using the mixture comprising the photoactive resin and the powdered metals may be performed without using heat, thereby avoiding or substantially reducing thermal distortion to the at least the portion of the 3D object during printing.

The metallic materials for the particles may include one or more of aluminum, calcium, magnesium, barium, scandium, titanium, vanadium, chromium, manganese, iron, cobalt, nickel, copper, zinc, yttrium, niobium, molybdenum, ruthenium, rhodium, silver, cadmium, actinium, and gold. The particles may comprise a rare earth element. The rare earth element may include one or more of scandium, yttrium, and elements of the lanthanide series having atomic numbers from 57-71.

An intermetallic material may be a solid-state compound exhibiting metallic bonding, defined stoichiometry and ordered crystal structure (i.e., alloys). The intermetallic materials may be in prealloyed powder form. Examples of such prealloyed powders may include, but are not limited to, brass (copper and zinc), bronze (copper and tin), duralumin (aluminum, copper, manganese, and/or magnesium), gold alloys (gold and copper), rose-gold alloys (gold, copper, and zinc), nichrome (nickel and chromium), and stainless steel (iron, carbon, and additional elements including manganese, nickel, chromium, molybdenum, boron, titanium, silicon, vanadium, tungsten, cobalt, and/or niobium). The prealloyed powders may include superalloys. The superalloys may be based on elements including iron, nickel, cobalt, chromium, tungsten, molybdenum, tantalum, niobium, titanium, and/or aluminum.

The ceramic materials may comprise metal (e.g., aluminum, titanium, etc.), non-metal (e.g., oxygen, nitrogen, etc.), and/or metalloid (e.g., germanium, silicon, etc.) atoms primarily held in ionic and covalent bonds. Examples of the ceramic materials include, but are not limited to, an aluminide, boride, beryllia, carbide, chromium oxide, hydroxide, sulfide, nitride, mullite, kyanite, ferrite, titania zirconia, yttria, and magnesia.

The mixture may comprise a pre-ceramic material. The pre-ceramic material may be a polymer that can be heated (or pyrolyzed) to form a ceramic material. The pre-ceramic material may include polyorganozirconates, polyorganoaluminates, polysiloxanes, polysilanes, polysilazanes, polycarbosilanes, polyborosilanes, etc. Additional examples of the pre-ceramic material include zirconium tetramethacrylate, zirconyl dimethacrylate, or zirconium 2-ethylhexanoate; aluminum III s-butoxide, aluminum III diisopropoxide-ethylacetoacetate; 1,3-bis(chloromethyl) 1,1,3,3-Tetrakis(trimethylsiloxy)disiloxane; 1,3-bis(3-carboxypropyl)tetramethyldisiloxane; 1,3,5,7-tetraethyl-2,4,6,8-tetramethylcyclotetrasilazane; tris(trimethylsilyl)phosphate; tris(trimethylsiloxy)boron; and mixtures thereof.

A cross-sectional dimension of the plurality of particles may range between about 1 nanometer (nm) to about 500 μm. The cross-sectional dimension of the plurality of particles may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μ, 10 μm, 20 μm, 30 μm, 40 μm, 50 μm, 60 μm, 70 μm, 80 μm, 90 μm, 100 μm, 200 μm, 300 μm, 400 μm, 500 μm, or greater. The cross-sectional dimension of the plurality of particles may be at most about 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or smaller.

The plurality of particles (e.g., metallic, intermetallic, and/or ceramic particles) may be present in an amount ranging between about 5 vol % to about 90 vol % in the mixture. The plurality of particles may be present in an amount of at least about 5 vol %, 10 vol %, 15 vol %, 20 vol %, 25 vol %, 30 vol %, 35 vol %, 40 vol %, 45 vol %, 50 vol %, 55 vol %, 60 vol %, 65 vol %, 70 vol %, 75 vol %, 80 vol %, 85 vol %, 90 vol %, or more in the mixture. The plurality of particles may be present in an amount of at most about 90 vol %, 85 vol %, 80 vol %, 75 vol %, 70 vol %, 65 vol %, 60 vol %, 55 vol %, 50 vol %, 45 vol %, 40 vol %, 35 vol %, 30 vol %, 25 vol %, 20 vol %, 15 vol %, 10 vol %, 5 vol %, or less in the mixture.

The mixture may comprise an anti-settling component to prevent settling of the plurality of particles and keep them suspend in the mixture. The anti-settling component may sterically limit the plurality of particles from moving closer to each other. The anti-settling component may not scatter light (e.g., the first light and/or the second light) to avoid negatively affecting the penetration depth of the light into the mixture. The anti-settling component may be present in an amount ranging between about 5 vol % to about 90 vol % in the mixture. The anti-settling component may be present in an amount of at least about 5 vol %, 10 vol %, 15 vol %, 20 vol %, 25 vol %, 30 vol %, 35 vol %, 40 vol %, 45 vol %, 50 vol %, 55 vol %, 60 vol %, 65 vol %, 70 vol %, 75 vol %, 80 vol %, 85 vol %, 90 vol %, or more in the mixture. The anti-settling component may be present in an amount of at most about 90 vol %, 85 vol %, 80 vol %, 75 vol %, 70 vol %, 65 vol %, 60 vol %, 55 vol %, 50 vol %, 45 vol %, 40 vol %, 35 vol %, 30 vol %, 25 vol %, 20 vol %, or less in the mixture.

Examples of the anti-settling component include, but are not limited to, one or more additional particles and a thixotropic additive. The one or more additional particles may be configured to prevent settling of the plurality of particles in the mixture. The one or more additional particles may decrease free space and increase the overall packing density within the mixture, thereby preventing the plurality of particles from settling towards the window during printing. Examples of the one or more additional particles include micronized and/or dispersed waxes such as paraffin, carnuba, montan, Fischer tropsch wax, ethylene bis stearamide, and lignin; micronized polymers such as cellulose, high density polyethylene, polyethylene, polypropylene, oxidized polyethylene (PE), paraformaldehyde, polyethylene glycol, phenolics, and melamine-formaldehyde based materials; and microspheres made from crosslinked polystyrene, polymethyl methacrylate, and/or other copolymers. An example of the one or more additional particles is Byk Ceraflour 929 (micronized, modified polyethylene wax).

The thixotropic additive may be a gel-like or static material that becomes fluid-like when physically disturbed. Such property may be reversible. In the mixture, the thixotropic additive may be configured to create a network to prevent settling of the plurality of particles. The network of the thixotropic additive may be easily disturbed by shearing (e.g., dispensing through the nozzle) the mixture to allow flow. Upon being dispensed through the nozzle, the thixotropic additive may form another network within the mixture to prevent settling of the plurality of particles during printing. Examples of the thixotropic additive include castor wax, oxidized polyethylene wax, amide wax, modified ureas, castor oil derivatives, fumed silica and alumina, Bentonite clays, and mixtures thereof.

The anti-settling component of the mixture may be the one or more additional particles, the thixotropic additive, or both.

The mixture may comprise at least one additional additive that is configured to prevent foaming (or induce deaeration) of the mixture. Preventing foaming of the mixture may improve quality of the resulting 3D object. The at least one additional additive may be an amphiphilic material. The at least one additional additive may be a low surface energy material to allow association with each other within the mixture. Such association of the at least one additional additive may trap air bubbles present inside the mixture, migrate towards the mixture-air interface, and release the air bubbles. During curing of the photoactive resin, the at least one additional additive may polymerize and/or cross-link with the polymeric precursor. Examples of the one additional additive include silcones, modified silicones, lauryl acrylates, hydrophobic silicas, and modified ureas. An example of the one additional additive may be Evonik Tegorad 2500 (silicon acrylate).

The mixture may comprise an extractable material. The extractable material may be soluble in the polymeric precursor and/or dispersed throughout the mixture. During printing, curing of the polymeric precursor of the photoactive resin of the at least the portion of the mixture may create a first solid phase comprising the polymeric material and a second solid phase comprising the extractable material within the at least the portion of the 3D object. Such process may be a polymerization-induced phase separation (PIPS) process. At least a portion of the plurality of particles may be encapsulated by the first solid phase comprising the polymeric material. In some examples, the at least the portion of the 3D object may be a green body that can be heated to sinter at least a portion of the plurality of particles and burn off at least a portion of other components (i.e., organic components).

Prior to sintering the plurality of particles, the green body may be treated (e.g., immersed, jetted, etc.) with a solvent (liquid or vapor) to generate a brown body. The solvent may be an extraction solvent. The extractable material may be soluble in the solvent. A first solubility of the extractable material in the solvent may be higher than a second solubility of the polymeric material in the solvent. The solvent may be a poor solvent for the polymeric material. Thus, treating the green body with the solvent may solubilize and extract at least a portion of the extractable material out of the green body into the solvent, and create one or more pores in the at least the portion of the 3D object. The one or more pores may be a plurality of pores. In some examples, the green body may be treated with the solvent and heat at the same time. The one or more pores may create at least one continuous porous network in the at least the portion of the 3D object. Such process may be a solvent de-binding process.

The mixture may be stored in the source of the mixture. The source of the mixture may be a cup, container, syringe, or any other repository that can hold the mixture. The source of the mixture may in fluid communication (e.g., via a passageway) with the nozzle in the deposition head. The source of the mixture may be connected to a flow unit. The flow unit may provide and control flow of the mixture from the source of the mixture towards the nozzle, thereby dispensing the mixture. Alternatively or in addition to, the flow unit may provide and control flow of the mixture in a direction away from the nozzle and towards the source of the mixture, thereby retrieving the mixture. The flow unit may use pressure mechanisms to control the speed and direction of the flow of the mixture. The flow unit may be a syringe pump, vacuum pump, an actuator (e.g., linear, pneumatic, hydraulic, etc.), a compressor, or any other suitable device to exert pressure (positive or negative) to the mixture in the source of the mixture. The controller may be operatively coupled to the flow unit the control the speed, duration, and/or direction of the flow of the mixture.

The source of the mixture may comprise a sensor (e.g., an optical sensor) to detect the volume of the mixture. The controller may be operatively coupled to the sensor to determine when the source of the mixture may be replenished with new mixture. Alternatively or in addition to, the source of the mixture may be removable. The controller may determine when the source of the mixture may be replaced with a new source of the mixture comprising with the mixture.

The deposition head may comprise the nozzle. The nozzle may be in fluid communication with the source of the mixture. The deposition head may dispense the mixture over the print surface through the nozzle as a process of depositing the film of the mixture over the print surface. The deposition head may retrieve any excess mixture from the print surface back into the source of the mixture through the nozzle. The source of the mixture may be connected to the flow unit to provide and control flow of the mixture towards or away from the nozzle of the deposition head. Alternatively or in addition to, the nozzle may comprise a nozzle flow unit that provides and controls flow of the mixture towards or away from the print surface. Examples of the nozzle flow unit include a piezoelectric actuator and an auger screw that is connected to an actuator.

The deposition head may comprise a wiper. The wiper may be movable along a direction towards and/or away from the print surface. The wiper may have a variable height relative to the print surface. The deposition head may comprise an actuator connected to the wiper to control movement of the wiper in a direction towards and away from the print surface. The actuator may be a mechanical, hydraulic, pneumatic, or electro-mechanical actuator. The controller may be operatively coupled to the actuator to control the movement of the wiper in a direction towards and away from the print surface. Alternatively or in addition to, a vertical distance between the wiper and the print surface (e.g., a distance perpendicular to the print surface) may be static. The deposition head may comprise a plurality of wipers with different configurations. In some examples, the deposition head may comprise the nozzle and three wipers.

The wiper of the deposition head may be configured to (i) reduce or inhibit flow of the mixture out of the deposition head, (ii) flatten the film of the mixture, and/or (iii) remove any excess of the mixture. In an example, the wiper may be configured to be in contact with the print surface and reduce or inhibit flow of the mixture out of the deposition head. In another example, the wiper may be movable along a direction away from the print surface and configured to flatten the film of the mixture. The wiper may flatten the film of the mixture to a defined height (or thickness). In a different example, the wiper may be movable along a direction away from the print surface and configured to remove the excess of the mixture.

The wiper may comprise polymer (e.g., rubber, silicone), metal, or ceramic. The wiper may comprise (e.g., entirely or as a coating) one or more fluoropolymers that prevent adhesion of the mixture on the wiper. Examples of the one or more fluoropolymers include polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (a copolymer of tetrafluoroethylene and perfluoromethylvinylether, also known as MFA).

The wiper of the deposition head may be a blade (e.g., a squeegee blade, a doctor blade). The blade may have various shapes. In some examples, the blade may be straight and/or curved. In some examples, the wiper may be a straight blade with a flat surface. In some examples, the wiper may be a straight blade with a curved surface. In some examples, the wiper may be a curved blade (curved along the long axis of the wiper) with a flat surface. In some examples, the wiper may be a curved blade (curved along the long axis of the wiper) with a curved surface. In some examples, the wiper may comprise at least one straight portion and at least one curved portion along its length. In an example, the wiper may be a blade comprising a straight central portion between two curved portions.

In an example, the wiper may be a straight blade and configured perpendicular to the print surface. In another example, the wiper may be a straight blade with a flat surface, and tilted at an angle. When the deposition head moves to remove any excess mixture from the print surface, the tilted straight blade may concentrate the excess resin at the bottom of the blade. The straight blade may be tilted at an angle ranging between about 1 degree to about 50 degrees. The straight blade may be tilted at an angle of at least about 1 degree, 2 degrees, 3 degrees, 4 degrees, 5 degrees, 6 degrees, 7 degrees, 8 degrees, 9 degrees, 10 degrees, 20 degrees, 30 degrees, 40 degrees, 50 degrees, or more. The straight blade may be tiled at an angle of at most about 50 degrees, 40 degrees, 30 degrees, 20 degrees, 10 degrees, 9 degrees, 8 degrees, 7 degrees, 6 degrees, 5 degrees, 4 degrees, 3 degrees, 2 degrees, 1 degree, or less.

In a different example, the wiper may be a straight blade with a curved surface (a curved blade). When the deposition head moves to remove any excess mixture from the print surface, the curved blade may concentrate the excess resin in the center of the concave surface of the wiper. The curved blade may reduce or prevent the excess resin from spilling out from the sides of the blade. A radius of curvature of the surface of the blade may range between about 10 mm to about 1000 mm. The radius of curvature of the surface of the blade may be at least about 10 mm, 20 mm, 30 mm, 40 mm, 50 mm, 60 mm, 70 mm, 80 mm, 90 mm, 100 mm, 200 mm, 300 mm, 400 mm, 500 mm, 1000 mm, or more. The radius of curvature of the surface of the blade may be at most about 1000 mm, 500 mm, 400 mm, 300 mm, 200 mm, 100 mm, 90 mm, 80 mm, 70 mm, 60 mm, 50 mm, 40 mm, 30 mm, 20 mm, 10 mm, or less.

The wiper of the deposition head may be a roller. The roller may have a surface that is flat or textured. The roller may be configured to rotate clockwise and/or counterclockwise while the deposition head moves across the print window. Alternatively or in addition to, the roller may be configured to be static while the deposition head moves across the print window. The wiper of the deposition head may be a rod. The rod may have a surface that is flat or textured. The rod may be configured to rotate clockwise and/or counterclockwise while the deposition head moves across the print window. Alternatively or in addition to, the rod may be configured to be static while the deposition head moves across the print window. In an example, the rod may be a wire wound rod, also known as a Meyer rod.

The deposition head may comprise a slot die. The slot die may be configured to move along a direction away from the print surface. The slot die may be height adjustable with respect to the print surface. The slot die may comprise a channel in fluid communication with the source of the mixture. The channel may comprise a first opening to receive the mixture from the source of the mixture. The channel may comprise a second opening opposite of the first opening to dispense the mixture to the print window. The second opening may be an injection point. The channel may have a reservoir between the first and second openings to hold a volume of the mixture. The injection point of the slot die may comprise a flat surface to flatten the film of the mixture to a defined height (or thickness).

The deposition head comprising the slot die may include a separate nozzle to suction and retrieve any excess mixture from the film of the mixture during printing. The separate nozzle of the deposition head comprising the slot die may be in fluid communication with a repository to collect the excess mixture. The repository may be a recycling bin. The repository may also be in fluid communication with the slot die to send the excess mixture collected in the repository back into the reservoir of the slot die. Alternatively or in addition to, the collected excess mixture may be removed for reprocessing. The reprocessing of the collected excess mixture may comprise (i) filtering out any polymerized solid particulates, (ii) filtering out any of the plurality of particles that may be greater than a target particle size, (iii) remixing the mixture to ensure homogeneity, and/or (iv) removing at least a portion of air entrapped in the mixture. The at least the portion of air entrapped in the mixture may be removed by centrifuging the mixture. The slot die may be part of a nozzle. Alternatively or in addition to, the slot die may be part of a wiper.

The system may further comprise an additional deposition head comprising an additional nozzle. The additional nozzle of the additional deposition head may be in fluid communication with an additional source of an additional mixture. In some examples, the nozzle of the deposition head of the system may be in fluid communication with the source of the mixture and the additional source of the additional mixture. Alternatively or in addition to, the deposition head may comprise a first nozzle in fluid communication with the source of the mixture, and (b) a second nozzle in fluid communication with the additional source of the additional mixture. The presence of the additional source of the additional mixture may allow printing at least a portion of a 3D object comprising multiple materials (multi-materials) in different layers and/or in different portions within the same layer.

The mixture and the additional mixture may be the same. As an alternative, the mixture and the additional mixture may be different. The mixture and the additional mixture may comprise different types of the photoactive resin, the plurality of particles, or both. Alternatively or in addition to, the mixture and the additional mixture may comprise different amounts (concentrations by weight or volume) of the photoactive resin, the plurality of particles, or both. In an example, the mixture may comprise metallic particles, and the additional mixture may comprise ceramic particles. A first concentration of the metallic particles in the mixture and a second concentration of the ceramic particles in the additional mixture may be the same or different. A first photoactive resin in the mixture and a second photoactive resin in the additional mixture may be the same or different. In another example, the mixture may comprise a first type of metallic particles, and the additional mixture may comprise a second type of metallic particles. In a different example, the mixture may comprise ceramic particles at a first concentration, and the additional mixture may comprise the same ceramic particles at a second concentration that is different from the first concentration.

Upon printing at least a portion of the 3D object, the deposition head may be configured to move across the print surface and remove any excess mixture from the print surface. The deposition head may be configured to collect the excess mixture. The deposition head may be configured to collect the excess mixture to a designated area of the platform. The deposition head may be configured to collect the excess mixture within the deposition head. At least a portion of the collected excess mixture may be used to deposit a subsequent layer or film of the mixture by the deposition head.

The system may comprise a cleaning zone. The cleaning zone may be configured adjacent to the platform. The cleaning zone may be configured in a path of movement of the deposition head across the platform. The cleaning zone may be configured to clean the deposition head. Cleaning the deposition head may (i) improve reliability and reproducibility of printing at least the portion of the 3D object, and (ii) reduce wear and tear of the deposition head. The deposition head may be static or move relative to the cleaning zone while the cleaning zone cleans the deposition head. The cleaning zone may comprise a wiper, a nozzle configured to provide at least one cleaning solvent, or both. The wiper of the cleaning zone may be a blade (e.g., a doctor blade), a roller, or a rod. One or more wipers of the cleaning zone may come in contact with one or more wipers of the deposition head and remove any excess resin remaining on the one or more wipers of the deposition head. The one or more nozzles of the cleaning zone may dispense or jet the at least one cleaning solvent to the one or more wipers of the deposition head for cleaning. The one or more nozzles of the cleaning zone may be in fluid communication with at least one source of the at least one cleaning solvent. At least a portion of the mixture may be soluble in the at least one cleaning solvent. The cleaning zone may comprise a repository that can hold the excess mixture that is removed from the deposition head and/or the at least one cleaning solvent.

The system may comprise a repository (e.g., vat or container) adjacent to the platform. The repository may be configured to collect the mixture removed from the platform (e.g., from the print surface). The repository may be configured to hold any excess mixture that is removed from the print surface by the deposition head. After removing any excess mixture from the print surface, the deposition head may move and use at least one wiper to collect the excess mixture into the repository. The repository may be a recycling bin. The repository may be in fluid communication with the source of the mixture to recycle the collected excess mixture for printing. Alternatively or in addition to, the collected excess mixture may be removed for reprocessing. The system may comprise a sensor for detecting or determining one or more qualities of the mixture or a layer of the mixture deposited on the print surface. The sensor may be configured to move across the print surface and/or measure a thickness of at least a portion of the film of the mixture. The sensor may assess integrity of the film of the mixture before inducing polymerization of the polymeric precursors in the photoactive resin in the film of the mixture. The sensor may detect any variation in thickness across the film of the mixture. The sensor may detect any irregularities (e.g., defects, empty spots, solid particles, etc.) in the film of the mixture. The sensor may be configured to perform quality control after printing at least a portion (e.g., a layer) of the 3D object. The sensor may scan a remaining portion of the film (i.e., “silhouette”) of the mixture after printing, and the controller that is operatively coupled to the sensor may determine if the previous printing process was successful or not. In some examples, the sensor may be an optical profilometer (e.g., an in-line profilometer), densitometer, or computer vision.

The system may comprise a motion stage adjacent to the open platform. The motion stage may be coupled to the deposition head and configured to direct movement of the deposition head across the open platform. In addition, the motion stage may be coupled to one or more other components of the system that move across the platform (e.g., an additional deposition head, a sensor, etc.). The motion stage may be connected to an actuator that is configured to direct movement of the motion stage. The actuator may be a mechanical, hydraulic, pneumatic, electro-mechanical, or magnetic actuator. The controller may be operatively coupled to the actuator to control movement of the motion stage. Alternatively or in addition to, the system may comprise an additional motion stage coupled to the open platform to direct movement of the open platform relative to other components of the system.

The system may comprise the optical source that provides the light through the print window for curing the at least the portion of the film of the mixture. The light of the optical source may comprise a first wavelength for curing the photoactive resin in a first portion of the film of the mixture. The first wavelength may activate the at least one photoinitiator of the photoactive resin, thereby initiating curing of the polymeric precursors into the polymeric material. The light may be a photoinitiation light, and the first portion of the film may be a photoinitiation layer. The optical source may provide an additional light having a second wavelength for inhibiting curing of the photoactive resin in a second portion of the film of the mixture. The first wavelength and the second wavelength may be different. The second wavelength may activate the at least one photoinhibitor of the photoactive resin, thereby inhibiting curing of the polymeric precursors into the polymeric material. The additional light may be a photoinhibition light, and the second portion of the film of the mixture may be a photoinhibition layer. In some examples, a dual-wavelength projector (e.g., a dual-wavelength laser) may be used as the optical source that provides both the photoinitiation light and the photoinhibition light.

The light of the optical source may comprise a first wavelength for curing the photoactive resin in a first portion of the film of the mixture. The first wavelength may activate the at least one photoinitiator of the photoactive resin, thereby initiating curing of the polymeric precursors into the polymeric material. The light may be a photoinitiation light, and the first portion of the film may be a photoinitiation layer. The light may be a patterned light. The system may further comprise an additional optical source comprising an additional light having a second wavelength for inhibiting curing of the photoactive resin in a second portion of the film of the mixture. The first wavelength and the second wavelength may be different. The second wavelength may activate the at least one photoinhibitor of the photoactive resin, thereby inhibiting curing of the polymeric precursors into the polymeric material. The additional light may be a photoinhibition light, and the second portion of the film of the mixture may be a photoinhibition layer. The additional light may be a flood light.

The optical source that directs the photoinitiation light may be a mask-based display, such as a liquid crystal display (LCD) device, or light emitting, such as a discrete LED array device. Alternatively, the optical source that directs the photoinitiation light may be a DLP device, including a digital micro-mirror device (DMD) for producing patterned light that can selectively illuminate and cure 3D printed structures. The initiation light directed from the DLP device may pass through one or more projection optics (e.g., a light projection lens) prior to illuminating through the print window and to the film of the mixture. The one or more projection optics may be integrated in the DLP device. Alternatively or in addition to, the one or more projection optics or may be configured between the DLP device and the print window. A relative position of the one or more projection optics relative to the DLP device and the print window may be adjustable to adjust an area of the photoinitiation layer in the film of the mixture. The area of the photoinitiation layer may be defined as a build area. In some examples, the one or more projection optics may be on a projection optics platform. The projection optics platform may be coupled to an actuator that directs movement of the projection optics platform. The controller may be operatively coupled to the actuator to control movement of the projection optics platform. The controller may direct the actuator (e.g., a screw-based mechanism) to adjust a relative position of the one or more projection optics to the DLP device and the print window during printing the 3D object.

The additional optical source that directs the photoinhibition light may comprise a plurality of light devices (e.g., a plurality of light emitting diodes (LEDs)). The light devices may be on a light platform. The light platform may be configured (i) move relative to the print window and (ii) yield a uniform projection of the photoinhibition light within the photoinhibition layer in the film of the mixture adjacent to the print window. In some examples, the position of the light platform may be independently adjustable with respect to a position of the optical source that directs the photoinitiation light. The light platform comprising the plurality of light devices may be arranged with respect to the print window such that a peak intensity of each of the plurality of light devices is directed at a different respective position (e.g., corner or other position) of the build area. In an example, the build area may have four corners and a separate beam of light (e.g., a separate LED) may be directed to each corner of the build area. The beams of photoinhibition light from the plurality of light devices may overlap to provide the uniform projection of the photoinhibition light within the photoinhibition layer. The light platform may be coupled to an actuator that directs movement of the light platform. The controller may be operatively coupled to the actuator to control movement of the light platform. The controller may direct the actuator (e.g., a screw-based mechanism) to adjust a relative position of the plurality of light devices to the print window during printing the 3D object. In some examples, the one or more projection optics to the DLP device (for the photoinitiation light) may be on the light platform.

Whether using one optical source or two optical sources, the photoinhibition light may be configured to create the photoinhibition layer in the film of the mixture adjacent to the print window. The photoinhibition light may be configured to form the photoinhibition layer in the film of the mixture adjacent to the transparent film that is covering the print window. Furthermore, the photoinitiation light may be configured to cure the photoactive resin in the photoinitiation layer that resides between the photoinhibition layer and the build head. The photoactive resin in the photoinitiation layer may be cured into at least a portion of the 3D structure. The photoinitiation light may be configured to cure the photoactive resin in the photoinitiation layer that resides between the photoinhibition layer and the at least the portion of the 3D structure adjacent to the build head.

A thickness of the photoinitiation layer, the photoinhibition layer, or both may be adjusted by adjusting an intensity and duration of the photoinitiation light, the photoinhibition light, or both. The thickness of the photoinitiation layer, the photoinhibition layer, or both may be adjusted to adjust the thickness of the printed layer of the at least the portion of the 3D object. Alternatively or in addition to, the thickness of the photoinitiation layer, the photoinhibition layer, or both may be adjusted by adjusting the speed at which the build head moves away in a direction away from the print window.

The system may comprise the controller to control various parts (e.g., actuators, sensors, etc.) of different components of the 3D printing system, as described elsewhere herein.

### Computer Systems

The present disclosure provides computer systems that are programmed to implement methods of the disclosure. Computer systems of the present disclosure may be used to regulate various operations of 3D printing, such as, for example, (i) directing movement of one or more platforms (for holding a film of mixture) relative to a deposition unit and/or a building unit; (ii) directing movement of a plurality of wipers for mixing, collecting, and re-using any excess mixture for 3D printing; or (iii) directing movement or controlling operations of a build head, optical sources, and/or sensors.

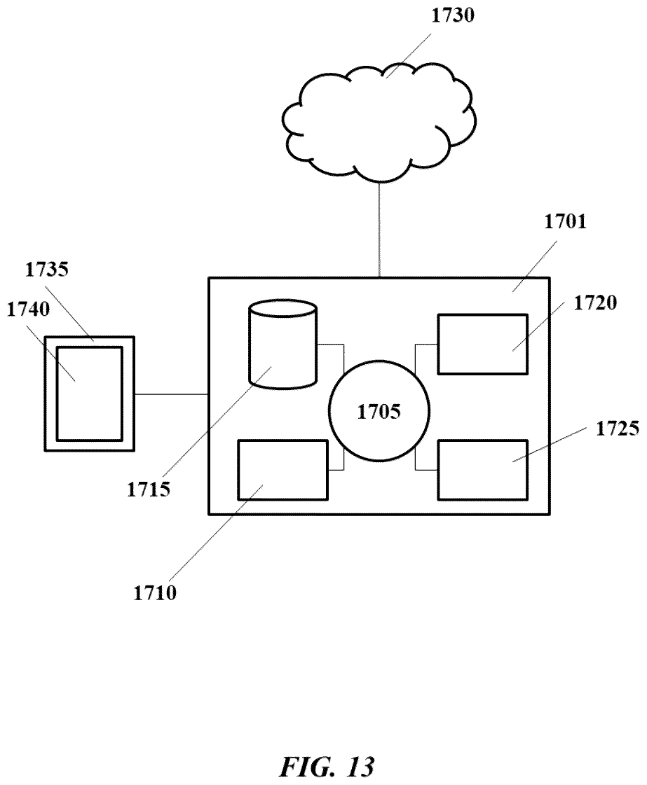

FIG. 13 shows a computer system 1701 that is programmed or otherwise configured to communicate with and regulate various aspects of a 3D printer of the present disclosure. The computer system 1701 can communicate with, for example, the optical sources, build head, one or more deposition heads, one or more sources of one or more mixtures of the present disclosure, one or more first coupling units of the platform, one or more second coupling units of the build head, one or more actuators coupled to one or more of the coupling units, one or more fixtures coupled to the one or more coupling units, one or more film transfer units, one or more actuators operatively coupled to the film transfer units, one or more sensors for detecting the layer of the mixture prior to, during, and subsequent to printing at least a portion of the 3D object, a vacuum unit, and/or a laminator unit. The computer system 1701 may also communicate with the 3D printing mechanisms or one or more controllers of the present disclosure. The computer system 1701 can be an electronic device of a user or a computer system that is remotely located with respect to the electronic device. The electronic device can be a mobile electronic device.

The computer system 1701 includes a central processing unit (CPU, also “processor” and “computer processor” herein) 1705, which can be a single core or multi core processor, or a plurality of processors for parallel processing. The computer system 1701 also includes memory or memory location 1710 (e.g., random-access memory, read-only memory, flash memory), electronic storage unit 1715 (e.g., hard disk), communication interface 1720 (e.g., network adapter) for communicating with one or more other systems, and peripheral devices 1725, such as cache, other memory, data storage and/or electronic display adapters. The memory 1710, storage unit 1715, interface 1720 and peripheral devices 1725 are in communication with the CPU 1705 through a communication bus (solid lines), such as a motherboard. The storage unit 1715 can be a data storage unit (or data repository) for storing data. The computer system 1701 can be operatively coupled to a computer network (“network”) 1730 with the aid of the communication interface 1720. The network 1730 can be the Internet, an internet and/or extranet, or an intranet and/or extranet that is in communication with the Internet. The network 1730 in some embodiments is a telecommunication and/or data network. The network 1730 can include one or more computer servers, which can enable distributed computing, such as cloud computing. The network 1730, in some embodiments with the aid of the computer system 1701, can implement a peer-to-peer network, which may enable devices coupled to the computer system 1701 to behave as a client or a server.

The CPU 1705 can execute a sequence of machine-readable instructions, which can be embodied in a program or software. The instructions may be stored in a memory location, such as the memory 1710. The instructions can be directed to the CPU 1705, which can subsequently program or otherwise configure the CPU 1705 to implement methods of the present disclosure. Examples of operations performed by the CPU 1705 can include fetch, decode, execute, and writeback.

The CPU 1705 can be part of a circuit, such as an integrated circuit. One or more other components of the system 1701 can be included in the circuit. In some embodiments, the circuit is an application specific integrated circuit (ASIC).

The storage unit 1715 can store files, such as drivers, libraries and saved programs. The storage unit 1715 can store user data, e.g., user preferences and user programs. The computer system 1701 in some embodiments can include one or more additional data storage units that are external to the computer system 1701, such as located on a remote server that is in communication with the computer system 1701 through an intranet or the Internet.

The computer system 1701 can communicate with one or more remote computer systems through the network 1730. For instance, the computer system 1701 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1701 via the network 1730.

Methods as described herein can be implemented by way of machine (e.g., computer processor) executable code stored on an electronic storage location of the computer system 1701, such as, for example, on the memory 1710 or electronic storage unit 1715. The machine executable or machine readable code can be provided in the form of software. During use, the code can be executed by the processor 1705. In some embodiments, the code can be retrieved from the storage unit 1715 and stored on the memory 1710 for ready access by the processor 1705. In some situations, the electronic storage unit 1715 can be precluded, and machine-executable instructions are stored on memory 1710.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1701 can include or be in communication with an electronic display 1735 that comprises a user interface (UI) 1740 for providing, for example, (i) activate or deactivate a 3D printer for printing a 3D object, (ii) determining when to clean the deposition head, (iii) determine any defects in the film of the mixture, (iv) determining a pathway of a platform to move from a deposition unit to a building unit, or vice versa, (v) determining a type of multi-wiper configuration to utilize for removing, collecting, and/or flattening any excess mixture, and/or (vi) controlling movement of a belt system (e.g., continuous belt, roll-to-roll belt) of the 3D printing system disclosed herein. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1705. The algorithm can, for example, determine a volume of the mixture that must be dispensed into a pool of excess mixture for a subsequent printing step.

Methods and systems of the present disclosure may be combined with or modified by other methods and systems for 3D printing and further processing thereof (e.g., debinding, sintering, etc.), such as, for example, those described in U.S. Patent Publication No. 2016/0067921 (“THREE DIMENSIONAL PRINTING ADHESION REDUCTION USING PHOTOINHIBITION”), U.S. Patent Publication No. 2018/0348646 (“MULTI WAVELENGTH STEREOLITHOGRAPHY HARDWARE CONFIGURATIONS”), Patent Cooperation Treaty Patent Publication No. 2018/213356 (“VISCOUS FILM THREE-DIMENSIONAL PRINTING SYSTEMS AND METHODS”), Patent Cooperation Treaty Patent Publication No. 2018/232175 (“METHODS AND SYSTEMS FOR STEREOLITHOGRAPHY THREE-DIMENSIONAL PRINTING”), Patent Cooperation Treaty Patent Application No. PCT/US2019/068413 (“SENSORS FOR THREE-DIMENSIONAL PRINTING SYSTEMS AND METHODS”), Patent Cooperation Treaty Patent Application No. 2020/236657 (“STEREOLITHOGRAPHY THREE-DIMENSIONAL PRINTING SYSTEMS AND METHODS”), and Patent Cooperation Treaty Patent Application No. 2022/025229 (“SYSTEMS AND METHODS FOR STEREOLITHOGRAPHY THREE-DIMENSIONAL PRINTING”), each of which is entirely incorporated herein by reference.

### EMBODIMENTS

The following non-limiting embodiments provide illustrative examples of the disclosure, but do not limit the scope of the disclosure.

Embodiment 1. A system for printing a three-dimensional (3D) object, comprising:

an optical source configured to provide light to a mixture, wherein the light is sufficient to cause formation of at least a portion of the 3D object during the printing;

a build head configured to support the at least the portion of the 3D object;

a platform comprising an area configured to hold the mixture adjacent to the build head; and

an actuator operatively coupled to the platform, wherein the actuator is configured to:
(i) adjust a movement between the area and the build head relative to one another, along a plurality of degrees of freedom; or
(ii) adjust a movement between the area and the optical source relative to one another,

optionally wherein:
(1) the actuator is operated by a user of the system; and/or
(2) the actuator is operated by a controller operatively coupled to the actuator; and/or
(3) the actuator is coupled to the platform; and/or
(4) the actuator is configured to adjust the movement between the area and the build head relative to one another,
   optionally wherein the actuator is configured to adjust movement of the area relative to the build head, while the build head remains stationary; and/or
(5) the actuator is configured to (ii) adjust the movement between the area and the optical source relative to one another,
   optionally wherein the actuator is configured to adjust movement of the area relative to the optical source, while the build head remains stationary; and/or
(6) the plurality of degrees of freedom comprises two or more members selected from the group consisting of x, y, z, pitch, yaw, and roll,
   optionally wherein the plurality of degrees of freedom comprises pitch and yaw; and/or
(7) the relative movement between the area and the optical source is along a plurality of degrees of freedom comprising two or more members selected from the group consisting of x, y, z, pitch, yaw, and roll,
   optionally wherein the plurality of degrees of freedom comprise pitch and yaw; and/or
(8) the actuator is configured to level the area,
   optionally wherein the leveling is controlled at a resolution of movement that ranges between about 10 micrometers and about 500 micrometers; and/or
(9) the actuator comprises a plurality of actuators disposed at different positions of the platform; and/or
(10) the plurality of actuators are disposed at opposite positions relative to each other; and/or
(11) the actuator comprises a leveling wedge,
   optionally wherein the actuator comprises a fastener to substantially maintain the leveling during the printing; and/or
(12) the actuator is disposed beneath the area; and/or
(13) the area is transparent or semi-transparent; and/or
(14) the optical source is configured to provide the light through the area and towards the mixture; and/or
(15) the build head is configured to move along a direction away from the platform during the printing; and/or
(16) the system further comprises a film for carrying the mixture, wherein the film is disposed between the mixture and the area.

Embodiment 2. A method for printing a three-dimensional (3D) object, comprising:

(a) providing:
an optical source configured to provide light to a mixture, wherein the light is sufficient to cause formation of at least a portion of the 3D object during the printing;
a build head configured to support the at least the portion of the 3D object;
a platform comprising an area configured to hold the mixture adjacent to the build head;

(b) adjusting (i) a movement between the area and the build head relative to one another, along a plurality of degrees of freedom, or (ii) a movement between the area and the optical source relative to one another, for leveling the area; and

(c) using the optical source to provide the light to the mixture disposed adjacent to the area of the platform, for the printing,

optionally wherein:
(1) the adjusting in (b) is performed by a user; and/or
(2) the adjusting in (b) is directed by a controller programmed to perform (b); and/or
(3) (b) comprises adjusting the movement between the area and the build head relative to one another,
   optionally wherein (b) comprises adjusting movement of the area relative to the build head, while the build head remains stationary; and/or
(4) (b) comprises adjusting (ii) the movement between the area and the optical source relative to one another,
   optionally wherein (b) comprises adjusting movement of the area relative to the optical source, while the build head remains stationary; and/or
(5) the plurality of degrees of freedom comprises two or more members selected from the group consisting of x, y, z, pitch, yaw, and roll,
   optionally wherein the plurality of degrees of freedom comprises pitch and yaw; and/or
(6) the movement between the area and the optical source relative to one another is along a plurality of degrees of freedom comprising two or more members selected from the group consisting of x, y, z, pitch, yaw, and roll,
   optionally wherein the plurality of degrees of freedom comprises pitch and yaw; and/or
(7) the leveling is controlled at a resolution of movement that ranges between about 10 micrometers and about 500 micrometers; and/or
(8) an actuator is operatively coupled to the platform and is configured to perform (b),
   optionally wherein:
      (i) the actuator is coupled to the platform; and/or
      (ii) the actuator comprises a plurality of actuators disposed at different positions of the platform,
         further optionally wherein the plurality of actuators are disposed at opposite positions relative to each other; and/or
      (iii) the actuator comprises a leveling wedge; and/or
      (iv) the actuator comprises a fastener to substantially maintain the leveling during the printing; and/or
      (v) the actuator is disposed beneath the area; and/or
(9) the area is transparent or semi-transparent; and/or
(10) (c) comprises using the optical source to provide the light through the area and towards the mixture; and/or
(11) the method further comprises moving the build head along a direction away from the platform during the printing; and/or
(12) a film is disposed between the mixture and the area, for carrying the mixture.

Embodiment 3. A system for printing a three-dimensional (3D) object, comprising:

a platform comprising:
an exposure window configured to hold a mixture for printing at least a portion of the 3D object, wherein a bottom surface of the exposure window comprises an inner portion surrounded by an outer portion, wherein the outer portion is at least about 20% of the bottom surface; and
a support unit coupled to the inner portion of the bottom surface of the exposure window, to provide stability to the exposure window;

a build head configured to support the at least the portion of the 3D object; and

an optical source configured to provide light to the mixture to form the at least the portion of the 3D object,

optionally wherein:
(1) the bottom surface is substantially flat; and/or
(2) the support unit is a support beam; and/or
(3) the support unit is coupled to a center portion of the bottom surface; and/or
(4) the outer portion is at least about 25% of the bottom surface; and/or
(5) the outer portion is at least about 30% of the bottom surface; and/or
(6) the outer portion is at least about 50% of the bottom surface; and/or
(7) the exposure window has an average thickness of at least about 15 millimeters; and/or
(8) the exposure window has an average thickness of at least about 20 millimeters; and/or
(9) the exposure window has an average thickness of at least about 40 millimeters; and/or
(10) the exposure window has a top surface, wherein an area of the top surface is at least

about 100 centimeter squared; and/or
(11) the support unit is releasably coupled to the inner portion; and/or
(12) the optical source comprises a plurality of optical sources configured to provide a plurality of lights along a plurality of optical paths and towards the window, wherein the support unit is disposed between the plurality of optical paths; and/or
(13) the support unit is configured to reduce deformation of the window during printing, as compared to a control 3D printing system lacking the support unit; and/or
(14) the platform further comprises a fastener to secure the window to the platform; and/or
(15) the system further comprise a controller operatively coupled to the optical source, wherein the controller is programmed to direct the optical source to provide the light to the mixture for the printing.

Embodiment 4. A method for printing a three-dimensional (3D) object, comprising:

(a) providing:
a platform comprising:
   an exposure window configured to hold a mixture for printing at least a portion of the 3D object, wherein a bottom surface of the exposure window comprises an inner portion surrounded by an outer portion, wherein the outer portion is at least about 20% of the bottom surface; and
   a support unit coupled to the inner portion of the bottom surface of the window, to provide stability to the exposure window;
a build head configured to support the at least the portion of the 3D object; and
an optical source configured to provide light to the mixture to form the at least the portion of the 3D object; and

(b) using the optical source to provide the light to the mixture disposed adjacent to the window of the platform for the printing,

optionally wherein:
(1) the bottom surface is substantially flat; and/or
(2) the support unit is a support beam; and/or
(3) the support unit is coupled to a center portion of the bottom surface; and/or
(4) the outer portion is at least about 25% of the bottom surface; and/or
(5) the outer portion is at least about 30% of the bottom surface; and/or
(6) the outer portion is at least about 50% of the bottom surface; and/or
(7) the exposure window has an average thickness of at least about 15 millimeters; and/or
(8) the exposure window has an average thickness of at least about 20 millimeters; and/or
(9) the exposure window has an average thickness of at least about 40 millimeters; and/or (10) the exposure window has a top surface, wherein an area of the top surface is at least about 100 centimeter squared; and/or
(11) the support unit is releasably coupled to the inner portion; and/or
(12) the optical source comprises a plurality of optical sources configured to provide a plurality of lights along a plurality of optical paths and towards the window, wherein the support unit is disposed between the plurality of optical paths; and/or
(13) the support unit reduces deformation of the window during printing, as compared to a control 3D printing system lacking the support unit; and/or
(14) the platform further comprises a fastener to secure the window to the platform; and/or
(15) the step (b) is performed by a controller operatively coupled to the optical source.

Embodiment 5. A system for printing a three-dimensional (3D) object, comprising:

a build head configured to support at least a portion of the 3D object during the printing;

a platform comprising an area configured to hold a mixture adjacent to the build head;

an optical source configured to provide light to the mixture, wherein the light is sufficient to cause formation of the at least the portion of the 3D object; and

an actuator operatively coupled to the optical source for controlling projection of the light onto the area, wherein the actuator is configured to:
adjust a movement between the optical source and the build head relative to one another, along a plurality of degrees of freedom; or
adjust a movement between the optical source and the area relative to one another, optionally wherein:
(1) the actuator is configured to (i) adjust the movement between the optical source and the build head relative to one another, along the plurality of degrees of freedom,
   optionally wherein the actuator is configured to adjust movement of the optical source relative to the build head along the plurality of degrees of freedom, while the build head remains stationary; and/or
(2) the actuator is configured to (ii) adjust the movement between the optical source and the area relative to one another,
   optionally wherein the actuator is configured to adjust movement of the optical source relative to the area, while the area remains stationary; and/or
(3) the plurality of degrees of freedom comprises two or more members selected from the group consisting of x, y, z, pitch, yaw, and roll,
   optionally wherein the plurality of degrees of freedom comprises two or more members selected from the group consisting of pitch, yaw and z; and/or
(4) the movement between the optical source and the area relative to one another is along a plurality of degrees of freedom comprising two or more members selected from the group consisting of x, y, z, pitch, yaw, and roll,
   optionally wherein the plurality of degrees of freedom comprises two or more members selected from the group consisting of pitch, yaw and z; and/or
(5) the actuator is configured to control shape and/or position of the projection of the light onto the area; and/or
(6) the optical source comprises a plurality of optical sources, wherein each optical source of the plurality of optical sources is configured to move relative to the area along the plurality of degrees of freedom; and/or
(7) a plurality of light projections onto the area from the plurality of optical sources are adjacent to each other; and/or
(8) the actuator is coupled to the optical source; and/or
(9) the system further comprises a base configured to hold the optical source, wherein the actuator is coupled to the base to adjust movement of the base relative to the area, thereby to control projection of the light from the optical source onto the area; and/or
(10) the area is transparent or semi-transparent; and/or
(11) the optical source is configured to provide the light through the area and towards the mixture; and/or
(12) the build head is configured to move along a direction away from the platform during the printing; and/or
(13) the system further comprises a film for carrying the mixture, wherein the film is disposed between the mixture and the area; and/or
(14) the system further comprises a controller operatively coupled to the actuator, wherein the controller is configured to direct the actuator to adjust the movement of the optical source relative to the area.

Embodiment 6. A method for printing a three-dimensional (3D) object, comprising:

(a) providing:
a build head configured to support at least a portion of the 3D object during the printing;
a platform comprising an area configured to hold a mixture adjacent to the build head; and
an optical source configured to provide light to the mixture, wherein the light is sufficient to cause formation of the at least the portion of the 3D object;

(b) adjusting (i) a movement between the optical source and the build head relative to one another, along a plurality of degrees of freedom; or (ii) a movement between the optical source and the area relative to one another; and

(c) using the optical source to provide the light to the mixture disposed adjacent to the area of the platform, for the printing,

optionally wherein:
(1) (b) comprises (i) adjusting the movement between the optical source and the build head relative to one another, along the plurality of degrees of freedom,
   optionally wherein (b) comprises adjusting the movement of the optical source relative to the build head along the plurality of degrees of freedom, while the build head remains stationary; and/or
(2) (b) comprises adjusting the movement between the optical source and the area relative to one another,
   optionally wherein (b) comprises adjusting the movement of the optical source relative to the area, while the area remains stationary; and/or
(3) the plurality of degrees of freedom comprises two or more members selected from the group consisting of x, y, z, pitch, yaw, and roll,
   optionally wherein the plurality of degrees of freedom comprises two or more members selected from the group consisting of pitch, yaw and z; and/or
(4) the movement between the optical source and the area relative to one another is along a plurality of degrees of freedom comprising two or more members selected from the group consisting of x, y, z, pitch, yaw, and roll,
   optionally wherein the plurality of degrees of freedom comprises two or more members selected from the group consisting of pitch, yaw and z; and/or
(5) an actuator is operatively coupled to the optical source, and wherein the method comprising using directing the actuator to perform the step of (b),
   optionally wherein:
      (i) the actuator controls shape and/or position of the projection of the light onto the area; and/or
      (ii) the actuator is coupled to the optical source; and/or
      (iii) the method further comprises, via a controller operatively coupled to the actuator, directing the actuator to adjust the movement of the optical source relative to the area; and/or
(6) the optical source comprises a plurality of optical sources, wherein each optical source of the plurality of optical sources is configured to move relative to the area long the plurality of degrees of freedom,
   optionally wherein a plurality of light projections onto the area from the plurality of optical sources are adjacent to each other; and/or
(7) the method further comprises adjusting movement of a base relative to the area, thereby to control projection of the light from the optical source onto the area, wherein the actuator is coupled to the base and wherein the base is configured to hold the optical source; and/or
(8) the area is transparent or semi-transparent; and/or
(9) in (c) the optical source provides the light through the area and towards the mixture; and/or
(10) the method further comprises moving the build head along a direction away from the platform during the printing; and/or
(11) a film is disposed between the mixture and the area, to carry the mixture.

Embodiment 7. A system for printing a three-dimensional (3D) object, comprising:

a platform comprising an area for holding a mixture for printing at least a portion of the 3D object during the printing;

a deposition unit in fluid communication with a source of the mixture, wherein the deposition unit is configured to deposit at least a portion of the mixture onto the area;

a building unit comprising an optical source configured to provide light to the mixture, wherein the light is sufficient to cause formation of the at least the portion of the 3D object; and

a plurality of guiding elements operatively coupled to the platform and configured to direct movement of the platform between the deposition unit and the building unit,
wherein a first guiding element of the plurality of guiding elements is configured to move along a first path, and a second guiding element of the plurality of guiding elements is configured to move along a second path that is not overlapping with the first path, wherein the first path and the second path are disposed in a single plane that is substantially parallel to the area,

optionally wherein:
(1) the plurality of guiding elements is configured to move towards a same direction; and/or
(2) the plurality of guiding elements is operatively coupled to a single actuator; and/or
(3) a guiding element of the plurality of guiding elements comprises a belt or a wheel; and/or
(4) a guiding element of the plurality of guiding elements comprises a rail; and/or
(5) the first path and the second path are substantially parallel to each other; and/or
(6) the first guiding element and the second guiding element are coupled to two opposite sides of the platform; and/or
(7) the platform comprises at least two platforms, wherein the plurality of guiding elements is configured to simultaneously direct movement of the at least two platforms between the deposition unit and the building unit; and/or
(8) movements of the at least two platforms are opposite relative to one another; and/or
(9) the area is transparent or semi-transparent; and/or
(10) the optical source is configured to provide the light through the area and towards the mixture; and/or
(11) the deposition unit comprises a nozzle that is in fluid communication with the source; and/or
(12) the building unit comprises a build head configured to support the at least the portion of the 3D object during the printing; and/or
(13) the system further comprises a controller operatively coupled to the plurality of guiding elements, wherein the controller is programmed to control the plurality of guiding elements to direct the movement of the platform between the deposition unit and the building unit.

Embodiment 8. A method for printing a three-dimensional (3D) object, comprising:

(a) providing:
a platform comprising an area for holding a mixture for printing at least a portion of the 3D object during the printing;
a deposition unit in fluid communication with a source of the mixture, wherein the deposition unit is configured to deposit at least a portion of the mixture onto the area;
a building unit comprising an optical source configured to provide light to the mixture, wherein the light is sufficient to cause formation of the at least the portion of the 3D object; and
a plurality of guiding elements operatively coupled to the platform and configured to direct movement of the platform between the deposition unit and the building unit,
   wherein a first guiding element of the plurality of guiding elements is configured to move along a first path, and a second guiding element of the plurality of guiding elements is configured to move along a second path that is not overlapping with the first path, wherein the first path and the second path are disposed in a single plane that is substantially parallel to the area;

(b) directing, via the plurality of guiding elements, the movement of the platform between the deposition unit and the building unit; and

(c) using the optical source to provide the light to the mixture disposed adjacent to the area of the platform for the printing,

optionally wherein:
(1) The method of claim D15, wherein the plurality of guiding elements move towards a same direction; and/or
(2) the plurality of guiding elements is operatively coupled to a single actuator; and/or
(3) a guiding element of the plurality of guiding elements comprises a belt or a wheel; and/or
(4) a guiding element of the plurality of guiding elements comprises a rail; and/or
(5) the first path and the second path are substantially parallel to each other; and/or
(6) the first guiding element and the second guiding element are coupled to two opposite sides of the platform; and/or
(7) the platform comprises at least two platforms, wherein the plurality of guiding elements is configured to simultaneously direct movement of the at least two platforms between the deposition unit and the building unit; and/or
(8) movements of the at least two platforms are opposite relative to one another; and/or
(9) the area is transparent or semi-transparent; and/or
(10) the optical source provides the light through the area and towards the mixture; and/or
(11) the deposition unit comprises a nozzle that is in fluid communication with the source; and/or
(12) the building unit comprises a build head configured to support the at least the portion of the 3D object during the printing; and/or
(13) the step (c) is performed by a controller operatively coupled to the plurality of guiding elements.

Embodiment 9. A system for printing a three-dimensional (3D) object, comprising:

a platform comprising (i) an area for holding a mixture for printing at least a portion of the 3D object during the printing and (ii) a first coupling unit;

a deposition unit in fluid communication with a source of the mixture, wherein the deposition unit is configured to deposit at least a portion of the mixture onto the area;

a building unit comprising an optical source configured to provide light to the mixture, wherein the light is sufficient to cause formation of the at least the portion of the 3D object during the printing; and

a moving unit configured to direct movement of the platform between the deposition unit and the building unit, wherein the moving unit comprises a second coupling unit that is configured to couple to the first coupling unit, such that the platform is operatively coupled to the moving unit,
wherein a vertical dimension of the second coupling unit is configured to permit a vertical movement between the first coupling unit and the moving unit relative to one another, optionally wherein:
(1) the system further comprises
   (A) an additional platform comprising (i) an additional area for holding the mixture or an additional mixture and (ii) a third coupling unit; and
   (B) an additional moving unit configured to direct movement of the additional platform between the deposition unit and the building unit,
      wherein the additional moving unit comprises a fourth coupling unit that is configured to couple to the third coupling unit, such that the additional platform is operatively coupled to the additional moving unit,
      wherein a vertical dimension of the fourth coupling unit is configured to permit a vertical movement between the third coupling unit and the additional moving unit relative to one another, and
      wherein the vertical dimension of the second coupling unit and the vertical dimension of the fourth coupling unit are different; and/or
(2) the platform and the additional platform are moving in opposite directions between the deposition unit and the building unit, the area of the platform and the additional area of the additional platform are disposed at different heights; and/or
(3) the platform and the additional platform are stationary at the deposition unit and the building unit, respectively, the area of the platform and the additional area of the additional platform are disposed at substantially the same heights; and/or
(4) the first coupling unit comprises a protrusion relative to a surface of the first coupling unit, and wherein the second coupling unit comprises a recess relative to a surface of the second coupling unit; and/or
(5) the protrusion comprises one or more pins, and wherein the recess comprises one or more slots; and/or
(6) the movement is substantially a horizontal movement; and/or
(7) the moving unit is operatively coupled to an actuator configured to move the moving unit, thereby to direct the movement of the platform along a direction; and/or
(8) the system further comprises an additional actuator coupled to the actuator and configured to direct movement of the actuator along an additional direction, wherein the direction and the additional direction are not parallel to each other; and/or
(9) the direction and the additional direction are substantially orthogonal to each other; and/or
(10) (i) the direction is substantially horizontal and (ii) the additional direction is substantially vertical; and/or
(11) the additional actuator is not directly coupled to the platform, such that operation of the additional actuator in absence of the actuator is not configured to move the platform along the direction; and/or
(12) the system further comprises a controller operatively coupled to the moving unit, wherein the controller is programmed to control the moving unit to direct the movement of the platform between the deposition unit and the building unit.

Embodiment 10. A method for printing a three-dimensional (3D) object, comprising:

(a) providing:
a platform comprising (i) an area for holding a mixture for printing at least a portion of the 3D object during the printing and (ii) a first coupling unit;
a deposition unit in fluid communication with a source of the mixture, wherein the deposition unit is configured to deposit at least a portion of the mixture onto the area;
a building unit comprising an optical source configured to provide light to the mixture, wherein the light is sufficient to cause formation of the at least the portion of the 3D object during the printing; and
a moving unit configured to direct movement of the platform between the deposition unit and the building unit, wherein the moving unit comprises a second coupling unit that is configured to couple to the first coupling unit, such that the platform is operatively coupled to the moving unit, wherein a vertical dimension of the second coupling unit is configured to permit a vertical movement between the first coupling unit and the moving unit relative to one another;

(b) directing, via the moving unit, the movement of the platform between the deposition unit and the building unit; and

(c) using the optical source to provide the light to the mixture disposed adjacent to the area of the platform for the printing,

optionally wherein:
(1) the method further comprises:
   providing an additional platform comprising (i) an additional area for holding the mixture or an additional mixture and (ii) a third coupling unit; and
   directing, via an additional moving unit, movement of the additional platform between the deposition unit and the building unit, wherein the additional moving unit comprises a fourth coupling unit that is configured to couple to the third coupling unit, such that the additional platform is operatively coupled to the additional moving unit,
      wherein a vertical dimension of the fourth coupling unit is configured to permit a vertical movement between the third coupling unit and the additional moving unit relative to one another, and wherein the vertical dimension of the second coupling unit and the vertical dimension of the fourth coupling unit are different; and/or
(2) when the platform and the additional platform are moving in opposite directions between the deposition unit and the building unit, the area of the platform and the additional area of the additional platform are disposed at different heights; and/or
(3) when the platform and the additional platform are stationary at the deposition unit and the building unit, respectively, the area of the platform and the additional area of the additional platform are disposed at substantially the same heights; and/or
(4) the first coupling unit comprises a protrusion relative to a surface of the first coupling unit, and wherein the second coupling unit comprises a recess relative to a surface of the second coupling unit; and/or
(5) the protrusion comprises one or more pins, and wherein the recess comprises one or more slots; and/or
(6) the movement is substantially a horizontal movement; and/or
(7) the moving unit is operatively coupled to an actuator configured to move the moving unit, thereby to direct the movement of the platform along a direction; and/or
(8) the method further comprises, directing, via an additional actuator coupled to the actuator, movement of the actuator along an additional direction, wherein the direction and the additional direction are not parallel to each other; and/or
(9) the direction and the additional direction are substantially orthogonal to each other; and/or
(10) (i) the direction is substantially horizontal and (ii) the additional direction is substantially vertical; and/or
(11) the additional actuator is not directly coupled to the platform, such that operation of the additional actuator in absence of the actuator is not configured to move the platform along the direction; and/or
(12) the step (c) is performed by a controller operatively coupled to the moving unit.

Embodiment 11. A system for printing a three-dimensional (3D) object, comprising:

a platform configured to support a film holding a mixture for printing at least a portion of the 3D object during the printing, wherein the platform comprises:
(i) a bar configured to hold the film at a side of the film; and
(ii) an additional bar configured to hold the film at an additional side of the film,
   wherein the bar comprises a locking mechanism comprising (i) a locking state to couple at least a portion of the side of the film to the bar and (ii) an unlocking state to release the at least the portion of the side of the film from the bar; and

an optical source configured to provide light to the mixture, wherein the light is sufficient to cause formation of the at least the portion of the 3D object during the printing,

optionally wherein:
(1) the step (c) is performed by a controller operatively coupled to the moving unit; and/or
(2) the side and the additional side are opposite to each other; and/or
(3) the locking mechanism is movable relative to the bar; and/or
(4) the locking mechanism is a clamping bar,
   optionally wherein at least a portion of a surface of the bar comprises a coupling mechanism to operatively couple to the clamping bar,
      further optionally wherein the coupling mechanism is an indentation on the at least the portion of the surface
(5) a length of the locking mechanism is at least about 50% of a length of the roller; and/or
(6) a length of the locking mechanism is at least about 70% of a length of the bar; and/or
(7) the additional bar comprises an additional locking mechanism comprising (i) a locking state to couple at least a portion of the additional side of the film to the additional bar and (ii) an unlocking state to release the at least the portion of the additional side of the film from the additional bar; and/or
(8) the bar or the additional bar is not configured to move upon movement of the film relative to the bar or the additional bar,
   optionally wherein the bar or the additional bar comprises a rolling mechanism configured to direct rotation of the bar or the additional bar about a central rolling axis; and/or
(9) the bar or the additional bar is configured (i) to receive the film form a source of the film and (ii) support movement of the film from the source to the bar or the additional bar; and/or
(10) a surface of the bar or the additional bar is coated with a friction-enhancing agent,
optionally wherein:
   (i) the friction-enhancing agent comprises a polymer; and/or
   (ii) the friction-enhancing agent comprises a rubber; and/or
(11) the system further comprises a controller operatively coupled to the optical source, wherein the controller is programmed to direct the optical source to provide the light to the mixture for the printing.

Embodiment 12. A method for printing a three-dimensional (3D) object, comprising:

(a) providing:
a platform configured to support a film holding a mixture for printing at least a portion of the 3D object during the printing, wherein the platform comprises:
   (i) a bar configured to hold the film at a side of the film; and
(ii) an additional bar configured to hold the film at an additional side of the film,
   wherein the bar comprises a locking mechanism comprising (i) a locking state to couple at least a portion of the side of the film to the bar and (ii) an unlocking state to release the at least the portion of the side of the film from the bar; and
an optical source configured to provide light to the mixture, wherein the light is sufficient to cause formation of the at least the portion of the 3D object during the printing; and

(b) using the optical source to provide the light to the mixture disposed adjacent to the film that is supported by the platform for the printing,

optionally wherein:
(1) the side and the additional side are opposite to each other; and/or
(2) the locking mechanism is movable relative to the bar; and/or
(3) the locking mechanism is a clamping bar,
   optionally wherein at least a portion of a surface of the bar comprises a coupling mechanism to operatively couple to the clamping bar,
      further optionally wherein the coupling mechanism is an indentation on the at least the portion of the surface; and/or
(4) a length of the locking mechanism is at least about 50% of a length of the bar; and/or
(5) a length of the locking mechanism is at least about 70% of a length of the bar; and/or
(6) the additional bar comprises an additional locking mechanism comprising (i) a locking state to couple at least a portion of the additional side of the film to the additional bar and (ii) an unlocking state to release the at least the portion of the additional side of the film from the additional bar; and/or
(7) the bar or the additional bar is not configured to move upon movement of the film relative to the bar or the additional bar,
   optionally wherein the bar or the additional bar comprises a rolling mechanism configured to direct rotation of the bar or the additional bar about a central rolling axis; and/or
(8) the other member is configured (i) to receive the film form a source of the film and (ii) support movement of the film from the source to the member; and/or
(9) a surface of the bar or the additional bar is coated with a friction-enhancing agent,
   optionally wherein the friction-enhancing agent comprises a polymer,
      further optionally wherein the friction-enhancing agent comprises a rubber; and/or
(10) the step (b) is performed by a controller operatively coupled to the optical source.

Embodiment 13. A system for printing a three-dimensional (3D) object, comprising:

a platform comprising a top surface configured to hold a mixture for printing at least a portion of the 3D object, wherein a portion of the top surface is not parallel to an additional portion of the top surface that holds the mixture, and wherein the portion of the top surface is substantially rigid; and

an optical source configured to provide light to the mixture, wherein the light is (i) usable for determining a characteristic of the mixture prior to the printing or (ii) sufficient to cause formation of the at least the portion of the 3D object during the printing,

optionally wherein:
(1) the portion of the top surface is characterized by exhibiting a Young's modulus of at least about 10 GPa; and/or
(2) an angle between an external normal of the portion and an external normal of the additional portion of the top surface is an acute angle,
   optionally wherein:
      (i) the acute angle is less than about 60 degrees; and/or
      (ii) the acute angle is less than about 30 degrees; and/or
(3) the system further comprises a collection unit configured to couple to the platform via the portion of the top surface of the platform, to collect any excess mixture from the platform; and/or
(4) the collection unit is configured to cover the portion of the top surface upon coupling between the collection unit and the platform; and/or
(5) upon coupling of the collection unit and the platform, a top surface of the collection unit is substantially parallel to the top surface of the platform; and/or
(6) upon coupling of the collection unit and the platform, (i) a top surface of the collection unit and (ii) the top surface of the platform form a substantially flat area; and/or
(7) the system further comprises an actuator configured to direct movement of the collection unit relative to the platform; and/or
(8) the portion of the top surface of the platform comprises a sealing mechanism to prevent flow of at least a portion of the mixture across the sealing mechanism; and/or
(9) the sealing mechanism is disposed across a cross-sectional dimension of the portion of the top surface; and/or
(10) the sealing mechanism protrudes out of the portion of the top surface; and/or
(11) the sealing mechanism is a polymer strip; and/or
(12) the additional portion of the top surface is transparent or semi-transparent; and/or
(13) the additional portion of the top surface is porous; and/or
(14) the portion of the top surface is not porous; and/or
(15) further comprising a film for carrying the mixture, wherein the film is disposed between the mixture and the additional portion of the top surface of the platform,
   optionally wherein the film comprises a back surface adjacent to the top surface of the platform, and wherein the platform comprises one or more channels in fluid communication with the back surface, and wherein the system further comprises:
      a vacuum unit operatively coupled to the one or more channels, wherein the vacuum unit is configured to provide a vacuum between the platform and the back surface; and
      a controller operatively coupled to the vacuum unit, wherein the controller is configured to direct the vacuum unit to provide the vacuum between the platform and the back surface; and/or
(16) the portion of the top surface is a frame that is holding the additional portion of the top surface; and/or
(17) the portion and the additional portion of the top surface are comprised of different materials; and/or
(18) the one or more channels are in fluid communication with a side surface of the platform; and/or
(19) the one or more channels are in fluid communication with a bottom surface of the platform; and/or
(20) the characteristic of the mixture comprises a profile of the mixture or a quality of the mixture; and/or
(21) the portion of the top surface of the platform is flat; or
(22) the portion of the top surface of the platform is not flat; and/or
(23) the platform is not a rollable film; and/or
(24) the system further comprises a controller operatively coupled to the optical source, wherein the controller is programmed to direct the optical source to provide the light to the mixture for the printing.

Embodiment 14. A method for printing a three-dimensional (3D) object, comprising:

(a) providing:
a platform comprising a top surface configured to hold a mixture for printing at least a portion of the 3D object, wherein a portion of the top surface is not parallel to an additional portion of the top surface that holds the mixture, and wherein the portion of the top surface is substantially rigid; and
an optical source configured to provide light to the mixture, wherein the light is (i) usable for determining a characteristic of the mixture prior to the printing or (ii) sufficient to cause formation of the at least the portion of the 3D object during the printing; and

(b) using the optical source to provide the light to the mixture disposed adjacent to the additional portion of the top surface of the platform for the printing,

optionally wherein:
(1) the portion of the top surface is characterized by exhibiting a Young's modulus of at least about 10 GPa; and/or
(2) an angle between an external normal of the portion and an external normal of the additional portion of the top surface is an acute angle,
   optionally wherein:
      (i) the acute angle is less than about 60 degrees; and/or
      (ii) the acute angle is less than about 30 degrees; and/or
(3) the system further comprises a collection unit configured to couple to the platform via the portion of the top surface of the platform, to collect any excess mixture from the platform; and/or
(4) the collection unit is configured to cover the portion of the top surface upon coupling between the collection unit and the platform; and/or
(5) upon coupling of the collection unit and the platform, a top surface of the collection unit is substantially parallel to the top surface of the platform; and/or
(6) upon coupling of the collection unit and the platform, (i) a top surface of the collection unit and (ii) the top surface of the platform form a substantially flat area; and/or
(7) the method further comprises using an actuator to direct movement of the collection unit relative to the platform; and/or
(8) the portion of the top surface of the platform comprises a sealing mechanism to prevent flow of at least a portion of the mixture across the sealing mechanism; and/or
(9) the sealing mechanism is disposed across a cross-sectional dimension of the portion of the top surface; and/or
(10) the sealing mechanism protrudes out of the portion of the top surface; and/or
(11) the sealing mechanism is a polymer strip; and/or
(12) the additional portion of the top surface is transparent or semi-transparent; and/or
(13) the additional portion of the top surface is porous; and/or
(14) the portion of the top surface is not porous; and/or
(15) further comprising a film for carrying the mixture, wherein the film is disposed between the mixture and the additional portion of the top surface of the platform,
   optionally wherein the film comprises a back surface adjacent to the top surface of the platform, and wherein the platform comprises one or more channels in fluid communication with the back surface, and wherein the system further comprises:
      a vacuum unit operatively coupled to the one or more channels, wherein the vacuum unit is configured to provide a vacuum between the platform and the back surface; and
      a controller operatively coupled to the vacuum unit, wherein the controller is configured to direct the vacuum unit to provide the vacuum between the platform and the back surface; and/or
(16) the portion of the top surface is a frame that is holding the additional portion of the top surface; and/or
(17) the portion and the additional portion of the top surface are comprised of different materials; and/or
(18) the one or more channels are in fluid communication with a side surface of the platform; and/or
(19) the one or more channels are in fluid communication with a bottom surface of the platform; and/or
(20) the characteristic of the mixture comprises a profile of the mixture or a quality of the mixture; and/or
(21) the portion of the top surface of the platform is flat; or
(22) the portion of the top surface of the platform is not flat; and/or
(23) the platform is not a rollable film; and/or
(24) the step (b) is performed by a controller operatively coupled to the optical source.

Embodiment 15. A system for printing a three-dimensional (3D) object, comprising:

a platform comprising an area configured to hold a mixture for printing at least a portion of the 3D object,

a deposition unit comprising:
a wiper configured to (i) remove at least a portion of an excess of the mixture from the area or (ii) spread the mixture over the area;
an actuator configured to control a vertical movement of the wiper towards or away from the area; and
a dampener disposed between the actuator and the wiper, to reduce at least a portion of a force exerted by the actuator and towards the wiper when the actuator directs the vertical movement of the wiper towards or away from the area; and

an optical source configured to provide light to the mixture, wherein the light is sufficient to cause formation of the at least the portion of the 3D object during the printing.

The system of claim H1, wherein the dampener permits a relative movement between the actuator and the wiper,

optionally wherein:
(1) wherein the deposition unit further comprises a joint mechanism coupled to the wiper, wherein the joint mechanism is configured to permit movement of the wiper relative to the actuator or the dampener along at least one degree of freedom (DOF), wherein the at least one DOF is different from a direction of the vertical movement,
   optionally wherein (i) the at least one DOF is a roll axis or a pitch axis, and/or (ii) the joint mechanism is a double clevis joint; and/or
(2) the wiper or an additional wiper of the deposition unit is configured to spread the mixture over the area, to generate a film of the mixture that is usable for the printing, optionally wherein the wiper and the additional wiper are configured to move relative to each other; and/or
(3) the system further comprises a controller operatively coupled to the deposition unit, wherein the controller is programmed to (a) direct the actuator to control the vertical movement of the wiper, and (b) direct the optical source to provide the light to the mixture, for the printing; and/or
(4) the dampener comprises a spring.

Embodiment 16. A method for printing a three-dimensional (3D) object, comprising:

(a) providing:
a platform comprising an area configured to hold a mixture for printing at least a portion of the 3D object,
a deposition unit comprising:
   a wiper configured to (i) remove at least a portion of an excess of the mixture from the area or (ii) spread the mixture over the area;
   an actuator configured to control a vertical movement of the wiper towards or away from the area; and
   a dampener disposed between the actuator and the wiper, to reduce at least a portion of a force exerted by the actuator and towards the wiper when the actuator directs the vertical movement of the wiper towards or away from the area; and
an optical source configured to provide light to the mixture, wherein the light is sufficient to cause formation of the at least the portion of the 3D object during the printing;

(b) using the deposition unit to (i) remove the at least the portion of an excess of the mixture from the area or (ii) spread the mixture over the area; and

(c) using the optical source to provide the light to the mixture disposed adjacent to the area of the platform for the printing,

optionally wherein:
(1) the dampener permits a relative movement between the actuator and the wiper; and/or
(2) the deposition unit further comprises a joint mechanism coupled to the wiper, wherein the joint mechanism is configured to permit movement of the wiper relative to the actuator or the dampener along at least one degree of freedom (DOF), wherein the at least one DOF is different from a direction of the vertical movement,
   optionally wherein (i) the at least one DOF is a roll axis or a pitch axis, and/or (ii) the joint mechanism is a double clevis joint; and/or
(3) the wiper or an additional wiper of the deposition unit is configured to spread the mixture over the area, to generate a film of the mixture that is usable for the printing,
   optionally wherein the wiper and the additional wiper are configured to move relative to each other; and/or
(4) the system further comprises a controller operatively coupled to the deposition unit, wherein the controller is programmed to (a) direct the actuator to control the vertical movement of the wiper, and (b) direct the optical source to provide the light to the mixture, for the printing; and/or
(5) the dampener comprises a spring; and/or
(6) further comprising using a controller operatively coupled to the deposition unit to (1) direct the actuator to control the vertical movement of the wiper, and (2) direct the optical source to provide the light to the mixture, for the printing.

Embodiment 17. A system for printing a three-dimensional (3D) object, comprising:

a platform comprising an area for holding a mixture for printing at least a portion of the 3D object;

a deposition unit comprising a plurality of nozzles in fluid communication with a common source of the mixture, wherein each of the plurality of nozzles is configured to deposit at least a portion of the mixture onto the area, and wherein:
(i) the plurality of nozzles comprises a nozzle and an additional nozzle, wherein a cross-sectional dimension of the nozzle and an additional cross-sectional dimension of the additional nozzle are different; or
(ii) the plurality of nozzles comprises three or more nozzles; and

an optical source configured to provide light to the mixture, wherein the light is sufficient to cause formation of the at least the portion of the 3D object during the printing,

optionally wherein:
(1) the cross-sectional dimension of the nozzle and the cross-sectional dimension of the additional nozzle are different,
   optionally wherein the plurality of nozzles is disposed adjacent to a bottom surface of the deposition unit, wherein the nozzle is closer to a center of the bottom surface as compared to the additional nozzle, and wherein the cross-sectional dimension of the nozzle is less than the cross-sectional dimension of the additional nozzle; and/or
(2) the plurality of nozzles comprises the three or more nozzles; and/or
(3) the deposition unit is configured to control flow of the mixture from the common source, through a nozzle of the plurality of nozzles, and towards the area,
   optionally wherein the deposition unit comprises one or more valves to control the flow,
      further optionally wherein the deposition unit comprises a housing that contains the one or more valves; and/or
(4) the deposition unit comprises:
   a housing comprising the plurality of nozzles; and
   an additional housing comprising (1) the common source of the mixture or (2) a channel in fluid communication with the common source of the mixture and the plurality of nozzles,
      wherein the housing and the additional housing are coupled to each other to provide a flow path from the common source of the mixture and to the plurality of nozzles,
   optionally wherein the housing comprises a protrusion on a surface that makes a contact with the additional housing during the coupling, wherein the protrusion is configured to provide a sealing between the housing and the additional housing,
      further optionally wherein (i) the protrusion is a metal protrusion, and/or (ii) the sealing is sufficient in absence of a rubber O-ring; and/or
(5) the system further comprises a controller operatively coupled to the deposition unit and the optical source, wherein the controller is programmed to (a) direct the deposition unit to deposit the at least the portion of the mixture onto the area, and (b) direct the optical source to provide the light to the mixture for the printing,
   optionally wherein the controller is programmed to individually control flow of the mixture through each of the nozzle of the plurality of nozzles and towards at least a portion of the area, thereby to control dispense location of the mixture onto the area,
      further optionally wherein the controller is programmed to direct the deposition unit to move across the area to deposit the at least the portion of the mixture onto the area.

Embodiment 18. A method for printing a three-dimensional (3D) object, comprising:

(a) providing:
a platform comprising an area for holding a mixture for printing at least a portion of the 3D object;
a deposition unit comprising a plurality of nozzles in fluid communication with a common source of the mixture, wherein each of the plurality of nozzles is configured to deposit at least a portion of the mixture onto the area, and wherein:
   (i) the plurality of nozzles comprises a nozzle and an additional nozzle, wherein a cross-sectional dimension of the nozzle and an additional cross-sectional dimension of the additional nozzle are different; or
   (ii) the plurality of nozzles comprises three or more nozzles; and
an optical source configured to provide light to the mixture, wherein the light is sufficient to cause formation of the at least the portion of the 3D object during the printing; and

(b) using the deposition unit to deposit the mixture from the common source and towards the area of the platform, via one or more nozzles of the plurality of nozzles; and

(c) using the optical source to provide the light to the mixture disposed adjacent to the area of the platform for the printing,

optionally wherein:
(1) the cross-sectional dimension of the nozzle and the cross-sectional dimension of the additional nozzle are different,
   optionally wherein the plurality of nozzles is disposed adjacent to a bottom surface of the deposition unit, wherein the nozzle is closer to a center of the bottom surface as compared to the additional nozzle, and wherein the cross-sectional dimension of the nozzle is less than the cross-sectional dimension of the additional nozzle; and/or
(2) the plurality of nozzles comprises the three or more nozzles; and/or
(3) the deposition unit is configured to control flow of the mixture from the common source, through a nozzle of the plurality of nozzles, and towards the area,
   optionally wherein the deposition unit comprises one or more valves to control the flow,
      further optionally wherein the deposition unit comprises a housing that contains the one or more valves; and/or
(4) the deposition unit comprises:
   a housing comprising the plurality of nozzles; and
   an additional housing comprising (1) the common source of the mixture or (2) a channel in fluid communication with the common source of the mixture and the plurality of nozzles,
      wherein the housing and the additional housing are coupled to each other to provide a flow path from the common source of the mixture and to the plurality of nozzles,
   optionally wherein the housing comprises a protrusion on a surface that makes a contact with the additional housing during the coupling, wherein the protrusion is configured to provide a sealing between the housing and the additional housing,
      further optionally wherein (i) the protrusion is a metal protrusion, and/or
         (ii) the sealing is sufficient in absence of a rubber O-ring; and/or
(5) the steps (b) and (c) are performed by a controller operatively coupled to the deposition unit and the optical source,
   optionally wherein the controller individually controls flow of the mixture through each of the nozzle of the plurality of nozzles and towards at least a portion of the area, thereby to control dispense location of the mixture onto the area
      further optionally wherein the controller is programmed to (i) direct the deposition unit to move across the area to deposit the at least the portion of the mixture onto the area.

Embodiment 19. A system for printing a three-dimensional (3D) object, comprising:

a platform comprising an area configured to hold a mixture for printing at least a portion of the 3D object,

a deposition unit comprising a structural support and a wiper coupled to the structural support for (i) spreading the mixture over the area or (ii) removing at least a portion of an excess of the mixture from the area,
wherein the wiper is configured to move relative to the structural support, such that an axis along a length of the wiper shifts between (a) a non-parallel position relative to a surface of the area and (b) a substantially parallel position relative to the surface of the area; and

an optical source configured to provide light to the mixture to form the at least the portion of the 3D object,

optionally wherein:
(1) the wiper is for (i) the spreading the mixture over the area; and/or
(2) the wiper is for (ii) the removing the at least the portion of the excess of the mixture from the area; and/or
(3) the wiper is configured to rotate about a pivot point to move relative to the structure support, optionally wherein (i) the pivot point is a single pivot point, and/or the pivot point is disposed at or adjacent to a central position along the length of the wiper; and/or
(4) the deposition unit further comprises a fastener to substantially maintain the wiper at the substantially parallel position; and/or
(5) the wiper is a non-contact wiper, such that the deposition unit is not in direct contact with the area during the spreading; and/or
(6) the system further comprises a controller operatively coupled to the deposition unit, wherein the controller is programmed to:
   (A) direct movement of the area and the deposition unit relative to one another, thereby to direct the wiper to perform (i) the spreading or (ii) the removing; or
   (B) direct the optical source to provide the light to the mixture for the printing.

Embodiment 20. A method for printing a three-dimensional (3D) object, comprising:

(a) providing:
a platform comprising an area configured to hold a mixture for printing at least a portion of the 3D object,
a deposition unit comprising a structural support and a wiper coupled to the structural support for (1) spreading the mixture over the area or (2) removing at least a portion of an excess of the mixture from the area,
   wherein the wiper is configured to move relative to the structural support, such that an axis along a length of the wiper shifts between (i) a non-parallel position relative to a
surface of the area and (ii) a substantially parallel position relative to the surface of the area; and an optical source configured to provide light to the mixture to form the at least the portion of the 3D object; and

(b) using the deposition unit to (1) spread the mixture over the area or (2) remove the at least the portion of the excess of the mixture from the area, via the wiper; and

(c) using the optical source to provide the light to the mixture disposed adjacent to the area of the platform for the printing,

optionally wherein:
(1) the wiper is for (i) the spreading the mixture over the area; and/or
(2) the wiper is for (ii) the removing the at least the portion of the excess of the mixture from the area; and/or
(3) the wiper is configured to rotate about a pivot point to move relative to the structure support,
   optionally wherein (i) the pivot point is a single pivot point, and/or the pivot point is disposed at or adjacent to a central position along the length of the wiper; and/or
(4) the deposition unit further comprises a fastener to substantially maintain the wiper at the substantially parallel position; and/or
(5) the wiper is a non-contact wiper, such that the deposition unit is not in direct contact with the area during the spreading; and/or
(6) the method further comprises using a controller operatively coupled to the deposition unit to (A) direct movement of the area and the deposition unit relative to one another, thereby to direct the wiper to perform (i) the spreading or (ii) the removing; or (B) direct the optical source to provide the light to the mixture for the printing.

Embodiment 21. A system for printing a three-dimensional (3D) object, comprising:

an optical source configured to provide light to a mixture, wherein the light is sufficient to cause formation of at least a portion of the 3D object during the printing;

a build head configured to support the at least the portion of the 3D object;

a platform comprising an area configured to hold the mixture adjacent to the build head, such that at least a portion of the mixture is disposed under compression between the area and the build head during the printing; and

a sensor configured to detect an optical profile of at least a portion of the mixture that is under the compression,

optionally wherein:
(1) the sensor comprises a camera, and the optical profile comprises an image or video of the at least the portion of the mixture that is under the compression; and/or
(2) the system further comprises an additional optical source configured to provide an additional light to the at least the portion of the mixture that is under the compression, and wherein the sensor is configured to detect a different light that is reflected or remitted by the at least the portion of the mixture upon exposure to the additional light, optionally wherein the additional light comprises a red light; and/or
(3) the light comprises an ultraviolet light; and/or
(4) the optical profile is indicative of a quality of the mixture optionally wherein the optical profile comprises presence of entrapped bubbles, uneven metal loading, non-uniform thickness of the mixture or error in projection geometry; and/or
(5) the system further comprises a controller programmed to:
   (a) direct movement of the build head and the platform relative to one another, to provide the mixture under the compression;
   (b) subsequent to (a), direct the sensor to detect the optical profile of the at least the portion of the mixture that is under the compression; and
   (c) subsequent to (b), direct the optical source to provide the light to the mixture, to form the at least the portion of the 3D object,
      optionally wherein the controller is programmed to, in (a), direct the build head to move relative to the platform.

Embodiment 22. A method for printing a three-dimensional (3D) object, comprising:

(a) providing:
an optical source configured to provide light to a mixture, wherein the light is sufficient to cause formation of at least a portion of the 3D object during the printing;
a build head configured to support the at least the portion of the 3D object;
a platform comprising an area configured to hold the mixture adjacent to the build head, such that at least a portion of the mixture is disposed under compression between the area and the build head during the printing; and
a sensor configured to detect an optical profile of at least a portion of the mixture that is under the compression;

(b) using the sensor to detect the optical profile of the at least the portion of the mixture that is under the compression; and

(c) using the optical source to provide the light to the mixture disposed adjacent to the area of the platform for the printing,

optionally wherein:
(1) the sensor comprises a camera, and the optical profile comprises an image or video of the at least the portion of the mixture that is under the compression; and/or
(2) the method further comprises, via an additional optical source, providing an additional light to the at least the portion of the mixture that is under the compression, and wherein the sensor is configured to detect a different light that is reflected or remitted by the at least the portion of the mixture upon exposure to the additional light, optionally wherein the additional light comprises a red light; and/or
(3) the light comprises an ultraviolet light; and/or
(4) the optical profile is indicative of a quality of the mixture optionally wherein the optical profile comprises presence of entrapped bubbles, uneven metal loading, non-uniform thickness of the mixture or error in projection geometry; and/or
(5) the step (b) is performed prior to, simultaneously with, or subsequent to the step (c); and/or
(6) the method further comprises, via a controller operatively coupled to the build head, the platform, and the sensor:
   (i) directing movement of the build head and the platform relative to one another, to provide the mixture under the compression;
   (ii) subsequent to (i), directing the sensor to detect the optical profile of the at least the portion of the mixture that is under the compression; and
   (iii) subsequent to (ii), directing the optical source to provide the light to the mixture, to form the at least the portion of the 3D object,
   optionally wherein (i) comprises directing the build head to move relative to the platform.

Embodiment 23. A method for printing a three-dimensional (3D) object, comprising:

(a) providing a plurality of mixtures comprising:
a first mixture comprising (i) a first polymeric precursor configured to form a first polymeric material and (ii) a first plurality of particles; and
a second mixture comprising (i) a second polymeric precursor configured to form a second polymeric material and (ii) a second plurality of particles,
wherein a first concentration of the first plurality of particles in the first mixture is different than a second concentration of the second plurality of particles in the second mixture;

(b) directing a light to the first polymeric material in the first mixture to form the first polymeric material, thereby to print a first layer of the 3D object comprising at least a portion of the first plurality of particles; and

(c) subsequent to (b), directing the light or an additional light to at least the second polymeric material in the second mixture to form the second polymeric material, thereby to print a second layer of the 3D object comprising at least a portion of the second plurality of particles,

optionally wherein:
(1) the first concentration is higher than the second concentration; and/or
(2) the first concentration is higher than the second concentration by at least about 0.1% by weight; and/or
(3) the first concentration is higher than the second concentration by at least about 0.5% by weight; and/or
(4) the first concentration is higher than the second concentration by at least about 1% by weight; and/or
(5) the first concentration is higher than the second concentration by at least about 5% by weight; and/or
(6) the first concentration is higher than the second concentration by at least about 10% by weight; and/or
(7) the first concentration or the second concentration is at least about 50% by weight; and/or
(8) the first concentration or the second concentration is at least about 60% by weight; and/or
(9) the first concentration or the second concentration is at least about 70% by weight; and/or
(10) the step (c) comprises directing the light to the at least the second polymeric material in the second mixture to form the second polymeric material; and/or
(11) the first polymeric precursor and the second polymeric precursor are the same; and/or
(12) the second layer is directly coupled to the first layer; and/or
(13) the plurality of mixtures are stored in separate containers; and/or
(14) the step (c) comprises:
   (c1) mixing an excess of the first mixture and the second mixture to form a third mixture; and
   (c2) directing the light or the additional light to the third mixture, thereby to print the second layer of the 3D object comprising (i) the at least the portion of the second plurality of particles and (ii) an additional portion of the first plurality of particles from the excess of the first mixture.

Embodiment 24. A kit comprising a plurality of mixtures for forming a three-dimensional (3D) object, wherein the plurality of mixtures comprises:

a first mixture comprising (i) a first polymeric precursor configured to form a first polymeric material and (ii) a first plurality of particles, wherein at least a portion of the first mixture is usable for forming a first layer of the 3D object; and

a second mixture comprising (i) a second polymeric precursor configured to form a second polymeric material and (ii) a second plurality of particles, wherein at least a portion of the second mixture is usable for forming a second layer of the 3D object,

wherein a first concentration of the first plurality of particles in the first mixture is different than a second concentration of the second plurality of particles in the second mixture, optionally wherein:
(1) the first concentration is higher than the second concentration; and/or
(2) the first concentration is higher than the second concentration by at least about 0.1% by weight; and/or
(3) the first concentration is higher than the second concentration by at least about 0.5% by weight; and/or
(4) the first concentration is higher than the second concentration by at least about 1% by weight; and/or
(5) the first concentration is higher than the second concentration by at least about 5% by weight; and/or
(6) the first concentration is higher than the second concentration by at least about 10% by weight; and/or
(7) the first concentration or the second concentration is at least about 50% by weight; and/or
(8) the first concentration or the second concentration is at least about 60% by weight; and/or
(9) the first concentration or the second concentration is at least about 70% by weight; and/or
(10) the first polymeric precursor and the second polymeric precursor are the same; and/or
(11) the second layer is directly coupled to the first layer; and/or
(12) the plurality of mixtures is stored in separate containers.

Embodiment 25. A system for printing a three-dimensional (3D) object, comprising:

a platform comprising a top surface and a plurality of side surfaces, wherein the top surface of the platform is configured to hold a film for carrying a mixture for printing at least a portion of the 3D object;

a perimeter wall disposed adjacent to and surrounding the plurality of side surfaces of the platform,
wherein at least a portion of the perimeter wall is not in direct contact with at least a portion of a side surface of the plurality of side surfaces, such that the at least the portion of the perimeter wall and the at least the portion of the side surface are separated by a gap;

a vacuum unit in fluid communication with the gap, wherein the vacuum unit is configured to provide suction through the gap; and

a controller operatively coupled to the vacuum unit, wherein the controller is configured to direct the vacuum unit to provide the suction through the gap to a bottom surface of the film, when the film is disposed adjacent to the top surface of the platform,

optionally wherein:
(1) the platform is not porous; and/or
(2) at least a portion of the top surface of the platform is textured, optionally wherein at least about 50% of the top surface of the platform is textured; and/or
(3) the platform is transparent or semi-transparent; and/or
(4) the platform comprises glass; and/or
(5) the top surface of the platform and a top surface of the perimeter wall are substantially at the same vertical level, such that the film remains substantially flat when disposed on top of the top surface of the platform and the top surface of the perimeter wall; and/or
(6) the at least the portion of the perimeter wall and the plurality of side surfaces are separated by the gap, wherein the gap is a continuous gap adjacent to the plurality of side surfaces; and/or
(7) the gap is surrounding the entire perimeter of the platform; and/or
(8) the perimeter wall is surrounding the entire perimeter of the platform; and/or
(9) the perimeter wall comprises at least one fluid channel within the perimeter wall, wherein the at least one channel provides the fluid communication between the vacuum unit and the gap; and/or
(10) a size of the gap is between about 0.1 millimeters and about 5 millimeters; and/or
(11) an additional portion of the perimeter wall is coupled to an additional portion of the plurality of side surfaces via an O-ring; and/or
(12) the system further comprises an optical source configured to provide light towards the top surface, wherein the optical source is disposed at or adjacent to a bottom surface of the platform.

Embodiment 26. A method for printing a three-dimensional (3D) object, comprising:

(a) providing:
a platform comprising a top surface and a plurality of side surfaces, wherein the top surface of the platform is configured to hold a film for carrying a mixture for printing at least a portion of the 3D object;
a perimeter wall disposed adjacent to and surrounding the plurality of side surfaces of the platform,
   wherein at least a portion of the perimeter wall is not in direct contact with at least a portion of a side surface of the plurality of side surfaces, such that the at least the portion of the perimeter wall and the at least the portion of the side surface are separated by a gap; and
a vacuum unit in fluid communication with the gap, wherein the vacuum unit is configured to provide suction through the gap; and

(b) using the vacuum unit to provide the suction through the gap to a bottom surface of the film, when the film is disposed adjacent to the top surface of the platform,

optionally wherein:
(1) the platform is not porous; and/or
(2) at least a portion of the top surface of the platform is textured, optionally wherein at least about 50% of the top surface of the platform is textured; and/or
(3) the platform is transparent or semi-transparent; and/or
(4) the platform comprises glass; and/or
(5) the top surface of the platform and a top surface of the perimeter wall are substantially at the same vertical level, such that the film remains substantially flat when disposed on top of the top surface of the platform and the top surface of the perimeter wall; and/or
(6) the at least the portion of the perimeter wall and the plurality of side surfaces are separated by the gap, wherein the gap is a continuous gap adjacent to the plurality of side surfaces; and/or
(7) the gap is surrounding the entire perimeter of the platform; and/or
(8) the perimeter wall is surrounding the entire perimeter of the platform; and/or
(9) the perimeter wall comprises at least one fluid channel within the perimeter wall, wherein the at least one channel provides the fluid communication between the vacuum unit and the gap; and/or
(10) a size of the gap is between about 0.1 millimeters and about 5 millimeters; and/or
(11) an additional portion of the perimeter wall is coupled to an additional portion of the plurality of side surfaces via an O-ring; and/or
(12) the method further comprises, via an optical source, providing light towards the top surface, wherein the optical source is disposed at or adjacent to a bottom surface of the platform.

While preferred embodiments of the present disclosure have been shown and described herein, it will be obvious to those skilled in the art that such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations or equivalents. It is intended that the following claims define the scope of the present disclosure and that methods and structures within the scope of these claims and their equivalents be covered thereby.

What is claimed is:

1. A system for printing a three-dimensional (3D) object, comprising:
a build head configured to support at least a portion of said 3D object during said printing;
a platform comprising an area configured to hold a mixture adjacent to said build head;
an optical source configured to provide light to said mixture, wherein said light is sufficient to cause formation of said at least said portion of said 3D object; and
an actuator operatively coupled to said optical source for controlling projection of said light onto said area, wherein said actuator is configured to:
(i) adjust a movement between said optical source and said build head relative to one another, along a plurality of degrees of freedom; or
(ii) adjust a movement between said optical source and said area relative to one another.

2. The system of claim 1, wherein said actuator is configured to (i) adjust said movement between said optical source and said build head relative to one another, along said plurality of degrees of freedom.

3. The system of claim 2, wherein said actuator is configured to adjust movement of said optical source relative to said build head along said plurality of degrees of freedom, while said build head remains stationary.

4. The system of claim 1, wherein said actuator is configured to (ii) adjust said movement between said optical source and said area relative to one another.

5. The system of claim 4, wherein said actuator is configured to adjust movement of said optical source relative to said area, while said area remains stationary.

6. The system of claim 1, wherein said plurality of degrees of freedom comprises two or more members selected from the group consisting of x, y, z, pitch, yaw, and roll.

7. The system of claim 6, wherein said plurality of degrees of freedom comprises two or more members selected from the group consisting of pitch, yaw, and z.

8. The system of claim 1, wherein said movement between said optical source and said area relative to one another is along a plurality of degrees of freedom comprising two or more members selected from the group consisting of x, y, z, pitch, yaw, and roll.

9. The system of claim 8, wherein said plurality of degrees of freedom comprises two or more members selected from the group consisting of pitch, yaw, and z.

10. The system of claim 1, wherein said actuator is configured to control shape and/or position of said projection of said light onto said area.

11. The system of claim 1, wherein said optical source comprises a plurality of optical sources, wherein each optical source of said plurality of optical sources is configured to move relative to said area along said plurality of degrees of freedom.

12. The system of claim 11, wherein a plurality of light projections onto said area from said plurality of optical sources are adjacent to each other.

13. The system of claim 1, wherein said actuator is coupled to said optical source.

14. The system of claim 1, further comprising a base configured to hold said optical source, wherein said actuator is coupled to said base to adjust movement of said base relative to said area, thereby to control projection of said light from said optical source onto said area.

15. The system of claim 1, wherein said area is transparent or semi-transparent.

16. The system of claim 1, wherein said optical source is configured to provide said light through said area and towards said mixture.

17. The system of claim 1, wherein said build head is configured to move along a direction away from said platform during said printing.

18. The system of claim 1, further comprising a film for carrying said mixture, wherein said film is disposed between said mixture and said area.

19. The system of claim 1, further comprising a controller operatively coupled to said actuator, wherein said controller is configured to direct said actuator to adjust said movement of said optical source relative to said area.

20. A method for printing a three-dimensional (3D) object, comprising:
(a) providing:
a build head configured to support at least a portion of said 3D object during said printing;
a platform comprising an area configured to hold a mixture adjacent to said build head; and
an optical source configured to provide light to said mixture, wherein said light is sufficient to cause formation of said at least said portion of said 3D object;
(b) adjusting (i) a movement between said optical source and said build head relative to one another, along a plurality of degrees of freedom; or (ii) a movement between said optical source and said area relative to one another; and
(c) using said optical source to provide said light to said mixture disposed adjacent to said area of said platform, for said printing.

21. A system for printing a three-dimensional (3D) object, comprising:
a platform comprising:
(i) an exposure window configured to hold a mixture for printing at least a portion of said 3D object, wherein a bottom surface of said exposure window comprises an inner portion surrounded by an outer portion, wherein said outer portion is at least about 20% of said bottom surface; and
(ii) a support unit coupled to said inner portion of said bottom surface of said window, to provide stability to said window;
a build head configured to support said at least said portion of said 3D object; and
an optical source configured to provide light to said mixture to form said at least said portion of said 3D object.

22. The system of claim 21, wherein said bottom surface is substantially flat.

23. The system of claim 21, wherein said support unit is a support beam.

24. The system of claim 21, wherein said support unit is coupled to a center portion of said bottom surface.

25. The system of claim 21, wherein said outer portion is at least about 25% of said bottom surface.

26. The system of claim 21, wherein said outer portion is at least about 30% of said bottom surface.

27. The system of claim 21, wherein said outer portion is at least about 50% of said bottom surface.

28. The system of claim 21, wherein said exposure window has an average thickness of at least about 15 millimeters.

29. The system of claim 21, wherein said exposure window has an average thickness of at least about 20 millimeters.

30. The system of claim 21, wherein said exposure window has an average thickness of at least about 40 millimeters.

31. The system of claim 21, wherein said exposure window has a top surface, wherein an area of said top surface is at least about 100 centimeter squared.

32. The system of claim 21, wherein said support unit is releasably coupled to said inner portion.

33. The system of claim 21, wherein said optical source comprises a plurality of optical sources configured to provide a plurality of lights along a plurality of optical paths and towards said window, wherein said support unit is disposed between the plurality of optical paths.

34. The system of claim 21, wherein said support unit is configured to reduce deformation of said window during printing, as compared to a control 3D printing system lacking said support unit.

35. The system of claim 21, wherein said platform further comprises a fastener to secure said window to said platform.

36. The system of claim 21, further comprising a controller operatively coupled to said optical source, wherein said controller is programmed to direct said optical source to provide said light to said mixture for said printing.

37. A method for printing a three-dimensional (3D) object, comprising:
(a) providing:
a platform comprising:
(i) an exposure window configured to hold a mixture for printing at least a portion of said 3D object, wherein a bottom surface of said exposure window comprises an inner portion surrounded by an outer portion, wherein said outer portion is at least about 20% of said bottom surface; and
(ii) a support unit coupled to said inner portion of said bottom surface of said window, to provide stability to said exposure window;
a build head configured to support said at least said portion of said 3D object; and
an optical source configured to provide light to said mixture to form said at least said portion of said 3D object; and
(b) using said optical source to provide said light to said mixture disposed adjacent to said window of said platform for said printing.

38. A system for printing a three-dimensional (3D) object, comprising:
a platform comprising an area for holding a mixture for printing at least a portion of said 3D object during said printing;
a deposition unit in fluid communication with a source of said mixture, wherein said deposition unit is configured to deposit at least a portion of said mixture onto said area;
a building unit comprising an optical source configured to provide light to said mixture, wherein said light is sufficient to cause formation of said at least said portion of said 3D object; and
a plurality of guiding elements operatively coupled to said platform and configured to direct movement of said platform between said deposition unit and said building unit,
wherein a first guiding element of said plurality of guiding elements is configured to move along a first path, and a second guiding element of said plurality of guiding elements is configured to move along a second path that is not overlapping with said first path, wherein said first path and said second path are disposed in a single plane that is substantially parallel to said area.

39. The system of claim 38, wherein said plurality of guiding elements is configured to move towards a same direction.

40. The system of claim 38, wherein said plurality of guiding elements is operatively coupled to a single actuator.

41. The system of claim 38, wherein a guiding element of said plurality of guiding elements comprises a belt or a wheel.

42. The system of claim 38, wherein a guiding element of said plurality of guiding elements comprises a rail.

43. The system of claim 38, wherein said first path and said second path are substantially parallel to each other.

44. The system of claim 38, wherein said first guiding element and said second guiding element are coupled to two opposite sides of said platform.

45. The system of claim 38, wherein said platform comprises at least two platforms, wherein said plurality of guiding elements is configured to simultaneously direct movement of said at least two platforms between said deposition unit and said building unit.

46. The system of claim 38, wherein movements of said at least two platforms are opposite relative to one another.

47. The system of claim 38, wherein said area is transparent or semi-transparent.

48. The system of claim 38, wherein said optical source is configured to provide said light through said area and towards said mixture.

49. The system of claim 38, wherein said deposition unit comprises a nozzle that is in fluid communication with said source.

50. The system of claim 38, wherein said building unit comprises a build head configured to support said at least said portion of said 3D object during said printing.

51. The system of claim 38, further comprising a controller operatively coupled to said plurality of guiding elements, wherein said controller is programmed to control said plurality of guiding elements to direct said movement of said platform between said deposition unit and said building unit.

52. A method for printing a three-dimensional (3D) object, comprising:
(a) providing:
a platform comprising an area for holding a mixture for printing at least a portion of said 3D object during said printing;
a deposition unit in fluid communication with a source of said mixture, wherein said deposition unit is configured to deposit at least a portion of said mixture onto said area;
a building unit comprising an optical source configured to provide light to said mixture, wherein said light is sufficient to cause formation of said at least said portion of said 3D object; and
a plurality of guiding elements operatively coupled to said platform and configured to direct movement of said platform between said deposition unit and said building unit,
wherein a first guiding element of said plurality of guiding elements is configured to move along a first path, and a second guiding element of said plurality of guiding elements is configured to move along a second path that is not overlapping with said first path, wherein said first path and said second path are disposed in a single plane that is substantially parallel to said area;
(b) directing, via said plurality of guiding elements, said movement of said platform between said deposition unit and said building unit; and
(c) using said optical source to provide said light to said mixture disposed adjacent to said area of said platform for said printing.

53. A system for printing a three-dimensional (3D) object, comprising:
a platform comprising (i) an area for holding a mixture for printing at least a portion of said 3D object during said printing and (ii) a first coupling unit;
a deposition unit in fluid communication with a source of said mixture, wherein said deposition unit is configured to deposit at least a portion of said mixture onto said area;
a building unit comprising an optical source configured to provide light to said mixture, wherein said light is sufficient to cause formation of said at least said portion of said 3D object during said printing; and
a moving unit configured to direct movement of said platform between said deposition unit and said building unit, wherein said moving unit comprises a second coupling unit that is configured to couple to said first coupling unit, such that said platform is operatively coupled to said moving unit,
wherein a vertical dimension of said second coupling unit is configured to permit a vertical movement between said first coupling unit and said moving unit relative to one another.

54. The system of claim 53, further comprising:
an additional platform comprising (i) an additional area for holding said mixture or an additional mixture and (ii) a third coupling unit; and
an additional moving unit configured to direct movement of said additional platform between said deposition unit and said building unit, wherein said additional moving unit comprises a fourth coupling unit that is configured to couple to said third coupling unit, such that said additional platform is operatively coupled to said additional moving unit,
wherein a vertical dimension of said fourth coupling unit is configured to permit a vertical movement between said third coupling unit and said additional moving unit relative to one another, and
wherein said vertical dimension of said second coupling unit and said vertical dimension of said fourth coupling unit are different.

55. The system of claim 53, wherein, when said platform and said additional platform are moving in opposite directions between said deposition unit and said building unit, said area of said platform and said additional area of said additional platform are disposed at different heights.

56. The system of claim 53, wherein when said platform and said additional platform are stationary at said deposition unit and said building unit, respectively, said area of said platform and said additional area of said additional platform are disposed at substantially the same heights.

57. The system of claim 53, wherein said first coupling unit comprises a protrusion relative to a surface of said first coupling unit, and wherein said second coupling unit comprises a recess relative to a surface of said second coupling unit.

58. The system of claim 53, wherein said protrusion comprises one or more pins, and wherein said recess comprises one or more slots.

59. The system of claim 53, wherein said movement is substantially a horizontal movement.

60. The system of claim 53, wherein said moving unit is operatively coupled to an actuator configured to move said moving unit, thereby to direct said movement of said platform along a direction.

61. The system of claim 53, further comprising an additional actuator coupled to said actuator and configured to direct movement of said actuator along an additional direction, wherein said direction and said additional direction are not parallel to each other.

62. The system of claim 53, wherein said direction and said additional direction are substantially orthogonal to each other.

63. The system of claim 53, wherein (i) said direction is substantially horizontal and (ii) said additional direction is substantially vertical.

64. The system of claim 53, wherein said additional actuator is not directly coupled to said platform, such that operation of said additional actuator in absence of said actuator is not configured to move said platform along said direction.

65. The system of claim 53, further comprising a controller operatively coupled to said moving unit, wherein said controller is programmed to control said moving unit to direct said movement of said platform between said deposition unit and said building unit.

66. A method for printing a three-dimensional (3D) object, comprising:
(a) providing:
a platform comprising (i) an area for holding a mixture for printing at least a portion of said 3D object during said printing and (ii) a first coupling unit;
a deposition unit in fluid communication with a source of said mixture, wherein said deposition unit is configured to deposit at least a portion of said mixture onto said area;
a building unit comprising an optical source configured to provide light to said mixture, wherein said light is sufficient to cause formation of said at least said portion of said 3D object during said printing; and
a moving unit configured to direct movement of said platform between said deposition unit and said building unit, wherein said moving unit comprises a second coupling unit that is configured to couple to said first coupling unit, such that said platform is operatively coupled to said moving unit,
wherein a vertical dimension of said second coupling unit is configured to permit a vertical movement between said first coupling unit and said moving unit relative to one another;
(b) directing, via said moving unit, said movement of said platform between said deposition unit and said building unit; and
(c) using said optical source to provide said light to said mixture disposed adjacent to said area of said platform for said printing.

67. A system for printing a three-dimensional (3D) object, comprising:
a platform comprising a top surface configured to hold a mixture for printing at least a portion of said 3D object, wherein a portion of said top surface is not parallel to an additional portion of said top surface that holds said mixture, and wherein said portion of said top surface is substantially rigid; and
an optical source configured to provide light to said mixture, wherein said light is (i) usable for determining a characteristic of said mixture prior to said printing or (ii) sufficient to cause formation of said at least said portion of said 3D object during said printing.

68. The system of claim 67, wherein said portion of said top surface is characterized by exhibiting a Young's modulus of at least about 10 GPa.

69. The system of claim 67, wherein an angle between an external normal of said portion and an external normal of said additional portion of said top surface is an acute angle.

70. The system of claim 69, wherein said acute angle is less than about 60 degrees.

71. The system of claim 69, wherein said acute angle is less than about 30 degrees.

72. The system of claim 67, further comprising a collection unit configured to couple to said platform via said portion of said top surface of said platform, to collect any excess mixture from said platform.

73. The system of claim 72, wherein said collection unit is configured to cover said portion of said top surface upon coupling between said collection unit and said platform.

74. The system of claim 72, wherein, upon coupling of said collection unit and said platform, (i) a top surface of said collection unit is substantially parallel to said top surface of said platform or (ii) a top surface of said collection unit and said top surface of said platform form a substantially flat area.

75. The system of claim 72, further comprising an actuator configured to direct movement of said collection unit relative to said platform.

76. The system of claim 67, wherein said portion of said top surface of said platform comprises a sealing mechanism to prevent flow of at least a portion of said mixture across said sealing mechanism.

77. The system of claim 76, wherein said sealing mechanism (i) is disposed across a cross-sectional dimension of said portion of said top surface, or (ii) protrudes out of said portion of said top surface.

78. The system of claim 67, wherein said additional portion of said top surface is transparent or semi-transparent.

79. The system of claim 67, wherein said additional portion of said top surface is porous.

80. The system of claim 67, wherein said portion of said top surface is not porous.

81. The system of claim 67, further comprising a film for carrying said mixture, wherein said film is disposed between said mixture and said additional portion of said top surface of said platform.

82. The system of claim 67, wherein said film comprises a back surface adjacent to said top surface of said platform, and wherein said platform comprises one or more channels in fluid communication with said back surface, and wherein the system further comprises:
a vacuum unit operatively coupled to said one or more channels, wherein said vacuum unit is configured to provide a vacuum between said platform and said back surface; and
a controller operatively coupled to said vacuum unit, wherein said controller is configured to direct said vacuum unit to provide said vacuum between said platform and said back surface.

83. The system of claim 82, wherein said one or more channels are in fluid communication with a side surface or a bottom surface of said platform.

84. The system of claim 67, wherein said portion of said top surface of said platform is flat.

85. The system of claim 67, wherein said portion of said top surface of said platform is not flat.

86. The system of claim 67, further comprising a controller operatively coupled to said optical source, wherein said controller is programmed to direct said optical source to provide said light to said mixture for said printing.

87. A method for printing a three-dimensional (3D) object, comprising:
(a) providing:
a platform comprising a top surface configured to hold a mixture for printing at least a portion of said 3D object, wherein a portion of said top surface is not parallel to an additional portion of said top surface that holds said mixture, and wherein said portion of said top surface is substantially rigid; and
an optical source configured to provide light to said mixture, wherein said light is (i) usable for determining a characteristic of said mixture prior to said printing or (ii) sufficient to cause formation of said at least said portion of said 3D object during said printing; and
(b) using said optical source to provide said light to said mixture disposed adjacent to said additional portion of said top surface of said platform for said printing.

88. A system for printing a three-dimensional (3D) object, comprising:
a platform comprising an area configured to hold a mixture for printing at least a portion of said 3D object,
a deposition unit comprising a structural support and a wiper coupled to said structural support for (i) spreading said mixture over said area or (ii) removing at least a portion of an excess of said mixture from said area,
wherein said wiper is configured to move relative to said structural support, such that an axis along a length of said wiper shifts between (a) a non-parallel position relative to a surface of said area and (b) a substantially parallel position relative to said surface of said area; and
an optical source configured to provide light to said mixture to form said at least said portion of said 3D object.

89. A method for printing a three-dimensional (3D) object, comprising:
(a) providing:
a platform comprising an area configured to hold a mixture for printing at least a portion of said 3D object,
a deposition unit comprising a structural support and a wiper coupled to said structural support for (1) spreading said mixture over said area or (2) removing at least a portion of an excess of said mixture from said area,
wherein said wiper is configured to move relative to said structural support, such that an axis along a length of said wiper shifts between (i) a non-parallel position relative to a surface of said area and (ii) a substantially parallel position relative to said surface of said area; and
an optical source configured to provide light to said mixture to form said at least said portion of said 3D object; and
(b) using said deposition unit to (1) spread said mixture over said area or (2) remove said at least said portion of said excess of said mixture from said area, via said wiper; and
(c) using said optical source to provide said light to said mixture disposed adjacent to said area of said platform for said printing.

90. A system for printing a three-dimensional (3D) object, comprising:
a platform comprising an area configured to hold a mixture for printing at least a portion of said 3D object,
a deposition unit comprising:
a wiper configured to (i) remove at least a portion of an excess of said mixture from said area or (ii) spread said mixture over said area;
an actuator configured to control a vertical movement of said wiper towards or away from said area; and
a dampener disposed between said actuator and said wiper, to reduce at least a portion of a force exerted by said actuator and towards said wiper when said actuator directs said vertical movement of said wiper towards or away from said area; and
an optical source configured to provide light to said mixture, wherein said light is sufficient to cause formation of said at least said portion of said 3D object during said printing.

91. A method for printing a three-dimensional (3D) object, comprising:
(a) providing:
a platform comprising an area configured to hold a mixture for printing at least a portion of said 3D object,
a deposition unit comprising:
a wiper configured to (i) remove at least a portion of an excess of said mixture from said area or (ii) spread said mixture over said area;
an actuator configured to control a vertical movement of said wiper towards or away from said area; and
a dampener disposed between said actuator and said wiper, to reduce at least a portion of a force exerted by said actuator and towards said wiper when said actuator directs said vertical movement of said wiper towards or away from said area; and
an optical source configured to provide light to said mixture, wherein said light is sufficient to cause formation of said at least said portion of said 3D object during said printing;
(b) using said deposition unit to (i) remove said at least said portion of an excess of said mixture from said area or (ii) spread said mixture over said area; and
(c) using said optical source to provide said light to said mixture disposed adjacent to said area of said platform for said printing.

92. A system for printing a three-dimensional (3D) object, comprising:
a platform configured to support a film holding a mixture for printing at least a portion of said 3D object during said printing, wherein said platform comprises:
(i) a bar configured to hold said film at a side of said film; and
(ii) an additional bar configured to hold said film at an additional side of said film,
wherein said bar comprises a locking mechanism comprising (i) a locking state to couple at least a portion of said side of said film to said bar and (ii) an unlocking state to release said at least said portion of said side of said film from said bar; and
an optical source configured to provide light to said mixture, wherein said light is sufficient to cause formation of said at least said portion of said 3D object during said printing.

93. A method for printing a three-dimensional (3D) object, comprising:
(a) providing:
a platform configured to support a film holding a mixture for printing at least a portion of said 3D object during said printing, wherein said platform comprises:
(i) a bar configured to hold said film at a side of said film; and
(ii) an additional bar configured to hold said film at an additional side of said film,
wherein said bar comprises a locking mechanism comprising (i) a locking state to couple at least a portion of said side of said film to said bar and (ii) an unlocking state to release said at least said portion of said side of said film from said bar; and
an optical source configured to provide light to said mixture, wherein said light is sufficient to cause formation of said at least said portion of said 3D object during said printing; and
(b) using said optical source to provide said light to said mixture disposed adjacent to said film that is supported by said platform for said printing.

94. A method for printing a three-dimensional (3D) object, comprising:
(a) providing a plurality of mixtures comprising:
a first mixture comprising (i) a first polymeric precursor configured to form a first polymeric material and (ii) a first plurality of particles; and
a second mixture comprising (i) a second polymeric precursor configured to form a second polymeric material and (ii) a second plurality of particles,
wherein a first concentration of said first plurality of particles in said first mixture is different than a second concentration of said second plurality of particles in said second mixture;
(b) directing a light to said first polymeric material in said first mixture to form said first polymeric material, thereby to print a first layer of said 3D object comprising at least a portion of said first plurality of particles; and
(c) subsequent to (b), directing said light or an additional light to at least said second polymeric material in said second mixture to form said second polymeric material, thereby to print a second layer of said 3D object comprising at least a portion of said second plurality of particles.

95. A kit comprising a plurality of mixtures for forming a three-dimensional (3D) object, wherein said plurality of mixtures comprises:
a first mixture comprising (i) a first polymeric precursor configured to form a first polymeric material and (ii) a first plurality of particles, wherein at least a portion of said first mixture is usable for forming a first layer of said 3D object; and
a second mixture comprising (i) a second polymeric precursor configured to form a second polymeric material and (ii) a second plurality of particles, wherein at least a portion of said second mixture is usable for forming a second layer of said 3D object,
wherein a first concentration of said first plurality of particles in said first mixture is different than a second concentration of said second plurality of particles in said second mixture.

96. A system for printing a three-dimensional (3D) object, comprising:
a platform comprising an area for holding a mixture for printing at least a portion of said 3D object;
a deposition unit comprising a plurality of nozzles in fluid communication with a common source of said mixture, wherein each of said plurality of nozzles is configured to deposit at least a portion of said mixture onto said area, and wherein:
(i) said plurality of nozzles comprises a nozzle and an additional nozzle, wherein a cross-sectional dimension of said nozzle and an additional cross-sectional dimension of said additional nozzle are different; or
(ii) said plurality of nozzles comprises three or more nozzles; and
an optical source configured to provide light to said mixture, wherein said light is sufficient to cause formation of said at least said portion of said 3D object during said printing.

97. A method for printing a three-dimensional (3D) object, comprising:
(a) providing:
a platform comprising an area for holding a mixture for printing at least a portion of said 3D object;
a deposition unit comprising a plurality of nozzles in fluid communication with a common source of said mixture, wherein each of said plurality of nozzles is configured to deposit at least a portion of said mixture onto said area, and wherein:
(i) said plurality of nozzles comprises a nozzle and an additional nozzle, wherein a cross-sectional dimension of said nozzle and an additional cross-sectional dimension of said additional nozzle are different; or
(ii) said plurality of nozzles comprises three or more nozzles; and
an optical source configured to provide light to said mixture, wherein said light is sufficient to cause formation of said at least said portion of said 3D object during said printing; and
(b) using said deposition unit to deposit said mixture from said common source and towards said area of said platform, via one or more nozzles of said plurality of nozzles; and
(c) using said optical source to provide said light to said mixture disposed adjacent to said area of said platform for said printing.

98. A system for printing a three-dimensional (3D) object, comprising:
an optical source configured to provide light to a mixture, wherein said light is sufficient to cause formation of at least a portion of said 3D object during said printing;
a build head configured to support said at least said portion of said 3D object;
a platform comprising an area configured to hold said mixture adjacent to said build head; and
an actuator operatively coupled to said platform, wherein said actuator is configured to:
(i) adjust a movement between said area and said build head relative to one another, along a plurality of degrees of freedom; or
(ii) adjust a movement between said area and said optical source relative to one another.

99. A method for printing a three-dimensional (3D) object, comprising:
(a) providing:
an optical source configured to provide light to a mixture, wherein said light is sufficient to cause formation of at least a portion of said 3D object during said printing;
a build head configured to support said at least said portion of said 3D object;
a platform comprising an area configured to hold said mixture adjacent to said build head;
(b) adjusting (i) a movement between said area and said build head relative to one another, along a plurality of degrees of freedom, or (ii) a movement between said area and said optical source relative to one another, for leveling said area; and
(c) using said optical source to provide said light to said mixture disposed adjacent to said area of said platform, for said printing.

100. A system for printing a three-dimensional (3D) object, comprising:
an optical source configured to provide light to a mixture, wherein said light is sufficient to cause formation of at least a portion of said 3D object during said printing;
a build head configured to support said at least said portion of said 3D object;
a platform comprising an area configured to hold said mixture adjacent to said build head, such that at least a portion of said mixture is disposed under compression between said area and said build head during said printing; and
a sensor configured to detect an optical profile of at least a portion of said mixture that is under said compression.

101. A method for printing a three-dimensional (3D) object, comprising:
(a) providing:
an optical source configured to provide light to a mixture, wherein said light is sufficient to cause formation of at least a portion of said 3D object during said printing;
a build head configured to support said at least said portion of said 3D object;
a platform comprising an area configured to hold said mixture adjacent to said build head, such that at least a portion of said mixture is disposed under compression between said area and said build head during said printing; and
a sensor configured to detect an optical profile of at least a portion of said mixture that is under said compression;
(b) using said sensor to detect said optical profile of said at least said portion of said mixture that is under said compression; and
(c) using said optical source to provide said light to said mixture disposed adjacent to said area of said platform for said printing.

102. A system for printing a three-dimensional (3D) object, comprising:
a platform comprising a top surface and a plurality of side surfaces, wherein said top surface of said platform is configured to hold a film for carrying a mixture for printing at least a portion of said 3D object;
a perimeter wall disposed adjacent to and surrounding said plurality of side surfaces of said platform,
wherein at least a portion of said perimeter wall is not in direct contact with at least a portion of a side surface of said plurality of side surfaces, such that said at least said portion of said perimeter wall and said at least said portion of said side surface are separated by a gap;
a vacuum unit in fluid communication with said gap, wherein said vacuum unit is configured to provide suction through said gap; and
a controller operatively coupled to said vacuum unit, wherein said controller is configured to direct said vacuum unit to provide said suction through said gap to a bottom surface of said film, when said film is disposed adjacent to said top surface of said platform.

103. A method for printing a three-dimensional (3D) object, comprising:
(a) providing:
a platform comprising a top surface and a plurality of side surfaces, wherein said top surface of said platform is configured to hold a film for carrying a mixture for printing at least a portion of said 3D object;
a perimeter wall disposed adjacent to and surrounding said plurality of side surfaces of said platform,
wherein at least a portion of said perimeter wall is not in direct contact with at least a portion of a side surface of said plurality of side surfaces, such that said at least said portion of said perimeter wall and said at least said portion of said side surface are separated by a gap; and
a vacuum unit in fluid communication with said gap, wherein said vacuum unit is configured to provide suction through said gap; and
(b) using said vacuum unit to provide said suction through said gap to a bottom surface of said film, when said film is disposed adjacent to said top surface of said platform.
